(19) United States
(12) Patent Application Publication
(10) Pub. No.: US 2001/0004107 A1
(43) Pub. Date: Jun. 21, 2001

(54) FLUORESCENT LIQUID CRYSTALLINE CHARGE TRANSFER MATERIALS

(75) Inventors: JUNICHI HANNA, YOKOHAMA-SHI (JP); KYOKO KOGO, SHINJUKU-KU (JP); KOMEI KAFUKU, LAS VEGAS, NV (US)

Correspondence Address: PARKHURST & WENDEL, 1431 PRINCE STREET, SUITE 210, ALEXANDRIA, VA, 223142805

(73) Assignee: Junichi Hanna

(21) Appl. No.: 09/183,947

(22) Filed: Nov. 2, 1998

(30) Foreign Application Priority Data
Nov. 4, 1997 (JP) 316654/1997
Nov. 4, 1997 (JP) 316656/1997

(51) Int. Cl. C09K 19/58; G09G 3/36; G02F 1/135

(52) U.S. Cl. 252/299.3; 349/25; 345/92

(57) ABSTRACT

The present invention relates to novel charge transfer materials which have both the advantageous properties of amorphous materials such as structural flexibility and uniformity over large areas, and those of crystalline materials such as molecular orientation and which are excellent in charge transferability, thin-film formability, and durability of various types. The liquid crystalline charge transfer materials have the following structure (A) containing a fluorescent skeletal structure Y, and the core Z of a liquid crystal:

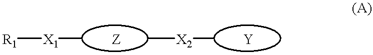

in which R₁, which may directly be combined with Z without interposing X₁, represents a saturated or unsaturated, and linear, branched or cyclic hydrocarbon group having 1 to 22 carbon atoms; and X₁ and X₂ represent oxygen atom, sulfur atom, or —CO—, —OCO—, —COO—, —N═CH—, —CONH—, —NH—, —NHCO— or —CH₂— group; or

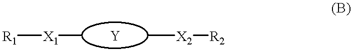

in which R₁ and R₂, which may directly be combined with Y without interposing X₁ and X₂, represents a saturated or unsaturated, and linear, branched or cyclic hydrocarbon group having 1 to 22 carbon atoms; and X₁ and X₂ represent oxygen atom, sulfur atom, or —CO—, —OCO—, —COO—, —N═CH—, —CONH—, —NH—, —NHCO— or —CH₂— group.

### TECHNICAL FIELD

The present invention relates to fluorescent liquid crystalline charge transfer materials. More particularly, the present invention relates to liquid crystalline organic materials having fluorescence and charge transferability, and to various elements or devices using these organic materials.

### BACKGROUND OF THE INVENTION

As charge transfer materials, there have conventionally been known those materials which are obtained by dissolving or dispersing charge transfer molecules, which will become charge transfer sites, in matrix materials such as polycarbonate resins; and those materials such as polyvinyl carbazole which have polymer backbones and charge transfer molecular structures as pendants to the backbones. These materials have widely been used for producing photoconductors for use in copying machines, printers, and the like.

In the case of the dispersion-type charge transfer materials in the above-described conventional charge transfer materials, it is desirable for improving charge transferability that charge transfer molecules be highly soluble in a matrix polymer. Practically, however, charge transfer molecules are crystallized in a matrix when the concentration of the charge transfer molecules in the matrix is made high. Therefore, the concentration of charge transfer molecules in a matrix is, in general, limited to 20 to 50% by weight although it depends on the type of the charge transfer molecules. Consequently, the amount of the matrix having no charge transferability becomes 50% by weight or more of the whole material; and, when such a material is made into a film, the sufficiently high charge transferability and speed of response of the charge transfer molecules are restricted by the matrix.

On the other hand, in the case of charge transfer polymers of the above-described pendant type, although the proportion of pendants having charge transferability is high, the polymers have many practical problems in film formability, and also in mechanical strength, environmental stability and durability when they are made into films. Further, in the charge transfer materials of this type, the charge transfer pendants are locally in close proximity. Such locally close pendants become stable sites when hopping of electric charges is conducted, and act as a kind of traps. Consequently, the mobility of electric charges is lowered.

Furthermore, the features of the above-described amorphous materials, viewed from electrical characteristics are different from those of crystalline materials; and the amorphous materials have such a problem that hopping sites have fluctuation in terms of not only space but also energy. For this reason, the mobility of electric charges in the amorphous materials is highly dependent on the concentration of charge transfer sites; and it is generally from about 10⁻⁶ to 10⁻⁵ cm²/vs. This value is much smaller than the mobility of electric charges in molecular crystals, which is in the range of 0.1 to 1 cm²/vs. Moreover, there is such a problem that the charge transferabiltiy is highly dependent on both temperature and electric field strength. This is the great difference between the amorphous charge transfer materials and crystalline ones.

In addition, for such applications that require charge transfer layers having large areas, polycrystalline charge transfer materials are anticipated because they can uniformly be made into charge transfer films having large areas. However, polycrystalline materials are essentially unhomogeneous from the microscopical point of view. They have therefore some problems; for example, it is necessary to suppress those defects which will be formed on particle-particle interfaces.

An object of the present invention is therefore to solve the aforementioned problems in the prior art, thereby providing novel charge transfer materials which have both the advantageous properties of amorphous materials such as structural flexibility and uniformity over large areas, and those of crystalline materials such as molecular orientation and which are excellent in charge transferability, thin-film formability, and durability of various types.

Further, we also found that some of the above-described novel charge transfer materials themselves are fluorescent. When a display element such as an electro-luminescent element is composed by using such a charge transfer material, it is not necessary to introduce any fluorescent material which tends to impede the orientation of molecules in a liquid crystal. Therefore, the present invention is also provide charge transfer materials which are free from lowering of charge transferability, which do not change the nature of liquid crystals and which can attain high mobility of electric charges.

Furthermore, the liquid crystalline materials of the present invention have both charge transferability and fluorescence. Therefore, when they are used, for example, as electro-luminescent elements, the electro-luminescent elements can be produced by using only the liquid crystalline materials, and the production process of the elements can thus be simplified, although it is necessary, for composing conventional electro-luminescent elements, to use two or three layers of an electron transfer layer, a hole transfer layer and a luminescent layer respectively made from materials having electron transferability, hole transferability or fluorescence.

### DISCLOSURE OF THE INVENTION

The above-described object is attained by the present invention which will be described hereinafter. Namely, a first embodiment of the present invention is a liquid crystalline charge transfer material having the following structure (A) containing a fluorescent skeletal structure Y, and the core Z of a liquid crystal:

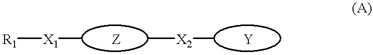

wherein R₁, which may directly be combined with Z without interposing X₁ represents a saturated or unsaturated, and linear, branched or cyclic hydrocarbon group having 1 to 22 carbon atoms; and X₁ and X₂ represent oxygen atom, sulfur atom, or —CO—, —OCO—, —COO—, —N═CH—, —CONH—, —NH—, —NHCO— or —CH₂— group.

A second embodiment of the present invention is a liquid crystalline charge transfer material having the following skeletal structure (B) containing the fluorescent core Y of a liquid crystal:

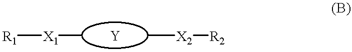

wherein R₁ and R₂, which may directly be combined with Y without interposing X₁ and X₂, represents a saturated or unsaturated, and linear, branched or cyclic hydrocarbon group having 1 to 22 carbon atoms; and X₁ and X₂ represent oxygen atom, sulfur atom, or —CO—, —OCO—, —COO—, —N═CH—, —CONH—, —NH—, —NHCO— or —CH₂— group.

Liquid crystalline molecules have self-orienting property due to their structures. Therefore, in the case of charge transfer in which liquid crystalline molecules are used as hopping sites, scattering of hopping sites in terms of both space and energy is prevented unlike in the case of charge transfer utilizing the previously-mentioned molecule-dispersed materials, and band-like charge transfer which can be seen in molecular liquid crystals is thus attained. For this reason, the liquid crystalline molecules can attain extremely high mobility of electric charges as compared with the conventional molecule-dispersed materials; and, moreover, the mobility is not dependent on electric field. In addition, by introducing fluorescent skeletal structures to the above-described liquid crystalline molecules having self-orienting property, there can be obtained liquid crystalline charge transfer materials whose self-orienting property is not adversely affected by the addition of fluorescent materials.

### BRIEF DESCRIPTION OF THE DRAWINGS

In the drawings,

FIG. 1 is a schematic view showing an electro-luminescent element;

FIG. 2 is a schematic view showing an electro-luminescent element (an example of electrode pattern);

FIG. 3 is a schematic view showing an electro-luminescent element;

FIG. 4 is a schematic view showing an electro-luminescent element;

FIG. 5 is a schematic view showing an optical sensor;

FIG. 6 is a schematic view showing an optical sensor;

FIG. 7 is a schematic view showing an optical sensor;

FIG. 8 is a schematic view showing an image-displaying element;

FIG. 9 is a schematic view showing an image-recording device;

FIG. 10 is a schematic view showing an image-recording device;

FIG. 11 is a schematic view showing a spacial optical modulator; and

FIG. 12 is a schematic view showing a thin-film transistor.

### BEST MODE FOR CARRYING OUT THE INVENTION

By showing preferable embodiments of the present invention, the present invention will be described more specifically.

Liquid crystalline charge transfer materials of the present invention will be enumerated below. Among the following charge transfer materials, preferable ones are those liquid crystalline charge transfer materials which fulfill the previously-mentioned requirements, and, at the same time, have the core (6π electron system aromatic ring)₁, (10π electron system aromatic ring)ₘ or (14π electron system aromatic ring)ₙ (where 1, m and n are an integer of 0 to 4, provided that 1+m+n=1 to 4), the 6π electron system aromatic ring being combined through a combining group having carbon-carbon double bond or carbon-carbon triple bond. The number of the aromatic rings combined are restricted by taking mobility of electric charges into consideration. Examples of 6π electron system aromatic rings include benzene, pyridine, pyrimidine, pyridazine, pyrazine and tropolone rings; examples of 10π electron system aromatic rings include naphthalene, azulene, benzofuran, indole, indazole, benzothiazole, benzoxazole, benzimidazole, quinoline, isoquinoline, quinazoline and quinoxaline rings; and 14π electron system aromatic rings include phenanthrene and anthracene rings. It has been known that these π electron system aromatic rings show fluorescence when voltage or light is applied thereto. Those charge transfer materials which are preferably used in the present invention have structures combined with these π electron system aromatic rings, so that they are more preferable from the viewpoint of fluorescence.

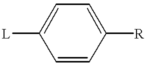

| L | R | Cr | LC |
|---|---|---|---|
| C₅H₁₁— | —CO—NH—NH—CO—CH₂—CN | K 124 | S 141 I |
| C₆H₁₃— | —CO—NH—NH—CO—CH₂—CN | K 121 | S 162 I |
| C₇H₁₅— | —CO—NH—NH—CO—CH₂—CN | K 125 | S 184 I |
| C₈H₁₇— | —CO—NH—NH—CO—CH₂—CN | K 130 | S 178 I |
| C₄H₉—O— | —CO—NH—NH—CO—CH₂—CN | K 141 | S 130 I |
| C₅H₁₁—O— | —CO—NH—NH—CO—CH₂—CN | K 138 | S 149 I |
| C₆H₁₃—O— | —CO—NH—NH—CO—CH₂—CN | K 133 | S 167 I |
| C₇H₁₅—O— | —CO—NH—NH—CO—CH₂—CN | K 134 | S 179 I |
| C₈H₁₇—O— | —CO—NH—NH—CO—CH₂—CN | K 131 | S 188 I |
| C₉H₁₉—O— | —CH═CH—CO—NH—NH—CO—CH₂—CN | K 142 | S 215 I |

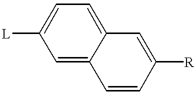

| L | R | | Cr | LC |
|---|---|---|---|---|
| C₁₀H₂₁—O— | —COO—C₃H₈—SiMe₂C₄H₉ | | K 1 | A 27 I |
| C₁₀H₂₁—O— | —C₄H₈—CHMe—O—C₃H₇ | 1 | K? | S 20 S 21 C* 31 A 37 U |

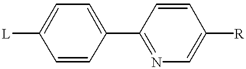

| L | R | Cr | LC |
|---|---|---|---|
| C₆H₁₃— | —O—C₄H₉ | K 26 | S 44.5 I |
| C₈H₁₇— | —O—C₆H₁₃ | K 57 | I 37 C 58 A 79 I |
| C₈H₁₇— | —O—C₈H₁₇ | K 22 | S 37 G 51 F 62 C 77 A 85 I |
| C₈H₁₇— | —OOC—C₅H₁₁ | K 84 | C 69 N 70 I |
| C₈H₁₇— | —OOC—C₆H₁₃ | K 61 | C 77 I |
| C₈H₁₇— | —OOC—C₇H₁₅ | K 41 | F 77 C 85 I |
| C₈H₁₇— | —OOC—C₈H₁₇ | K 58 | G 48 F 85 C 88 I |
| C₈H₁₇— | —OOC—C₉H₁₉ | K 36 | G 60 F 92 I |
| C₈H₁₇— | —OOC—C₁₀H₂₁ | K 13 | G 66 F 93 I |
| C₈H₁₇— | —OOC—C₁₁H₂₃ | K 26 | G 43 F 96 I |
| C₄H₉—O— | —C₄H₉ | K 43 | S 62 I |
| C₄H₉—O— | —C₆H₁₃ | K 50 | S 54 N 61 I |
| C₄H₉—O— | —C₈H₁₇ | K 33 | B 57.3 C 66.8 A 69.4 I |
| C₅H₁₁—O— | —C₆H₁₃ | K 20.5 | H 31.5 G 45 F 48.5 C 58 N 60.8 I |
| C₅H₁₁—O— | —C₇H₁₅ | K 26.5 | G 35 F 48 C 67.5 N 68.7 I |
| C₅H₁₁—O— | —C₈H₁₇ | K 37.4 | B 52 C 70.1 I |
| C₅H₁₁—O— | —C₉H₁₉ | K 42.5 | B 65 C 72.4 A 74.5 I |
| C₅H₁₁—O— | —C₁₀H₂₁ | K 44.4 | B 66.7 C 70.4 A 74.7 I |
| C₆H₁₃—O— | —C₃H₇ | K 50 | S 72 I |
| C₆H₁₃—O— | —C₆H₁₃ | K 22 | C 66 N 69 B |
| C₆H₁₃—O— | —C₇H₁₅ | K 34 | H 31.2 G 44.4 F 53 C 74.4 N 75.2 I |
| C₆H₁₃—O— | —C₈H₁₇ | K 30 | G 23 I 58 C 77 I |
| C₆H₁₃—O— | —C₉H₁₉ | K 36 | B 64.4 C 80.5 I |
| C₆H₁₃—O— | —C₁₀H₂₁ | K 30 | B 67.6 C 80 I |
| C₇H₁₅—O— | —C₅H₁₁ | K 56.9 | S 61.8 N 68.2 I |
| C₇H₁₅—O— | —C₆H₁₃ | K 40 | C 68 B |
| C₇H₁₅—O— | —C₇H₁₅ | K 31 | G 40 I 52 C 77 I |
| C₇H₁₅—O— | —C₈H₁₇ | K 38.5 | F 56 C 76.5 I |
| C₇H₁₅—O— | —C₉H₁₉ | K 33 | B 64 C 81.5 I |
| C₇H₁₅—O— | —C₁₀H₂₁ | K 41 | B 67.8 C 80.8 I |

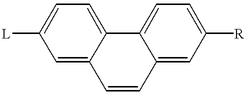

| L | R | Cr | LC |
|---|---|---|---|
| C₃H₇— | —CO—C₇H₁₅ | K 116 | A 119 I |
| C₄H₉— | —CO—C₆H₁₃ | K 114 | A 123 I |
| C₅H₁₁— | —CO—C₅H₁₁ | K 107 | E 83 A 127 I |
| C₆H₁₃— | —CO—C₄H₉ | K 92 | E 92 A 126 I |
| C₇H₁₅— | —CO—C₃H₇ | K 75 | E 73 A 107 I |
| C₈H₁₇— | —CO—C₂H₅ | K 80 | E 55 A 117 I |
| C₉H₁₉— | —CO—C₂H₅ | K 75 | A 120 I |
| C₉H₁₉— | —CO—C₃H₇ | K 74 | E 64 A 104 I |
| C₉H₁₉— | —CO—C₄H₉ | K 71 | A 118 I |
| C₉H₁₉— | —CO—C₅H₁₁ | K 98 | A 118 I |
| C₆H₁₃—O— | —O—C₆H₁₃ | K 114 | S 125 I |
| C₇H₁₅—O— | —O—C₇H₁₅ | K 99 | S 101 S 123 I |
| C₈H₁₇—O— | —O—C₈H₁₇ | K 90 | S 93 S 122 I |
| C₉H₁₉—O— | —O—C₉H₁₉ | K 93 | S 119 I |
| C₁₀H₂₁—O— | —O—C₁₀H₂₁ | K 94 | S 117 I |
| C₁₁H₂₃—O— | —O—C₁₁H₂₃ | K 98 | S 113 I |
| C₁₂H₂₅—O— | —O—C₁₂H₂₅ | K 99 | S 109 I |
| C₄H₉—CO— | —CO—C₄H₉ | K 130 | E 108 A 157 I |
| C₅H₁₁—CO— | —CO—C₅H₁₁ | K 149 | A 164 I |
| C₆H₁₃—CO— | —CO—C₆H₁₃ | K 146.5 | A 166 I |
| C₇H₁₅—CO— | —CO—C₇H₁₅ | K 140 | A 167 I |
| C₅H₁₁—COO— | —OOC—C₅H₁₁ | K 109 | A 117 B |
| C₆H₁₃—COO— | —OOC—C₆H₁₃ | K 72 | X 105 A 119 B |
| C₇H₁₅—COO— | —OOC—C₇H₁₅ | K 57 | X 83 X 93 A 123 B |
| C₉H₁₉—COO— | —OOC—C₉H₁₉ | K 88 | A 126 B |

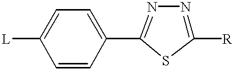

| L | R | | Cr | LC |
|---|---|---|---|---|
| C₅H₁₁—O— | —C₇H₁₅ | | K 78 | A 73 I |
| C₆H₁₃—O— | —C₆H₁₃ | | K 79 | A 74 I |
| C₆H₁₃—O— | —C₇H₁₅ | | K 83 | A 82 I |
| C₇H₁₅—O— | —C₅H₁₁ | | K 72 | C 74 A 79 I |
| C₇H₁₅—O— | —C₆H₁₃ | | K 74 | C 81 I |
| C₇H₁₅—O— | —C₇H₁₅ | | K 79 | C 89 I |
| C₇H₁₅—O— | —C₈H₁₇ | | K 70 | C 85 I |
| C₇H₁₅—O— | —C₉H₁₉ | | K 77 | C 89 I |
| C₇H₁₅—O— | —C₁₀H₂₁ | | K 75 | C 86 I |
| C₈H₁₇—O— | —C₅H₁₁ | | K 73 | C 69 A 81 I |
| C₈H₁₇—O— | —C₆H₁₃ | | K 73 | C 80 A 83 I |
| C₈H₁₇—O— | —C₇H₁₅ | | K 80 | C 87 I |
| C₈H₁₇—O— | —C₈H₁₇ | | K 80 | C 90 I |
| C₈H₁₇—O— | —C₉H₁₉ | | K 77 | C 90 I |
| C₈H₁₇—O— | —C₁₀H₂₁ | | K 78 | G 70 C 90 I |
| C₉H₁₉—O— | —C₅H₁₁ | | K 69 | G 53 C 68 A 82 I |
| C₉H₁₉—O— | —C₆H₁₃ | | K 62 | G 61 C 81 A 83 I |
| C₉H₁₉—O— | —C₇H₁₅ | | K 72 | C 87 I |
| C₉H₁₉—O— | —C₉H₁₉ | | K 76 | C 90 I |
| C₁₀H₂₁—O— | —C₅H₁₁ | | K 73 | F 55 C 57 A 84 I |
| C₁₀H₂₁—O— | —C₆H₁₃ | | K 50.6 | S 65.4 C 81.1 A 85.4 I |
| C₁₀H₂₁—O— | —C₇H₁₅ | | K 70 | C 89 I |
| C₁₀H₂₁—O— | —C₉H₁₉ | | K 79 | C 92 I |
| C₄H₉—CMe₂—C₄H₈—O— | —C₇H₁₅ | | K 49 | C 33 I |
| C₄H₉—CMe₂—C₈H₁₂—O— | —C₇H₁₅ | | K 54 | C 55 I |
| C₇H₁₅—COO— | —C₇H₁₅ | | K 79 | B 66 A 73 I |
| C₈H₁₇—COO— | —C₉H₁₉ | | K 85 | C 84.5 I |
| C₁₁H₂₃—COO— | —C₁₁H₂₃ | | K 88 | B 85 I |
| C₈H₁₇—O— | —CHMe—C₂H₅ | 1 | K 52 | A 19 I |
| C₇H₁₅— | —C₄H₈—CHMe—C₂H₅ | S | K 42.6 | C* 27.5 A 34 I |

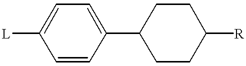

| L | R | | Cr | LC |
|---|---|---|---|---|
| C₆H₁₃—O— | —CH═CH—CH₂—O—CH₃ | | K 16 | B 30 N 38 I |
| C₇H₁₅—O— | —CH═CH—CH₂—O—CH₃ | | K 14 | B 38 I |
| CH₃—CO— | —C₃H₇ | | K 45 | S 54 I |
| C₄H₉—CO— | —C₅H₁₁ | | K 60.7 | B 52.5 N 58 I |
| C₄H₉—CO— | —C₇H₁₅ | | K 56.5 | A 50.5 N 64.3 I |
| C₆H₁₃—CO— | —C₇H₁₅ | | K 70 | B 71.5 I |
| C₈H₁₇—CO— | —C₇H₁₅ | | K 70.2 | E 43 B 80.1 I |
| C₃H₇—CF₂—CO— | —C₅H₁₁ | | K 20 | B 33 N 53.9 I |
| CH₃—NH—CH%CH—CO— | —C₆H₁₃ | | K 107.8 | A 144.3 N 153 I |
| C₂H₅—NH—CH%CH—CO— | —C₆H₁₃ | | K 68.4 | A 76.8 N 120 I |
| C₆H₁₃—NH—CH%CH—CO— | —C₆H₁₃ | | K 61 | C 35 N 104.2 I |
| C₇H₁₅—NH—CH%CH—CO— | —C₆H₁₃ | | K 55.2 | H 40 C 68.9 N 107.8 I |
| C₈H₁₇—NH—CH%CH—CO— | —C₆H₁₃ | | K 50.8 | H 57.8 C 80.3 N 104 I |
| C₉H₁₉—NH—CH%CH—CO— | —C₆H₁₃ | | K 54 | H 74.6 C 94.1 N 107.3 I |
| C₁₀H₂₁—NH—CH%CH—CO— | —C₆H₁₃ | | K 61.3 | H 83.3 C 100.1 N 105.2 I |
| C₁₁H₂₃—NH—CH%CH—CO— | —C₆H₁₃ | | K 66.7 | H 94.4 C 106.6 N 109.3 I |
| C₁₂H₂₅—NH—CH%CH—CO— | —C₆H₁₃ | | K 64.1 | H 97.8 C 109 N 109.4 I |
| C₁₃H₂₇—NH—CH%CH—CO— | —C₆H₁₃ | | K 65 | H 103.2 C 111.4 I |
| C₁₄H₂₉—NH—CH%CH—CO— | —C₆H₁₃ | | K 55 | H 102.1 C 109.8 I |
| C₁₅H₃₁—NH—CH%CH—CO— | —C₆H₁₃ | | K 54.2 | H 106.1 C 110.6 I |
| C₁₈H₃₇—NH—CH%CH—CO— | —C₆H₁₃ | | K 54.1 | H 107.4 I |
| C₄H₉—OOC— | —C₅H₁₁ | | K 11 | A −4 N −3.2 I |
| C₃H₇—COO— | —C₃H₇ | | K 11 | B 26.1 N 30.3 I |
| C₄H₉—COO— | —C₃H₇ | | K 32.3 | B 42.7 I |
| C₅H₁₁—COO— | —C₇H₁₅ | | K 34.2 | B 64.5 I |
| C₈H₁₇—O— | —OOC—CH₂—CHMe—C₃H₆—CHMe—CH₃ | S | K 53 | B 39 I |
| C₁₀H₂₁—O— | —OOC—CHF—C₄H₉ | S | K 42.5 | B 41 I |
| C₅H₁₁—O— | —OOC—CHF—C₄H₉ | R | K 42 | B 59 I |
| C₆H₁₃—O— | —OOC—CHF—C₄H₉ | R | K 52 | B 59 I |
| C₇H₁₅—O— | —OOC—CHF—C₄H₉ | R | K 42 | B 64 I |

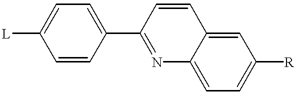

| L | R | Cr | LC |
|---|---|---|---|
| C₂H₅—O— | —CN | K 150 | S 144 N 189 I |
| C₈H₁₇— | —C₆H₁₃ | K 68 | C 106 N 116 I |
| C₅H₁₁— | —O—C₄H₉ | K 77 | S 76 N 118 I |
| C₅H₁₁—O— | —C₅H₁₁ | K 73 | C 77 N 118 I |
| C₅H₁₁—O— | —C₆H₁₃ | K 73 | C 88 N 114 I |
| C₅H₁₁—O— | —C₇H₁₅ | K 71 | C 96 A 98 N 118 I |
| C₅H₁₁—O— | —C₈H₁₇ | K 73 | C 92 A 105 N 112 I |
| C₆H₁₃—O— | —C₅H₁₁ | K 68 | C 93 N 125 I |
| C₆H₁₃—O— | —C₆H₁₃ | K 66 | C 98 N 117 I |
| C₆H₁₃—O— | —C₇H₁₅ | K 65 | C 104 A 106 N 121 I |
| C₆H₁₃—O— | —C₈H₁₇ | K 69 | C 104 A 113 N 117 I |
| C₇H₁₅—O— | —C₅H₁₁ | K 73 | C 98 N 121 I |
| C₇H₁₅—O— | —C₆H₁₃ | K 70 | C 105 N 116 I |
| C₇H₁₅—O— | —C₇H₁₅ | K 70 | C 109 A 113 N 120 I |
| C₇H₁₅—O— | —C₈H₁₇ | K 71 | C 109 A 115 N 116 I |
| C₈H₁₇—O— | —C₅H₁₁ | K 72 | C 104 N 120 I |
| C₈H₁₇—O— | —C₆H₁₃ | K 68 | C 106 N 116 I |
| C₈H₁₇—O— | —C₇H₁₅ | K 70 | C 109 A 117 N 120 I |
| C₈H₁₇—O— | —C₈H₁₇ | K 69 | C 113 A 118 I |
| C₉H₁₉—O— | —C₅H₁₁ | K 76 | C 107 A 109 N 118 I |
| C₉H₁₉—O— | —C₆H₁₃ | K 76 | C 111 A 113 N 116 I |
| C₉H₁₉—O— | —C₇H₁₅ | K 76 | C 113 A 119 I |
| C₉H₁₉—O— | —C₈H₁₇ | K 75 | C 114 A 117 I |
| C₁₀H₂₁—O— | —C₅H₁₁ | K 77 | C 107 A 113 N 118 I |
| C₁₀H₂₁—O— | —C₆H₁₃ | K 75 | C 110 A 114 N 116 I |
| C₁₀H₂₁—O— | —C₇H₁₅ | K 74 | C 114 A 119 I |
| C₁₀H₂₁—O— | —C₈H₁₇ | K 68 | C 114 A 116 I |
| C₁₁H₂₃—O— | —C₅H₁₁ | K 83 | C 105 A 114 N 116 I |
| C₁₁H₂₃—O— | —C₆H₁₃ | K 82 | C 110 A 115 I |
| C₁₁H₂₃—O— | —C₇H₁₅ | K 81 | C 113 A 118 I |

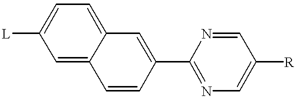

| L | R | | Cr | LC |
|---|---|---|---|---|
| C₇H₁₅— | —CN | | K 125.6 | S 154.1 N 163.7 I |
| C₈H₁₇—O— | —O—C₈H₁₇ | | K 93 | C 105 A 111 N 129 I |
| C₈H₁₇—O— | —O—CH₂—CH/O\CH[t]-C₄H₉ | S | K 85 | C* 128.4 A 130.5 N* 141 I |

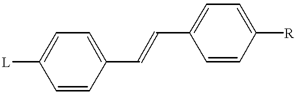

| L | R | | Cr | LC |
|---|---|---|---|---|
| NC— | —O—C₅H₁₀—SiMeCl₂ | | K 119.4 | S 191.4 I |
| C₁₀H₂₁—O— | —H | | K 106.8 | B 94 I |
| C₇H₁₅— | —CN | | K 61.5 | S 73.5 N 96 I |
| C₈H₁₇— | —CN | | K 52 | S 57.5 A 80 N 89 B |
| C₉H₁₉— | —CN | | K 56.2 | A 94.4 N 96.7 I |
| C₁₀H₂₁— | —CN | | K 47.2 | A 95.1 I |
| C₁₁H₂₃— | —CN | | K 65.5 | A 100.2 I |
| C₇H₁₅—O— | —CN | | K 80 | A 80.5 N 126 B |
| C₈H₁₇—O— | —CN | | K 103 | A 110 N 128 B |
| C₁₀H₂₁—O— | —CN | | K 87 | A 129 B |
| C₁₇H₃₆—CONH— | —CN | | K 144 | S 159 I |
| C₂H₅—CHMe—C₄H₈— | —CN | 1 | K 59.4 | S 67.2 I |
| C₂H₅—CHMe—C₅H₁₀— | —CN | | K 44.7 | S 68.3 I |
| C₇H₁₅—O— | —NO₂ | | K 77.5 | A 94 N 106.5 B |
| C₈H₁₇—O— | —NO₂ | | K 111 | A 111 N 114 I |
| C₁₀H₂₁—O— | —NO₂ | | K 97 | A 116 I |
| C₁₂H₂₅—O— | —NO₂ | | K 85 | A 115 I |
| C₁₂H₂₅—NH— | —NO₂ | | K 109 | E 141 I |
| C₁₈H₃₇—NH— | —NO₂ | | K 112.1 | E 132 I |
| C₁₇H₃₅—CONH— | —NO₂ | | K 139 | A 160 B |
| C₈H₁₇— | —C₈H₁₇ | | K 46 | H 106 G 108 I |
| C₉H₁₉— | —C₉H₁₉ | | K 41 | H 93 G 109 I |
| C₁₀H₂₁— | —C₁₀H₂₁ | | K 64 | H 92 G 106 I |
| C₁₁H₂₃— | —C₁₁H₂₃ | | K 61 | S 70 H 85 G 106 I |
| C₁₂H₂₅— | —C₁₂H₂₅ | | K 75 | S 77 H 81 G 103 I |
| C₅H₁₁— | —O—CH₃ | | K 118 | B 109.8 N 124.7 I |
| C₅H₁₁— | —O—C₈H₁₇ | | K 121.3 | S 121.1 S 125.5 S 131 I |
| CH₃—O— | —O—C₉H₁₉ | | K 149 | S 142.5 N 142.6 I |
| CH₃—O— | —O—C₁₂H₂₅ | | K 142 | S 136 I |
| CH₃—O— | —O—C₁₄H₂₉ | | K 139 | S 132 I |

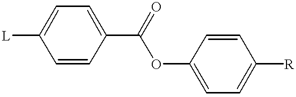

| L | R | Cr | LC |
|---|---|---|---|
| C₉H₁₉— | —O—C₇H₁₅ | K 46 | C 41 N 61 I |
| C₉H₁₉— | —O—C₈H₁₇ | K 53 | C 48 N 64 I |
| C₉H₁₉— | —O—C₉H₁₉ | K 54 | C 52 N 63 I |
| C₉H₁₉— | —O—C₁₀H₂₁ | K 58.7 | C 57.9 N 65.8 I |
| C₉H₁₉— | —O—C₁₂H₂₅ | K 62.1 | B 47.5 C 63.1 A 63.8 N 66.5 I |
| C₉H₁₉— | —O—C₁₄H₂₉ | K 63.7 | B 55.7 C 65.4 A 66.8 I |
| C₉H₁₉— | —O—C₁₆H₃₃ | K 69.4 | B 61.3 C 66.4 A 67.6 I |
| C₁₀H₂₁— | —O—C₅H₁₁ | K 52.5 | A 42.4 N 52.5 I |
| C₁₀H₂₁— | —O—C₆H₁₃ | K 44.1 | B 33.6 A 47.7 N 59 I |
| C₁₀H₂₁— | —O—C₇H₁₅ | K 52.8 | B 38.2 C 40.6 A 51.7 N 58.7 I |
| C₁₀H₂₁— | —O—C₈H₁₇ | K 55.2 | B 40.5 C 52.4 A 55.9 N 82.5 I |
| C₁₀H₂₁— | —O—C₁₀H₂₁ | K 61.4 | B 45.9 C 60.5 A 62.1 N 64.5 I |
| C₁₀H₂₁— | —O—C₁₂H₂₅ | K 64.5 | B 51 C 64.1 A 65.7 I |
| C₁₀H₂₁— | —O—C₁₄H₂₉ | K 65.2 | B 58.1 C 66.7 I |
| C₁₀H₂₁— | —O—C₁₆H₃₃ | K 67.2 | B 64.2 C 69.6 I |
| C₁₂H₂₅— | —O—C₁₆H₃₃ | K 73.7 | B 68.9 C 71 I |
| C₆H₁₃— | —CO—C₄H₉ | K 80 | A 76 I |
| C₆H₁₃— | —CO—C₅H₁₁ | K 91.6 | A 80.4 I |
| C₆H₁₃— | —CO—C₇H₁₅ | K 91.4 | A 85.8 I |
| C₉H₁₉— | —CO—C₅H₁₁ | K 86.7 | A 88.5 I |
| C₁₀H₂₁— | —CO—C₄H₉ | K 81.4 | A 87.3 I |
| C₁₀H₂₁— | —CO—C₅H₁₁ | K 87.8 | A 93.3 I |
| C₁₀H₂₁— | —CO—C₇H₁₅ | K 97.1 | A 93 I |
| C₄H₉— | —CO—CH₂—OOC—C₃H₇ | K 80.2 | S 90.4 N 95.6 I |
| C₁₀H₂₁— | —OOC—C₇H₁₅ | K 69 | C 61.7 N 70.4 I |
| C₆H₁₃—O— | —C₆H₁₃ | K 43.7 | A 36.7 N 59.6 I |
| C₆H₁₃—O— | —C₈H₁₇ | K 43.6 | A 42.1 N 61.6 I |
| C₆H₁₃—O— | —C₉H₁₉ | K 38.3 | C 26.1 A 40 N 65.2 I |
| C₆H₁₃—O— | —C₁₀H₂₁ | K 51 | A 49 N 62 I |
| C₆H₁₃—O— | —C₁₂H₂₅ | K 61.2 | A 51.4 N 62.2 I |

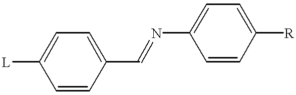

| L | R | Cr | LC |
|---|---|---|---|
| C₄H₉—O— | —CH₃ | K 65 | G 45 N 72 I |
| C₄H₉—O— | —C₂H₅ | K 40.5 | G 51 N 65.5 I |
| C₄H₉—O— | —C₄H₉ | K 8 | G 41 B 45 A 45.5 N 75 I |
| C₄H₉—O— | —C₅H₁₁ | K 28 | S 30 S 41.5 A 44.4 N 84.6 I |
| C₄H₉—O— | —C₆H₁₃ | K 26 | B 47.3 A 54.7 N 76.9 I |
| C₄H₉—O— | —C₇H₁₅ | K 20 | S 29 B 48.8 A 56.6 N 83.3 I |
| C₄H₉—O— | —C₈H₁₇ | K 33 | B 49.5 A 64.5 N 79 I |
| C₄H₉—O— | —C₉H₁₉ | K ? | B 48 A 64.7 N 80.2 I |
| C₄H₉—O— | —C₁₀H₂₁ | K 44.3 | B 46.8 A 64.7 N 76.7 I |
| C₄H₉—O— | —C₁₂H₂₅ | K 37.5 | G 45.6 B 52.5 A 69.4 N 76.7 I |
| C₅H₁₁—O— | —CH₃ | K 55 | G 44 N 70.5 I |
| C₅H₁₁—O— | —C₂H₅ | K 49.2 | G 54.2 N 59 I |
| C₅H₁₁—O— | —C₃H₇ | K 24 | A 58 N 77.7 B |
| C₅H₁₁—O— | —C₄H₉ | K 20 | G 51.9 A 52.4 N 69.2 I |
| C₅H₁₁—O— | —C₅H₁₁ | K 28 | G 46.1 B 48 C 52 A 53 N 77.5 I |
| C₅H₁₁—O— | —C₆H₁₃ | K 34.5 | G 41 F 44.3 B 51.6 C 53 A 61.1 N 72.9 I |
| C₅H₁₁—O— | —C₇H₁₅ | K 29.5 | G 33.9 B 51 C 53.1 A 62.8 N 78 I |
| C₅H₁₁—O— | —C₈H₁₇ | K 43.2 | G 26.2 B 53.7 A 67.8 N 75.1 I |
| C₅H₁₁—O— | —C₉H₁₉ | K ? | B 52.9 A 68.7 N 76.7 I |
| C₅H₁₁—O— | —C₁₀H₂₁ | K 41 | B 54 A 67 N 76.2 I |
| C₅H₁₁—O— | —C₁₁H₂₃ | K ? | B 53 A 70.4 N 75.1 I |
| C₅H₁₁—O— | —C₁₂H₂₅ | K 37 | B 53.3 A 71 N 73.9 I |
| C₅H₁₁—O— | —C₁₃H₂₇ | K ? | B 52.9 A 70.2 N 73.2 I |
| C₅H₁₁—O— | —C₁₄H₂₉ | K ? | B 52.7 A 69.5 N 71.2 I |
| C₆H₁₃—O— | —CH₃ | K 58 | G 44 B 53 N 76 I |
| C₆H₁₃—O— | —C₂H₅ | K 47 | G 58 N 70 I |
| C₆H₁₃—O— | —C₃H₇ | K 29 | G 65.7 A 68 N 85.6 I |
| C₆H₁₃—O— | —C₄H₉ | K 33.5 | G 58.5 B 59.8 A 70.1 N 77.8 I |
| C₆H₁₃—O— | —C₅H₁₁ | K 41.9 | G 45.6 B 62 A 75.1 N 85 I |
| C₆H₁₃—O— | —C₆H₁₃ | K 15 | G 35 B 63 A 77 N 82 I |

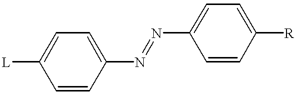

| L | R | Cr | LC |
|---|---|---|---|
| C₈H₁₇— | —C₈H₁₇ | K 47.9 | A 36.4 N 41.8 I |
| C₉H₁₉— | —C₉H₁₉ | K 37 | B 40.5 A 53.2 I |
| C₁₀H₂₁— | —C₁₀H₂₁ | K 42.3 | B 44.6 A 53.7 I |
| CH₃— | —O—C₅H₁₁ | K 61 | S 48 N 63 I |
| C₄H₉— | —O—C₇H₁₅ | K 53.7 | C 40.3 N 70.2 I |
| C₄H₉— | —O—C₈H₁₇ | K 55.2 | B 35 C 54.2 A 57.6 N 75.2 I |
| C₄H₉— | —O—C₉H₁₉ | K 62.1 | C 58.9 A 63.8 N 73.2 I |
| C₄H₉— | —O—C₁₀H₂₁ | K 54.4 | B 50.3 C 61.5 A 69.4 N 75.8 I |
| C₄H₉— | —O—C₁₂H₂₅ | K 62 | I 60 C 64 A 76 N 76.2 I |
| C₄H₉— | —O—C₁₄H₂₉ | K 64 | S 68 C 69 A 77 I |
| C₄H₉— | —O—C₁₈H₃₇ | K 72.5 | S 72 A 77 I |
| C₈H₁₇— | —O—C₇H₁₅ | K 53.2 | C 56.6 A 60.2 N 77.5 I |
| C₉H₁₉— | —O—C₈H₁₇ | K 49.2 | I 44.8 C 66 A 77.8 N 84.7 I |
| C₉H₁₉— | —O—C₉H₁₉ | K 51 | I 51.5 C 72.5 A 80.5 N 84.7 I |
| C₉H₁₉— | —O—C₁₀H₂₁ | K 42.5 | I 62.3 C 77.2 A 87.3 I |
| C₉H₁₉— | —O—C₁₂H₂₅ | K 41.5 | G 52 I 72.2 C 83 A 88.3 I |
| C₉H₁₉— | —O—C₁₄H₂₉ | K 51 | G 68 I 81.1 C 88.2 I |
| C₉H₁₉— | —O—C₁₆H₃₃ | K 57.5 | G 77.7 I 86.2 C 88.6 I |
| C₉H₁₉— | —O—C₁₈H₃₇ | K 63 | G 81.8 I 89 I |
| CH₃—OOC—CH═CH— | —CH═CH—COO—CH₃ | K 237 | S 246 S 249 I |
| CH₃—OOC—CH═CH— | —CH═CH—COO—C₂H₅ | K 237 | S 246 S 249 I |
| CH₃OOC—CH═CH— | —CH═CH—COO—C₂H₅ | K 237 | S 246 S 249 I |
| C₂H₅OOC—CH═CH— | —CH═CH—COO—C₂H₅ | K 156 | A 240 I |
| C₃H₇OOC—CH═CH— | —CH═CH—COO—C₃H₇ | K 120 | S 209 I |
| CH₃—O— | —CH═CH—COO—C₂H₅ | K 117.7 | A 124.2 N 142.8 I |
| C₂H₅—O— | —CH═CH—COO—C₂H₅ | K 110 | S 137 S 147 N 160 I |
| C₅H₁₁—O— | —CH═CH—COO—C₅H₁₁ | K 87 | E 91 A 133 I |
| C₅H₁₁—O— | —CH═CH—COOO—C₁₀H₂₁ | K 50.5 | E 64 A 119 I |
| C₁₀H₂₁—O— | —CH═CH—COO—C₅H₁₁ | K 54 | B 94.5 C 95 A 127.5 I |
| C₁₀H₂₁—O— | —CH═CH—COO—C₁₀H₂₁ | K 59 | E 60 B 72 C 95 A 116.5 I |
| CH₃—COO— | —CH═CH—COO—C₂H₅ | K 138.3 | A 153.2 N 162.2 I |

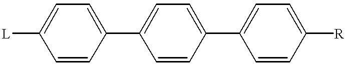

| L | R | | Cr | LC |
|---|---|---|---|---|
| C₇H₁₅—O—CHMe—CH₂—OOC— | —COO—CH₂—CHMe—O—C₇H₁₅ | 3 | K 57.8 | A 80.1 I |
| C₈H₁₇—O—CHMe—CH₂—OOC— | —COO—CH₂—CHMe—O—C₈H₁₇ | 3 | K 63 | A 84.1 I |
| CH₃—COO— | —OOC—CH₃ | | K 229 | S 282.5 X 284.5 I |
| CH₃—OCOO— | —OCOO—CH₃ | | K 229 | S 257 N 277 I |
| C₂H₅—OCOO— | —OCOO—C₂H₅ | | K 213 | S 225.5 X 242.5 I |
| C₅H₁₁— | —CHCN—OOC—CHMe—C₂H₅ | 5 | K 124 | A <7 I |
| C₁₀H₂₁— | —O—CHMe—C₅H₁₁ | R | K 76.5 | S 101.5 S 116 C* 122.5 A 126 I |
| C₈H₁₇— | —COO—CHMe—C₆H₁₃ | 1 | K 116.5 | A 123.4 I |
| C₈H₁₇— | —COO—CH₂—CHMe—C₂H₅ | 1 | K 104.7 | S 125.1 G* 126.9 B 147.6 A 173.5 I |
| C₈H₁₇— | —COO—CH₂—CHCl—CH₂—CHMe—CH₃ | 1 | K 114.2 | G* 106 I* 114.2 A 153.5 I |
| C₈H₁₇— | —COO—CH₂—CHCN—CH₂—CHMe—CH₃ | 1 | K 81.8 | B 83.8 A 96.7 I |
| C₅H₁₁— | —O—C₃H₅—CHMe—C₂H₅ | S | K ? | B 198 A 215.5 I |
| C₁₀H₂₁— | —O—C₃H₅—CHMe—C₂H₅ | S | K 65 | S 181.5 C* 188.5 A 191 I |
| C₈H₁₇— | —COO—CH₂—CHCl—CH₃ | 1 | K 54.9 | S 111.7 G* 148.5 C* 149.1 A 195.4 I |
| C₈H₁₇— | —COO—CH₂—CHCl—C₄H₉ | 1 | K 123.6 | G* 130.6 C* 139.7 A 169.5 I |
| C₈H₁₇— | —COO—CH₂—CHCN—CH₃ | 1 | K 138 | C* 151.4 A 168.5 I |
| C₈H₁₇— | —COO—CH₂—CHCN—C₂H₅ | 1 | K 77.8 | G* 99.7 I* 118.6 A 139.6 I |
| C₈H₁₇— | —COO—CH₂—CHCN—C₃H₇ | 1 | K 97 | B 92.8 A 112.7 I |
| C₈H₁₇— | —COO—CH₂—CHCN—C₄H₉ | 1 | K 78.8 | B 86.7 A 101.2 I |
| C₅H₁₁— | —O—CF₃ | | K 211 | B 221 A 239 I |
| C₅H₁₁— | —O—CF₂—H | | K 223 | A 241 I |
| C₃H₇—O—CH₂— | —O—CH₂—CH/C\CH(t)—C₃H₇ | S | K 210 | E 227.8 A 257.3 I |
| C₆H₁₃—CHMe—OOC— | —COO—CH₂—CHCl—CHMe—C₂H₅ | * | K 55.2 | C* 57.9 A 79.1 I |
| C₆H₁₃—CHMe—OOC— | —COO—CH₂—CHCl—CH₂—CHMe—CH₃ | 3 | K 58.9 | C* 54.8 A 61.9 I |
| C₆H₁₃—CHMe—OOC— | —COO—CH₂CHCl—CH₃ | 3 | K 79.8 | C* 90.4 A 120.2 I |
| C₆H₁₃—CHMe—OOC— | —COO—CH₂—CHCl—C₃H₇ | 3 | K 84.9 | C* 78.3 A 84.3 I |
| C₆H₁₃—CHMe—OOC— | —COO—CH₂—CHCl—C₄H₉ | 3 | K 91.8 | A 83.8 I |
| C₂H₅—CHMe—CH₂—OOC— | —COO—CH₂—CHMe—C₂H₅ | 3 | K 132 | A 143 N* 145 I |
| CH₃—CHCl—CH₂—OOC— | —COO—CH₂—CHCl—CH₃ | 3 | K 123 | A 135 N* 138 I |
| C₂H₅—CHCl—CH₂—OOC— | —COO—CH₂—CHCl—C₂H₅ | 3 | K 137.3 | A 138.3 N* 151.5 BP 152.2 I |

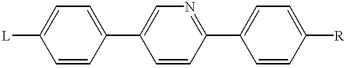

| L | R | | Cr | LC |
|---|---|---|---|---|
| C₆H₉—COO—CHMe—CH₂—O— | —C₉H₁₉ | S | K 82.9 | S 101.2 C* 121.7 I |
| C₃H₇—COO—CH₂—CHMe—CH₂—O— | —C₆H₁₃ | R | K ? | S 89 S 114 S 132 C* 145 A 145.5 I |
| C₃H₇—O—CHMe—COO—CHMe—CH₂—O— | —C₅H₁₁ | S | K 76.2 | C* 101 A 113.3 N* 114.9 I |
| C₃H₇—O—CHMe—COO—CHMe—CH₂—O— | —C₆H₁₃ | S | K 75.1 | C* 100.7 A 105.6 N* 109.2 I |
| C₃H₇—O—CHMe—COO—CHMe—CH₂—O— | —C₇H₁₈ | S | K 73.5 | C* 104.2 N* 111.2 I |
| C₃H₇—O—CHMe—COO—CHMe—CH₂—O— | —C₉H₁₉ | S | K 70.1 | C* 102.7 A 107.9 N* 109.5 I |
| C₄H₉—O—CHMe—COO—CHMe—CH₂—O— | —C₅H₁₁ | S | K 78 | C* 93.4 A 111.1 I |
| C₄H₉—O—CHMe—COO—CHMe—CH₂—O— | —C₆H₁₃ | S | K 67.6 | C* 94 A 106.1 I |
| C₄H₉—O—CHMe—COO—CHMe—CH₂—O— | —C₇H₁₅ | S | K 83.5 | C* 97.8 A 106.8 I |
| C₄H₉—O—CHMe—COO—CHMe—CH₂O— | —C₉H₁₉ | S | K 68.9 | C* 107 I |
| C₂H₅—O—CH₂—COO—CH₂—CHMe —CH₂—O— | —C₆H₁₃ | R | K 63 | S 77.6 S 122.3 C* 132.3 A 138.8 I |
| C₃H₇—O—CHMe—COO—CH₂—CHMe—CH₂—O— | —C₆H₁₃ | R | K ? | S 62 S 99 C* 116 A 117.4 I |
| C₃H₇—O—CHMe—COO— | —C₆H₁₃ | R | K 110 | S 116 S 132 C* 161.4 I |
| C₅H₁₁— | —O—CHMe—C₆H₁₃ | 1 | K 78 | A 139 I |
| C₅H₁₁— | —O—CHMe—C₁₀H₂₁ | 1 | K 70 | A 127 I |
| C₅H₁₁—O— | —O—CHMe—C₆H₁₃ | 1 | K 104 | S 117 B 132 C* 142 A 185 I |
| C₄H₉— | —O—CH₂—CHMe—C₂H₅ | R | K ? | H 118.5 G* 139.2 F* 144.4 B 158.7 C* 165.8 A 191.4 I |
| C₇H₁₈—O— | —O—CH₂—CHMe—C₂H₅ | 1 | K 114 | E 127 F* 168 C* 213 A 215 I |
| C₈H₁₇—O— | —O—CH₂—CHMe—C₂H₅ | 1 | K 110 | E 122 F* 164 C* 212 A 214 I |
| C₉H₁₉—O— | —O—CH₂—CHMe—C₂H₅ | 1 | K 97 | E 117 F* 160 C* 207 A 208 I |
| C₁₀H₂₁—O— | —O—CH₂—CHMe—C₂H₅ | 1 | K 85 | E 108 F* 146 C* 205 A 206 I |
| C₈H₁₇— | —O—C₄H₉—CHMe—C₃H₇ | 2 | K 67 | S 109 S 180 C 194 A 215 I |
| C₄H₉— | —OOC—C₄H₉—CHMe—C₂H₅ | R | K ? | G* 111.3 F* 152.4 B 182.8 A 207 I |
| C₄H₉— | —O—C₅H₁₀—CHMe—C₂H₅ | R | K 61 | S 96.8 S 102.5 S 170 C* 182.3 A 196.3 I |
| C₈H₁₇— | —O—CH₂—CHF—C₆H₁₃ | R | K 75.4 | S 106 B 153.7 C* 158.5 A 183.3 I |
| C₆H₁₃—CHMe—O— | —C₅H₁₁ | 1 | K 58 | C* 115 A 118 N* 117 I |
| C₂H₅—CHMe—COO—CHMe—CH₂—O— | —C₆H₁₃ | 3 | K 107 | C* 112 I |
| C₂H₅—CHMe—COO—CHMe—CH₂—O— | —C₇H₁₅ | 3 | K 101 | C* 113.1 I |
| C₂H₅—CHMe—COO—CHMe—CH₂—O— | —C₉H₁₉ | 3 | K 92.3 | C* 108.6 N* 110.8 I |
| C₆H₁₃—CHMe—OOC— | —C₆H₁₃ | R | K 57.4 | S 80 S 90.3 C* 94 A 118.5 I |

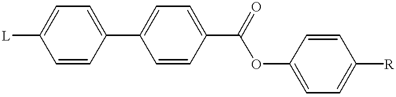

| L | R | | Cr | LC |
|---|---|---|---|---|
| C₃H₇— | —COO—CH₂—CHMe—C₂H₅ | 1 | K 127 | A 158 N* 166 I |
| C₅H₁₁— | —COO—CH₂—CHMe—C₂H₅ | 1 | K 89 | A 161.6 N* 162.3 I |
| C₆H₁₃— | —COO—CH₂—CHMe—C₂H₅ | 1 | K 68 | C* 86 A 157 I |
| C₇H₁₅— | —COO—CH₂—CHMe—C₂H₅ | 1 | K 62 | C* 90 A 158 I |
| C₈H₁₇— | —COO—CH₂—CHMe—C₂H₅ | 1 | K 67 | C* 101 A 153 I |
| C₉H₁₇— | —COO—CH₂—CHMe—C₂H₅ | 1 | K 53 | C* 100 A 151 I |
| C₁₀H₂₁— | —COO—CH₂—CHMe—C₂H₅ | 1 | K 57 | C* 102 A 148 I |
| C₁₂H₂₅— | —COO—CH₂—CHMe—C₂H₅ | 1 | K 42 | C* 81 A 175 U |
| C₅H₁₁— | —COO—CH₂—CHMe—C₂H₅ | 2 | K 106.5 | A 163 I |
| C₈H₁₇— | —COO—CH₂—CHMe—C₂H₅ | 2 | K 68.9 | I 51.4 C 103.6 A 154.5 I |
| C₈H₁₇— | —COO—CH₂—CHMe—C₃H₇ | 2 | K 57.2 | I 36.4 C 93.7 A 150.4 I |
| C₈H₁₇— | —COO—CH₂—CHMe—C₄H₉ | 2 | K 54.5 | I 35.7 C 91.7 A 145 I |
| C₇H₁₅— | —OCOO—CH₂—CHMe—C₂H₅ | S | K 88.8 | B 105 A 160.7 N* 163.8 I |
| C₈H₁₇— | —OCOO—CH₂—CHMe—C₂H₅ | S | K 78.3 | A 150.2 N* 165.2 I |
| C₄H₉—O— | —CH₂—CHMe—C₂H₅ | S | K 107 | E 102 A 174 N* 193 I |
| C₅H₁₁—O— | —CH₂—CHMe—C₂H₅ | S | K 91 | E 70 B 96 A 172 N* 186 I |
| C₆H₁₃—O— | —CH₂—CHMe—C₂H₅ | S | K 88.5 | J* 84 C* 103.5 A 172 N* 182 I |
| C₇H₁₅—O— | —CH₂—CHMe—C₂H₅ | S | K 86.5 | K 66 J* 70 I* 79 C* 126 A 170 N* 177 I |
| C₈H₁₇—O— | —CH₂—CHMe—C₂H₅ | S | K 77 | K 61 J* 72 I* 80 C* 132 A 171 N* 174 I |
| C₉H₁₉—O— | —CH₂—CHMe—C₂H₅ | S | K 82 | K 61 J* 70 I* 79 C* 133 A 169 N* 171 I |
| C₁₀H₂₁—O— | —CH₂—CHMe—C₂H₅ | S | K 38 | K 60 J* 70 I* 79 C* 133 A 167 I |
| C₁₂H₂₅—O— | —CH₂—CHMe—C₂H₅ | S | K 74 | J* 68 I* 79 C* 131 A 162 I |
| C₁₄H₂₉—O— | —CH₂—CHMe—C₂H₅ | S | K 79 | J* 67 I* 79 C* 124 A 157 I |
| C₁₆H₃₃—O— | —CH₂—CHMe—C₂H₅ | S | K 68 | J* 65 I* 79 C* 120 A 154 I |
| C₁₈H₃₇—O— | —CH₂—CHMe—C₂H₅ | S | K 71 | J* 64.5 I* 79 C* 118 A 150 I |
| C₄H₉—O— | —CH₂—CHMe—C₂H₅ | 2 | K 107 | E 103 A 174 N 192 I |
| C₅H₁₁—O— | —CH₂—CHMe—C₂H₅ | 2 | K 90 | E 72 B 98 A 172 N 186 I |
| C₆H₁₃—O— | —CH₂—CHMe—C₂H₅ | 2 | K 88 | G 84 C 103 A 172 N 182 I |
| C₇H₁₅—O— | —CH₂—CHMe—C₂H₅ | 2 | K 86 | H 66 G 70 F 79 C 126 A 170 N 177 I |
| C₈H₁₇—O— | —CH₂—CHMe—C₂H₅ | 2 | K 74 | K 61 J 72 I 79 C 132 A 171 N 174 I |

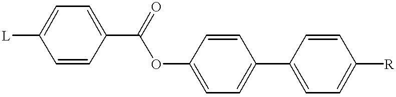

| L | R | | Cr | LC |
|---|---|---|---|---|
| C₂H₅—CHMe—CH₂— | —O—C₇H₁₅ | S | K 65 | J* 85 I* 91 C* 110 N* 154 I |
| C₂H₅—CHMe—CH₂— | —O—C₈H₁₇ | S | K 60 | J* 90 I* 92 C* 114 N* 163 I |
| C₂H₅—CHMe—CH₂— | —O—C₉H₁₉ | S | K 89 | J* 88 I* 90 C* 115 N* 152 I |
| C₂H₅—CHMe—CH₂— | —O—C₁₀H₂₁ | S | K 65 | J* 78 I* 87 C* 117 N* 148 I |
| C₂H₅—CHMe—CH₂— | —O—C₁₂H₂₅ | S | K 50 | J* 70 I* 87 C* 116 N* 136 I |
| C₂H₅—CHMe—CH₂— | —O—C₁₄H₂₅ | 1 | K 50.8 | C* 93.1 A 130.8 U |
| C₂H₅—CHMe—CH₂— | —O—C₁₀H₂₁ | 2 | K 55 | J 78.8 I 90 C 117.3 N 151.6 I |
| C₂H₅—CHMe—CH₂—O—C₂H₄— | —O—C₁₀H₂₁ | S | K 79.5 | S 75 C* 115.5 I |
| C₂H₅—CHMe—CH₂—O—CHMe— | —O—C₁₀H₂₁ | 3 | K 89 | C* 95 I |
| C₂H₅—CHMe—CH₂—NMe—CH₂— | —O—C₈H₁₇ | S | K 68 | S 103 C* 114 N* 128 I |
| C₂H₅—CHMe—CH₂—NMe—CH₂— | —O—C₁₂H₂₅ | S | K <25 | S 93 C* 111 N* 115 I |
| C₂H₅—CHMe—CH₂—NMe—CH₂— | —O—C₁₄H₂₉ | S | K 48 | S 83 C* 105 N* 109.1 I |
| C₂H₅—CHMe—CH₂—NMe—CH₂— | —O—C₁₅H₃₀ | S | K 65 | S 82 C* 104 N* 107 I |
| C₂H₅—CHMe—CH₂—NMe—CH₂— | —O—C₁₈H₃₇ | S | K 72 | S 75 C* 104 N* 107 I |
| C₂H₅—CHMe—CH₂—O— | —O—C₈H₁₇ | S | K 136.5 | C* 128.8 N* 174 I |
| C₆H₁₃—CHMe—CH₂—O— | —O—C₈H₁₇ | 1 | K 108.2 | C* 125.3 N* 141.3 I |
| C₂H₅—CHMe—CH₂—OOC— | —O—C₆H₁₃ | 1 | K 94 | K 121.3 B.125.6 A 155.9 N* 177.5 I |
| C₂H₅—CHMe—CH₂—OOC— | —O—C₈H₁₇ | 1 | K 85.3 | E 102 B 118 C* 126.9 A 162.9 N* 170.4 I |
| C₂H₅—CHMe—CH₂—OOC— | —O—C₁₀H₂₁ | 1 | K 85.5 | B 97.9 C* 149.5 A 158.5 N* 162.7 I |
| C₂H₅—CHMe—CH₂—COO— | —O—C₈H₁₇ | S | K 110 | C* 148.3 N* 189.9 I |
| C₂H₅—CHMe—CH₂—O—CHMe—COO— | —O—C₇H₁₅ | 3 | K 120 | C* 130 N* 134 I |
| C₂H₅—CHMe—CH₂—O—CHMe—COO— | —O—C₈H₁₇ | 3 | K 115 | C* 135 N* 139 I |
| C₂H₅—CHMe—CH₂—O—CHMe—COO— | —O—C₉H₁₉ | 3 | K 104 | C* 131 N* 133 I |
| C₂H₅—CHMe—CH₂—O—CHMe—COO— | —O—C₁₀H₂₁ | 3 | K 103 | C* 134 I |
| C₂H₅—CHMe—CH₂—O—CHMe—COO— | —O—C₁₂H₂₅ | 3 | K 106 | C* 129 I |
| C₂H₅—CHMe—CH₂—OCOO— | —O—C₆H₁₃ | S | K 99.7 | C* 125.1 N* 185 I |
| C₂H₅—CHMe—CH₂—OCOO— | —O—C₈H₁₇ | S | K 104 | C* 135.9 N* 173.8 I |
| C₂H₅—CHMe—CH₂—OCOO— | —O—C₉H₁₉ | S | K 102.8 | C* 139.8 N* 170.4 I |
| C₂H₅—CHMe—CH₂—OCOO— | —O—C₁₀H₂₁ | S | K 105.6 | C* 142.9 N* 168.8 I |
| C₂H₅—CHMe—CH₂— | —O—C₂H₄—O—C₄H₉ | S | K ? | S 64 C* 76 A 92 N* 126 I |

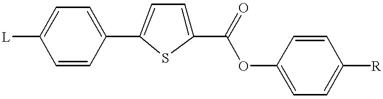

| L | R | | Cr | LC |
|---|---|---|---|---|
| C₅H₁₁— | —O—C₈H₁₇ | | K 86.3 | C 88.3 N 132.4 I |
| C₆H₁₃— | —O—C₈H₁₇ | | K 87 | C 102.2 N 126.8 I |
| C₇H₁₅— | —O—C₈H₁₇ | | K 87.3 | I 76.4 C 112.6 A 123 N 130.9 I |
| C₈H₁₇— | —O—C₈H₁₇ | | K 87.6 | I 83.4 C 120 A 125 N 128.2 I |
| C₉H₁₉— | —O—C₈H₁₇ | | K 84.6 | B 92.3 C 124.7 A 129 N 129.5 I |
| C₁₀H₂₁— | —O—C₈H₁₇ | | K 87.8 | G 94.3 C 127.2 A 128.3 I |
| C₁₀H₂₁—O— | —COO—CHMe—C₆H₁₃ | 1 | K ? | CA ? C-g ? C* ? I |
| C₁₂H₂₅—O— | —COO—CHMe—C₆H₁₃ | 1 | K ? | CA ? C-g ? C* ? I |

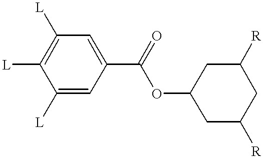

| L | R | Cr | LC |
|---|---|---|---|
| C₁₀H₂₁—O— | —OOC—C₁₀H₂₁ | K 40.7 | P −32 I |

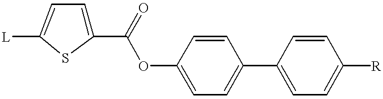

| L | R | Cr | LC |
|---|---|---|---|
| C₆H₁₃— | —Br | K 104.5 | S 141.5 N 146.5 I |
| C₁₀H₂₁— | —Br | K 95 | S 143 I |
| C₁₂H₂₅— | —Br | K 100.5 | S 144.6 I |
| C₃H₇— | —CN | K 133.1 | A 107.3 N 209.1 I |
| C₁₂H₂₅— | —CN | K 98.5 | S 165 I |
| C₆H₁₃— | —COO—C₃H₆—SiMe₂C₄H₉ | K 45 | S −17 C 41 A 70 I |
| H— | —O—C₈H₁₇ | K 116.7 | F 93 N 116.5 I |
| H— | —O—C₉H₁₉ | K 113 | F 94.6 N 114.5 I |
| H— | —O—C₁₀H₂₁ | K 110.8 | F 96.5 N 116 I |
| H— | —O—C₁₂H₂₅ | K 114.6 | B 99.6 C 99.7 N 115.2 I |
| C₂H₅— | —C₉H₁₉ | K 89.7 | G 95 N 114.6 I |
| C₂H₅— | —C₁₀H₂₁ | K 72 | G 66.4 N 109.7 I |
| C₃H₇— | —C₈H₁₇ | K 88.9 | G 73.6 N 110.8 I |
| C₃H₇— | —C₉H₁₉ | K 88.2 | G 76.7 N 113.3 I |
| C₃H₇— | —C₁₀H₂₁ | K 83 | G 74.1 N 110.6 I |
| C₄H₉— | —C₈H₁₇ | K 90 | G 79 N 104.3 I |
| C₄H₉— | —C₉H₁₉ | K 71.1 | G 81.6 N 106.6 I |
| C₄H₉— | —C₁₀H₂₁ | K 70 | K 79.5 J 80.5 F 81.5 I 82.7 N 103.7 I |
| C₅H₁₁— | —C₈H₁₇ | K 82.4 | G 82.3 N 108.5 I |
| C₅H₁₁— | —C₉H₁₉ | K 80 | G 85.8 N 110.2 I |
| C₅H₁₁— | —C₁₀H₂₁ | K 73.2 | K 78.9 J 82.5 F 84.3 I 86.3 C 87.7 N 106.7 I |
| C₆H₁₃— | —C₈H₁₇ | K 78 | K 80.7 J 82.2 I 85 C 86.7 N 104.5 I |
| C₆H₁₃— | —C₉H₁₉ | K 74.5 | K 82.6 J 85.4 F 87 I 88.3 C 91.4 N 107.2 I |
| C₆H₁₃— | —C₁₀H₂₁ | K 67.4 | K 79.2 J 80.9 F 85 I 88 C 92.8 N 103.8 I |
| C₇H₁₅— | —C₈H₁₇ | K 88 | K 68 J 78 I 81.6 C 91.6 N 107.4 I |
| C₇H₁₅— | —C₉H₁₉ | K 86.3 | K 79 J 82.2 F 84.8 I 86.4 C 98 N 110.2 I |
| C₇H₁₅— | —C₁₀H₂₁ | K 76.8 | K 76.6 J 78.1 F 83.4 I 86.5 C 96.6 N 106.7 I |
| C₈H₁₇— | —C₈H₁₇ | K 87.3 | J 71.1 I 80 C 96.3 N 106.7 I |
| C₈H₁₇— | —C₉H₁₉ | K 88.8 | J 76.4 F 82.6 I 84.9 C 100.6 N 108.1 I |
| C₈H₁₇— | —C₁₀H₂₁ | K 75.8 | K 86.1 J 74 F 83.9 I 86.7 C 103 N 107 I |

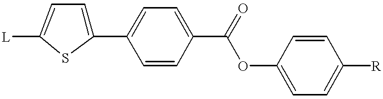

| L | R | Cr | LC |
|---|---|---|---|
| C₈H₁₇— | —C₇H₁₅ | K 60 | E 54.6 B 81.8 A 128.2 N 128.6 I |
| C₈H₁₇— | —C₈H₁₇ | K 70 | E 47.7 B 82.2 A 126.6 I |
| C₄H₉— | —O—C₈H₁₇ | K 84.4 | C 73.9 N 149.5 I |
| C₄H₉— | —O—C₉H₁₉ | K 92 | C 78.6 N 141.7 I |
| C₄H₉— | —O—C₁₀H₂₁ | K 88.8 | C 82.8 N 143.8 I |
| C₈H₁₇— | —O—C₅H₁₁ | K 88.9 | E 84.3 B 99.7 A 137.6 N 147.3 I |
| C₈H₁₇— | —O—C₆H₁₃ | K 86.1 | E 75.9 B 99.7 C 120.7 A 138.6 N 148.9 I |
| C₈H₁₇— | —O—C₇H₁₅ | K 91.7 | E 73.3 B 97.8 C 125.6 A 138.8 N 146.2 I |
| C₈H₁₇— | —O—C₈H₁₇ | K 87 | E 70.1 B 95.2 C 130.5 A 139.5 N 146.4 I |
| C₈H₁₇— | —O—C₉H₁₉ | K 95.6 | E 88.9 B 95.5 C 130 A 139.5 N 143.2 I |
| C₈H₁₇— | —O—C₁₀H₂₁ | K 92.3 | E 66.2 B 93.5 C 131 A 138.9 N 142.6 I |
| C₁₀H₂₁— | —O—C₅H₁₁ | K 90.1 | H 81.5 B 102.8 C 119.6 A 141.1 N 143.2 I |
| C₁₀H₂₁— | —O—C₆H₁₃ | K 89.5 | H 70 B 99.4 C 131.5 A 142.7 N 145.3 I |
| C₁₀H₂₁— | —O—C₇H₁₅ | K 94.2 | H 65.5 B 100.5 C 135.7 A 141.7 N 143.1 I |
| C₁₀H₂₁— | —O—C₈H₁₇ | K 93 | H 62.2 B 99.5 C 138 A 142 N 142.9 I |
| C₁₀H₂₁— | —O—C₉H₁₉ | K 97 | H 60.5 B 99.9 C 137.8 A 141.1 I |
| C₁₀H₂₁— | —O—C₁₀H₂₁ | K 96.5 | B 99.5 C 136.3 A 140.7 I |
| C₁₂H₂₅— | —O—C₅H₁₁ | K 95.8 | H 83.2 G 93.4 B 103.8 C 123.9 A 140.4 I |
| C₁₂H₂₅— | —O—C₆H₁₃ | K 95.8 | H 86.5 B 103.1 C 134 A 142.1 I |
| C₁₂H₂₅— | —O—C₇H₁₅ | K 97.4 | H 82 B 102.5 C 137.1 A 140.4 I |
| C₁₂H₂₅— | —O—C₈H₁₇ | K 97.4 | H 69 B 101.3 C 139.6 A 140.9 I |
| C₁₂H₂₅— | —O—C₉H₁₉ | K 99.8 | H 63.7 B 102.2 C 139.6 I |
| C₁₂H₂₅— | —O—C₁₀H₂₁ | K 97.9 | B 102.2 C 139.3 I |

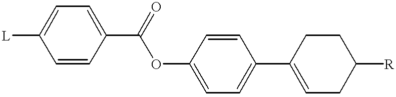

| L | R | | Cr | LC |
|---|---|---|---|---|
| Me₃Si—O—Me₂Si—C₄H₅— | —C₃H₇ | 2 | K 65 | G 88 C 93 I |
| Me₃Si—CH₂—SiMe₂—C₄H₈— | —C₃H₇ | 2 | K 45 | C 86 I |
| Me₃Si—C₂H₄—SiMe₂—C₄H₈— | —C₃H₇ | 2 | K 73 | E 77 C 84 I |
| Me₃Si—(CH₂—SiMe₂)₂—C₄H₈— | —C₃H₇ | 2 | K ? | G 43 C 71 I |
| (Me₃Si—CH₂)₂—SiMe—C₂H₄—SiMe₂—C₄H₈— | —C₃H₇ | 2 | K ? | G 45 C 55 I |
| Me₃Si—C₂H₄—SiMe₂—O—SiMe₂—C₄H₈— | —C₃H₇ | 2 | K 28 | C 72 I |

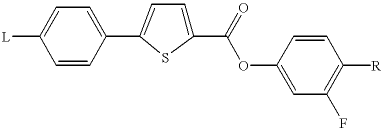

| L | R | Cr | LC |
|---|---|---|---|
| C₇H₁₅— | —O—C₆H₁₃ | K 74 | C 77.9 A 123.3 I |
| C₇H₁₅— | —O—C₈H₁₇ | K 78.6 | C 77.9 A 122 I |
| C₈H₁₇— | —O—C₆H₁₃ | K 70 | C 99 A 122.3 I |
| C₈H₁₇— | —O—C₈H₁₇ | K 77.3 | C 100.2 A 120.3 I |
| C₉H₁₉— | —O—C₆H₁₃ | K 68.5 | C 103.5 A 123.8 I |
| C₉H₁₉— | —O—C₆H₁₇ | K 72.9 | C 107.4 A 121.7 I |

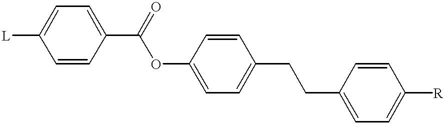

| L | R | | Cr | LC |
|---|---|---|---|---|
| C₉H₁₉—O— | —C₅H₁₁ | | K 74 | S 48 S 70.5 F 74 C 102 N 124.5 I |
| C₁₀H₂₁—O— | —C₅H₁₁ | | K 75 | S 56.5 B 83.5 C 111 N 125 I |
| C₁₁H₂₃—O— | —C₅H₁₁ | | K 74 | S 65 B 94 C 118 A 120 N 123 I |
| C₁₂H₂₅—O— | —C₅H₁₁ | | K 78 | B 90 C 115 N 124 I |
| C₇H₁₅— | —CO—CH₃ | | K 125 | S 132 N 140.5 I |
| C₄H₉—O— | —CO—CH₃ | | K 134 | S 144 N 176 I |
| C₆H₁₃—O— | —CO—CH₃ | | K 149.5 | C 154.5 N 169 I |
| C₅H₁₁—COO— | —CO—CH₃ | | K 143 | S 150 N 179 I |
| C₄H₉— | —COO—C₂H₅ | | K 118 | B 119.5 N 125 I |
| C₄H₉—O— | —COO—C₂H₅ | | K 121 | A 129 N 156.5 I |
| C₆H₁₃—CHMe—OOC— | —O—C₆H₁₃ | R | K 51 | S 82 I |
| C₆H₁₃—CHMe—OOC— | —O—C₇H₁₅ | R | K 62 | S 81 I |
| C₆H₁₃—CHMe—OOC— | —O—C₈H₁₇ | R | K 73 | S 83 I |
| C₆H₁₃—CHMe—OOC— | —O—C₉H₁₉ | R | K 70 | S 77 I |
| C₆H₁₃—CHMe—OOC— | —O—C₁₀H₂₁ | R | K 72 | S 76 A 81 I |
| C₆H₁₃—CHMe—OOC— | —O—C₁₁H₂₃ | R | K 55 | S 70 C* 74 A 79 I |
| C₆H₁₃—CHMe—OOC— | —O—C₁₂H₂₅ | R | K 54 | S 69 C* 75 A 79 I |
| CH₃—CHMe—CHCl—COO— | —O—C₆H₁₃ | 1 | K 59 | S 84 B 96 C* 106 N* 125 I |
| CH₃—CHMe—CHCl—COO— | —O—C₇H₁₅ | 1 | K 69 | S 96 C* 110 A 111 N* 122 I |
| CH₃—CHMe—CHCl—COO— | —O—C₈H₁₇ | 1 | K 81 | S 96 C* 112 A 115 N* 121.7 I |
| CH₃—CHMe—CHCl—COO— | —O—C₉H₁₉ | 1 | K 49 | I* 96.5 C* 114 A 117 N* 120 I |
| CH₃—CHMe—CHCl—COO— | —O—C₁₀H₂₁ | 1 | K 48 | I* 96 C* 114 A 118 N* 119.5 I |
| CH₃—CHMe—CHCl—COO— | —O—C₁₁H₂₃ | 1 | K 57 | I* 95.5 C* 114 A 119 I |
| CH₃—CHMe—CHCl—COO— | —O—C₁₂H₂₅ | 1 | K 60 | I* 95.2 C* 114 A 118 I |
| C₂H₅—CHMe—C₃H₆—O— | —O—C₉H₁₉ | 1 | K 65 | J* 82 I* 95 C* 111 N* 123 I |
| C₂H₅—CHMe—C₄H₈—O— | —O—C₉H₁₉ | 1 | K 60 | J* 79 I* 93 C* 111 A 118 I |
| C₂H₅—CHMe—C₅H₁₀—O— | —O—C₉H₁₉ | 1 | K 72 | J* 82 I* 99 C* 121 N* 123 I |
| C₆H₁₃—O— | —COO—CHMe—C₆H₁₃ | R | K 50 | C* 65 A 100 I |
| C₇H₁₅—O— | —COO—CHMe—C₆H₁₃ | R | K 62 | C* 78 A 97 I |
| C₈H₁₇—O— | —COO—CHMe—C₆H₁₃ | R | K 68 | C* 83 A 99 I |

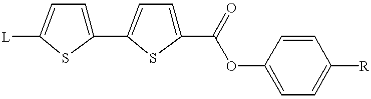

| L | R | Cr | LC |
|---|---|---|---|
| C₇H₁₅— | —O—C₈H₁₇ | K 84.4 | C 79.3 N 104.6 I |
| C₈H₁₇— | —O—C₈H₁₇ | K 87.1 | B 58 C 91.7 N 104.5 I |
| C₉H₁₉— | —O—C₈H₁₇ | K 76.8 | B 65.6 C 97.2 N 105 I |
| C₁₀H₂₁— | —O—C₈H₁₇ | K 81 | B 72.2 C 102.7 N 104.7 I |

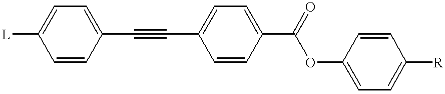

| L | R | | Cr | LC |
|---|---|---|---|---|
| C₇H₁₅—O— | —COO—CHMe—C₆H₁₃ | 1 | K 92.3 | * 73.7 CA 87.5 C-g 90 C* 96.1 C-a 98.4 A 136 I |
| C₈H₁₇—O— | —COO—CHMe—C₆H₁₃ | 1 | K 87.6 | * 71.6 CA 95.1 C-g 97 C* 104 C-a 105.5 A 135.3 I |
| C₉H₁₉—O— | —COO—CHMe—C₆H₁₃ | 1 | K 62.2 | * 64 CA 92.5 C-g 95 C* 107.6 C-a 108.5 A 129.6 I |
| C₁₀H₂₁—O— | —COO—CHMe—C₆H₁₃ | R | K 58.2 | CA 94.6 C-g 96.1 C* 111.2 A 128.6 I |
| C₁₁H₂₃—O— | —COO—CHMe—C₆H₁₃ | 1 | K 66 | CA 89 C-g 92.3 C* 112.4 A 123 I |
| C₁₂H₂₅—O— | —COO—CHMe—C₆H₁₃ | 1 | K 73.4 | CA 92 C-g 94.3 C* 113.2 A 121.3 I |
| C₁₀H₂₁—O— | —COO—CH₂—CHMe—C₂H₅ | S | K 53 | S 54 C* 131 A 169 N* 172 I |
| C₆H₁₃—CHMe—OOC— | —O—C₆H₁₃ | R | K 92 | C* 62 A 122 I |
| C₆H₁₃—CHMe—OOC— | —O—C₇H₁₅ | R | K 83 | C* 85 A 117 I |
| C₆H₁₃—CHMe—OOC— | —O—C₈H₁₇ | R | K 84 | C* 90 A 117 I |
| C₆H₁₃—CHMe—OOC— | —O—C₉H₁₉ | R | K 87 | C* 99 A 112 I |
| C₆H₁₃—CHMe—OOC— | —O—C₁₀H₂₁ | R | K 87 | C* 102 A 112 I |
| C₆H₁₃—CHMe—OOC— | —O—C₁₁H₂₃ | R | K 91 | C* 107 A 109 I |
| C₆H₁₃—CHMe—OOC— | —O—C₁₂H₂₅ | R | K 91 | C* 105 A 109 I |
| C₂H₅—CHMe—CH₂—OOC— | —O—C₈H₁₇ | S | K 84 | C* 120 A 159 N* 175 I |
| C₂H₅—CHMe—CH₂—OOC— | —O—C₁₀H₂₁ | S | K 91 | C* 122 A 158 N* 168 I |

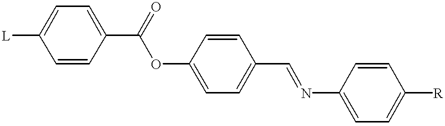

| L | R | Cr | LC |
|---|---|---|---|
| C₁₀H₂₁—O— | —CH₃ | K 106.5 | S 121.5 N 202.5 I |
| C₁₀H₂₁—O— | —C₂H₅ | K 84 | S 136.5 N 197 I |
| C₁₀H₂₁—O— | —C₄H₉ | K 68 | B 88 C 151 N 192 I |
| C₁₂H₂₅—O— | —CH₃ | K 99.5 | S 142.5 N 193.5 I |
| C₁₂H₂₅—O— | —C₂H₅ | K 90 | S 150 N 186.5 I |
| C₁₂H₂₅—O— | —C₄H₉ | K 66 | B 91 C 159 N 185 I |
| C₁₄H₂₉—O— | —CH₃ | K 95 | S 155 N 184 I |
| C₁₄H₂₉—O— | —C₂H₅ | K 94 | S 155 N 180 I |
| C₁₄H₂₉—O— | —C₄H₉ | K 64 | B 95 C 162 N 178 I |
| C₁₆H₃₃—O— | —CH₃ | K 91 | S 160.5 N 178 I |
| C₁₆H₃₃—O— | —C₂H₅ | K 94 | S 157 N 172 I |
| C₁₆H₃₃—O— | —C₄H₉ | K 83 | B 96 C 163 N 172 I |
| C₁₈H₃₇—O— | —CH₃ | K 88 | S 159 N 171.5 I |
| C₁₈H₃₇—O— | —C₂H₅ | K 95 | S 157.5 N 168.5 I |
| C₅H₁₁—O— | —O—C₈H₁₇ | K 95 | S 138 N 226 I |
| C₆H₁₃—O— | —O—C₈H₁₇ | K 90 | S 151 N 221 I |
| C₇H₁₅—O— | —O—C₂H₅ | K 101.5 | C 73.8 N 250 I |
| C₇H₁₅—O— | —O—C₃H₇ | K 114.3 | S 84.5 C 108 N 235 I |
| C₇H₁₅—O— | —O—C₄H₉ | K 90.4 | S 88.4 C 128.4 N 234.6 I |
| C₇H₁₅—O— | —O—C₅H₁₁ | K 89.4 | S 85.5 C 141.5 N 221.5 I |
| C₇H₁₅—O— | —O—C₆H₁₃ | K 92 | S 83 S 84 C 150 N 221.7 I |
| C₇H₁₅—O— | —O—C₇H₁₅ | K 101.4 | S 85 C 157 N 215.5 I |
| C₇H₁₅—O— | —O—C₈H₁₇ | K 89.7 | S 84 S 86 C 162.6 N 213.4 I |
| C₇H₁₅—O— | —O—C₉H₁₉ | K 92.9 | S 81.2 S 85.8 C 168.8 N 208.7 I |
| C₇H₁₅—O— | —O—C₁₀H₂₁ | K 90.4 | S 80 S 85.5 C 167.4 N 205.3 I |
| C₈H₁₇—O— | —O—C₈H₁₇ | K 94 | S 169 N 215.5 I |
| C₉H₁₉—O— | —O—C₂H₅ | K 104.2 | C 99 N 238 I |
| C₉H₁₉—O— | —O—C₃H₇ | K 105.4 | S 79 C 134.6 N 224 I |
| C₉H₁₉—O— | —O—C₄H₉ | K 94.6 | S 80 C 148.8 N 221.8 I |
| C₉H₁₉—O— | —O—C₅H₁₁ | K 91.2 | S 79 S 80.5 C 158.8 N 215.3 I |

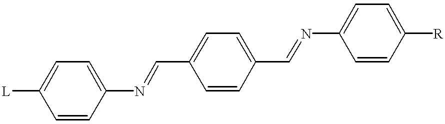

| L | R | Cr | LC |
|---|---|---|---|
| C₂H₅— | —C₂H₅ | K 127 | S 136 S 149 N 251 I |
| C₃H₇— | —C₃H₇ | K 109.2 | H 114.5 G 143 C 150.7 A 180.6 N 255 I |
| C₄H₉— | —C₄H₉ | K 113 | S 74 H 89.2 G 144.5 C 172 A 199 N 235 I |
| C₅H₁₁— | —C₅H₁₁ | K 72.8 | H 62.8 G 139 F 148.8 C 178.3 A 212 N 233.3 I |
| C₆H₁₃— | —C₆H₁₃ | K 71.3 | H 64.5 G 141.6 F 152.4 C 186.2 A 207.5 N 215.5 I |
| C₇H₁₅— | —C₇H₁₅ | K 61.6 | H 48 G 143 F 156.9 C 191.4 A 210 N 211.5 I |
| C₈H₁₇— | —C₈H₁₇ | K 63.5 | H 46 G 138.5 F 156.8 C 192.5 A 202.5 I |
| C₉H₁₉— | —C₉H₁₉ | K 57.3 | G 132.5 F 155.5 I 157.5 C 192.7 A 199 I |
| C₁₀H₂₁— | —C₁₀H₂₁ | K 73 | G 115 F 149 I 156 C 196 A 198 I |
| C₁₂H₂₅— | —C₁₂H₂₅ | K 80.7 | G 112.9 F 136.9 I 151 C 180.3 I |
| C₁₃H₂₇— | —C₁₃H₂₇ | K 95 | G 115 F 130 I 153 C 178 I |
| C₁₄H₂₉— | —C₁₄H₂₉ | K 90 | F 120.1 I 144 C 170 I |
| C₁₅H₃₁— | —C₁₅H₃₁ | K 91 | G 117 I 147 C 170 I |
| C₁₆H₃₃— | —C₁₆H₃₃ | K 89 | F 133.6 I 138.8 C 160 I |
| C₂H₅—OOC—CH═CH— | —CH═CH—COO—C₂H₅ | K 180.6 | B 189.7 C 232 A 305 N ? Z |
| C₅H₁₁—OOC—CH═CH— | —CH═CH—COO—C₅H₁₁ | K 124.7 | B 133 C 247 A 307 N 314 Z |
| C₂H₅—OOC—CMe═CH— | —CH═OMe—COO—C₂H₅ | K 169 | S 241 S 249 N 308 Z |
| C₄H₉—O— | —O—C₄H₉ | K 191 | C 221 N 295 I |
| C₆H₁₃—O— | —O—C₆H₁₃ | K 159 | S 176 S 232 S 239 N 262 I |
| C₈H₁₇—O— | —O—C₈H₁₇ | K 144 | S 172 S 234 S 241 N 246 I |
| C₁₂H₂₅—O— | —O—C₁₂H₂₅ | K 130 | S 162 S 215.1 I |
| C₂H₅—S— | —S—C₂H₅ | K 175.8 | A 204.5 N 236.2 I |
| CH₃—O—CH₂—O— | —O—CH₂—O—CH₃ | K 136 2 | B 140.9 A 147.1 N 222 I |
| C₄H₉—O—CH₂—O— | —O—CH₂—O—C₄H₉ | K 106.2 | A 118.7 I |
| C₃H₇—OOC— | —COO—C₃H₇ | K 153 | A 199 N 258 I |
| C₄H₉—OOC— | —COO—C₄H₉ | K 92 | C 137 A 190 N 209 I |
| C₅H₁₁—OOC— | —COO—C₅H₁₁ | K 100 | A 206 N 215 I |
| C₆H₁₃—OOC— | —COO—C₆H₁₃ | K 113 | C 148 A 189 I |
| C₇H₁₅—OOC— | —COO—C₇H₁₅ | K 92 | C 140 A 196 I |
| C₄H₉— | —C₄D₉ | K 112 | S 146 C 174 A 201 N 238 I |

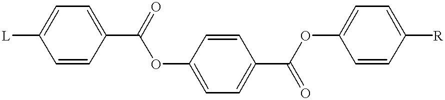

| L | R | | Cr | LC |
|---|---|---|---|---|
| C₈H₁₇—O— | —CH═C(COO—C₆H₁₃)₂ | | K 52 | C 51 A 85 N 101 I |
| C₈H₁₇—O— | —CH═C(COO—C₇H₁₅)₂ | | K 58 | C 51.5 A 83 N 97 I |
| C₈H₁₇—O— | —CH═C(COO—C₈H₁₇)₂ | | K 59 | C 53 A 84 N 94 I |
| C₈H₁₇—O— | —CH═C(COO—C₉H₁₉)₂ | | K 58 | C 53 A 86 N 94 I |
| C₈H₁₇—O— | —CH═C(COO—C₁₀H₂₁)₂ | | K 63 | C 55 A 84 N 91 I |
| C₈H₁₇—O— | —CH═C(COO—C₁₁H₂₃)₂ | | K 61 | C 56 A 84 N 90 I |
| C₈H₁₇—O— | —CH═C(COO—C₁₂H₂₅)₂ | | K 67 | C 57 A 85 N 89 I |
| C₈H₁₇—O— | —CH═C(COO—C₁₆H₃₃)₂ | | K 83 | C 65 A 85 N 86 I |
| C₈H₁₇—O— | —CH═C(COO—C₁₈H₃₇)₂ | | K 86 | C 69 A 83 I |
| C₉H₁₉—O— | —CH═C(COO—C₅H₁₁)₂ | | K 70 | C 56 A 88 N 107 I |
| C₈H₁₇—O— | —CHCN—CH(COO—C₃H₇)₂ | 2 | K 60 | A 100 N 131 I |
| C₄H₉—O— | —O—C₈H₁₇ | | K ? | C 65 N 207 I |
| C₅H₁₁—O— | —O—C₈H₁₇ | | K 97 | C 101 N 201 I |
| C₆H₁₃—O— | —O—C₈H₁₇ | | K 96 | C 132 A 144 N 198 I |
| C₇H₁₅—O— | —O—C₇H₁₅ | | K 87 | C 143 A 162 N 193 I |
| C₇H₁₅—O— | —O—C₈H₁₇ | | K ? | C 142 A 155 N 193 I |
| C₈H₁₇—O— | —O—CH₃ | | K 107 | A 122 N 226 I |
| C₈H₁₇—O— | —O—C₂H₅ | | K 110 | A 130 N 213 I |
| C₈H₁₇—O— | —O—C₈H₁₇ | | K 87 | C 145 A 163 N 189.5 I |
| C₈H₁₇—O— | —O—CHMe—COO—C₂H₅ | S | K 86 | A 117 N* 122 I |
| C₈H₁₇—O— | —O—CHMe—COO—C₈H₁₇ | S | K 71 | A 94 N* 113 I |
| C₈H₁₇—O— | —CO—CH₃ | | K 131 | A 210 N 227 I |
| C₆H₁₃—O— | —COO—C₃H₇ | | K 101.5 | C 188.5 N 193 I |
| C₈H₁₇—O— | —CO—N(—CH₃)₂ | | K 127 | A 144 N 204 I |
| C₈H₁₇—O— | —COO—N═C(—CH₃)₂ | | K 116 | A 180 N 230 Z |
| C₈H₁₇—O— | —COO—N═C(—C₂H₅)₂ | | K 77.5 | A 155.5 N 192 Z |
| C₈H₁₇—O— | —COO—N═C(—C₃H₇)₂ | | K 91 | A 128 N 165 I |
| C₈H₁₇—O— | —COO—N═C(—C₇H₁₅)₂ | | K 76 | A 83 N 116.5 I |
| C₈H₁₇—O— | —COO—N═C(—C₁₁H₂₃)₂ | | K 73 | A 78 N 99 I |
| C₈H₁₇—O— | —COO—N═C(—C₁₃H₂₇)₂ | | K 59 | A 78 N 93 I |

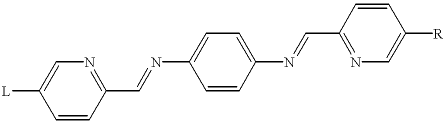

| L | R | Cr | LC |
|---|---|---|---|
| C₆H₁₃—O— | —O—C₆H₁₃ | K 122.4 | B 132.6 N 243 I |
| C₈H₁₇—O— | —O—C₈H₁₇ | K 61.2 | H 100.2 G 121.2 C 158.4 N 223.1 I |
| C₁₀H₂₁—O— | —O—C₁₀H₂₁ | K 89.9 | H 87.2 G 95.5 C 173.4 N 202.1 I |

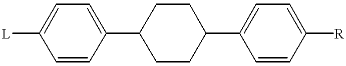

| L | R | Cr | LC |
|---|---|---|---|
| C₄H₉— | —C₄H₉ | K 89 | P 107 I |
| C₆H₁₃— | —C₆H₁₃ | K 70 | P 112 I |
| C₇H₁₅— | —C₇H₁₅ | K 60 | P 114 I |
| C₁₂H₂₅— | —C₁₂H₂₅ | K 53 | P 108.8 I |
| C₁₆H₃₃— | —C₁₆H₃₃ | K 69 | P 102.5 I |

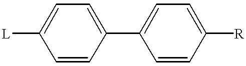

| L | R | Cr | LC |
|---|---|---|---|
| C₈H₁₇— | —C₈H₁₇ | K 57 | P 61 I |
| C₉H₁₉— | —C₉H₁₉ | K 57 | P 68 I |

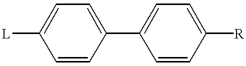

| L | R | Cr | LC | Ref |
|---|---|---|---|---|
| H—O—C₅H₁₂—O— | —O—C₅H₁₂—O—H | K 97.9 | S 178.8 I | 5165 |
| H—CONH— | —NHOC—H | K 274 | S 286 I | 4109 |
| Br—C₃H₆—COO— | —OOC—C₃H₆—Br | K 114 | S 142 I | 7455 |
| Br—C₄H₈—COO— | —OOC—C₄H₈—Br | K 96 | S 116 I | 7455 |
| Br—C₅H₁₀—COO— | —OOC—C₅H₁₀—Br | K 57 | S 103 I | 7455 |
| Br—C₇H₁₄—COO— | —OOC—C₇H₁₄—Br | K 71 | S 99 I | 7455 |

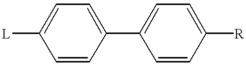

| L | R | | Cr | LC |
|---|---|---|---|---|
| Br—C₁₀H₂₀—COO— | —OOC—C₁₀H₂₀—Br | | K 83 | S 100 I |
| C₅H₁₁— | —H | | K 11.5 | N −34 E |
| C₆H₁₁— | —C₂H₄—O—H | | K 72 | S 112.5 I |
| C₂H₅—O— | —O—H | | K 169 | X 176 I |
| C₈H₁₇—O— | —O—CH₂—CHlBu—O—H | S | K 95 | S 58 S 103 S 113.1 S 113.6 S 115.6 A 119.5 I |
| CH₃—O— | —O—C₆H₁₂—OOC—CMe═CH—H | | K 66 | S 73 I |
| C₂H₅—O— | —O—C₆H₁₂—OOC—CMe═CH—H | | K 63.1 | N 87.6 I |
| C₅H₁₁—O— | —O—C₆H₁₂—OOC—CMe═CH—H | | K 53 | S 57 I |
| C₆H₁₃—O— | —O—C₆H₁₂—OOC—CMe═CH—H | | K 79 | S 84 I |
| C₄H₉— | —CO—H | | K 4.5 | N 2 I |
| C₅H₁₁— | —CO—H | | K 21.5 | N 23.5 I |
| C₆H₁₃— | —CO—H | | K −5.5 | N 17.5 I |
| C₇H₁₅— | —CO—H | | K 4.5 | N 33 I |
| C₈H₁₇— | —CO—H | | K 20.5 | S 30 N 36 I |
| C₉H₁₉— | —CO—H | | K 31 | S 42 N 45 I |
| C₁₀H₂₁— | —CO—H | | K 42 | S 44 I |
| C₈H₁₇—O— | —COO—CH₂—CHMe—O—H | S | K 119 | A 118 I |
| C₂H₅—O— | —OOC—CMe═CH—H | | K 95 | X 105 I |
| C₈H₁₇—O— | —OOC—C₄H₈—OOC—CMe═CH—H | | K 80.6 | S 86.2 I |
| C₈H₁₇—O— | —OOC—C₂H₄—CHMe—CH₂—OOC—CMe═CH—H | 1 | K 46 | S 64.1 I |
| C₆H₁₃—O— | —OOC—C₁₁H₂₂—NHOC—CMe═CH—H | | K 111 | S 132 X ? I |
| C₂H₅—CHMe—CHF—CH₂—OOC— | —O—H | 3 | K 127.5 | I |
| CH₃—CHMe—CH₂—CHCl—CH₂—OOC— | —O—H | S | K 48.3 | I |
| C₂H₅—CHMe—CH₂—O— | —O—C₆H₁₂—OOC—CMe═CH—H | S | K 42.5 | S 49 I |
| C₈F₁₇—C₁₁H₂₂—O— | —CONH—H | | K 224 | I |
| H₂C═CH—C₄H₉—O— | —O—H | | K 138 | I |
| H₂C═CH—C₉H₁₈—O— | —O—H | | K 134 | S 139 I |
| C₅H₁₁— | —CH═CH—F | | K ? | S 123 I |
| C₃H₇— | —SO₂—F | | K 94 | N −100 E |
| C₄H₉—C:::C— | —F | | K ? | S 73.7 I |
| C₅H₁₁— | —C₂H₄—Cl | | K 49 | N 14 E |
| C₄H₉—O— | —CO—CH₂—Cl | | K 115 | E 110 I |
| C₅H₁₁—O— | —CO—CH₂—Cl | | K 98 | E 72 A 103 I |
| C₆H₁₃—O— | —CO—CH₂—Cl | | K 87 | E 107 A 116 I |
| C₇H₁₅—O— | —CO—CH₂—Cl | | K 93 | E 106 A 122 I |
| C₈H₁₇—O— | —CO—CH₂—Cl | | K 88 | E 105 A 126 I |
| C₉H₁₉—O— | —CO—CH₂—Cl | | K 95 | E 102 A 126 I |
| C₁₀H₂₁—O— | —CO—CH₂—Cl | | K 89 | E 101 A 128 I |
| C₅H₁₁—CO—C₂H₄—CO— | —Br | | K 119 | A 123.8 I |
| C₆H₁₃—CO—C₂H₄—CO— | —Br | | K 120.3 | A 127.5 I |
| C₃H₇—COO—CH₂—CO— | —Br | | K 94.4 | S 112 I |
| C₅H₁₁—COO— | —Br | | K 70 | E 83 B 103 I |
| C₆H₁₃—COO— | —Br | | K 68.5 | E 74 B 104 I |
| C₇H₁₅—COO— | —Br | | K 76 | S 59.7 B 104.5 I |
| C₈H₁₇—COO— | —Br | | K 69 | E 46 B 103 I |
| C₉H₁₈—COO— | —Br | | K 73.5 | B 102.5 I |
| C₅H₁₁— | —CH₂—Br | | K 76 | N 1.5 E |
| C₅H₁₁— | —C:::C—Br | | K 88 | X 108 I |
| CH₃—O— | —O—C₉H₁₈—Br | | K 88.4 | I |
| C₆H₁₃— | —CO—CH₂—Br | | K 64 | A 52 I |
| C₇H₁₅— | —CO—CH₂—Br | | K 60.5 | A 59.5 I |
| C₈H₁₇— | —CO—CH₂—Br | | K 65.5 | A 64 I |
| C₉H₁₉— | —CO—CH₂—Br | | K 64 | A 67 I |
| C₁₀H₂₁— | —CO—CH₂—Br | | K 72.5 | A 70 I |
| C₂H₅—O— | —CO—CH₂—Br | | K 137 | S 112.5 I |
| C₃H₇—O— | —CO—CH₂—Br | | K 124 | S 118.5 I |
| C₄H₈—O— | —CO—CH₂—Br | | K 107 | E 106 I |
| C₅H₁₁—O— | —CO—CH₂—Br | | K 93 | E 101 I |
| C₆H₁₃—O— | —CO—CH₂—Br | | K 79 | E 98 A 104 I |
| C₇H₁₅—O— | —CO—CH₂—Br | | K 96 | E 92 A 104 I |
| C₈H₁₇—O— | —CO—CH₂—Br | | K 80 | E 95 A 107 I |
| C₉H₁₉—O— | —CO—CH₂—Br | | K 95 | E 100 A 118 I |
| C₁₀H₂₁—O— | —CO—CH₂—Br | | K 91 | E 98 A 116 I |
| C₇H₁₅—O— | —CO—CHCl—Br | 2 | K 95 | A 56 I |
| C₈H₁₇—O— | —CO—CHCl—Br | 2 | K 68 | A 71 I |
| C₉H₁₉—O— | —CO—CHCl—Br | 2 | K 68 | A 78 I |
| C₁₀H₂₁—O— | —CO—CHCl—Br | 2 | K 65 | A 66 I |
| C₂H₅—CHMe—C₂H₄—COO— | —Br | 1 | K 56 | S 28 I |
| C₅H₁₁—O— | —NO₂ | | K 54.5 | N <42 I |
| C₆H₁₃—O— | —NO₂ | | K 67 | N 32.5 I |
| C₇H₁₅—O— | —NO₂ | | K 38.5 | A 30.5 N 38.5 B |
| C₈H₁₇—O— | —NO₂ | | K 51.5 | A 49.5 N 51.5 B |
| H₂C═CH—O—C₁₁H₂₂—O— | —NO₂ | | K 97 | I |
| C₆H₁₃— | —CH═CF₂ | | K 59 | S 95.8 I |
| C₅H₁₁— | —CH₂—CH═CF₂ | | K 36.9 | S 53.1 I |
| C₅H₁₁— | —C₂H₄—CH═CF₂ | | K −25.4 | S 30.8 S 50.6 I |
| C₉H₁₉—O— | —COO-isopinocampheyl | R | K 67.5 | A 48.7 N 55.7 I |
| CH₃— | —C₅H₁₁ | | K 48 | N-1 I |
| C₂H₅— | —C₅H₁₁ | | K <20 | S 33.9 I |
| C₃H₇— | —C₅H₁₁ | | K −18 | S 47.8 I |
| C₃H₇— | —C₆H₁₃ | | K −10.5 | E 48 I |
| C₃H₇— | —C₇H₁₅ | | K −14 | E 29 B 50.5 I |
| C₄H₉— | —C₆H₁₃ | | K −2 | E 40.5 B 48.5 I |
| C₄H₉— | —C₇H₁₅ | | K −15 | E 16.5 B 38.5 I |
| C₅H₁₁— | —C₅H₁₁ | | K 25.1 | E 46.1 E 47.1 L 52.3 I |
| C₅H₁₁— | —C₆H₁₃ | | K ? | E 11.7 E 41.7 E 42.6 L 53.7 I |
| C₅H₁₁— | —C₇H₁₅ | | K ? | E 36 B 63 I |
| C₆H₁₃— | —C₆H₁₃ | | K 25.1 | E 46.1 E 47.1 L 52.3 I |
| C₆H₁₃— | —C₇H₁₅ | | K ? | E 29.7 E 30.2 L 58.1 I |
| C₇H₁₅— | —C₇H₁₅ | | K ? | E 19.5 E 35.1 L 61 I |
| C₈H₁₇— | —C₈H₁₇ | | K 57 | P 61 I |
| C₉H₁₈— | —C₉H₁₉ | | K 57 | P 68 I |
| C₅H₁₁— | —CH₂—O—CH₃ | | K 48 | S 47 I |
| C₅H₁₁— | —CH₂—O—C₃H₇ | | K 27 | S 21 I |
| C₅H₁₁— | —CH₂—O—C₅H₁₁ | | K 16 | S 10 I |
| C₅H₁₁— | —O—C₂H₅ | | K 72 | S 81 I |
| C₅H₁₁— | —O—C₄H₉ | | K 37 | S 80.1 S 88.1 I |
| C₅H₁₁— | —O—C₆H₁₃ | | K 82 | S 84 I |
| C₆H₁₃— | —O—C₆H₁₃ | | K 9 | E 68 B 83.9 I |
| C₇H₁₅— | —O—C₆H₁₃ | | K 58 | B 88.5 I |
| C₈H₁₇— | —O—C₆H₁₃ | | K 46 | B 84 I |
| C₈H₁₇— | —O—C₈H₁₇ | | K 57 | E 86 I |
| C₉H₁₉— | —O—C₆H₁₃ | | K 34 | B 82 I |
| C₃H₇— | —NH—C₄H₉ | | K 75 | S 74.1 I |
| C₅H₁₁— | —NH—C₄H₉ | | K 45 | A 78 I |
| C₃H₇— | —CO—C₂H₅ | | K 42 | S 130 I |
| C₅H₁₁— | —CO—CH₃ | | K 77 | B 84 I |
| C₅H₁₁— | —CO—C₄H₉ | | K 90 | S 106.2 S 110.5 I |
| C₅H₁₁— | —CO—C₆H₁₁ | | K 106 | B 104 A 109.5 I |
| C₅H₁₁— | —CO—C₆H₁₃ | | K 96 | A 111 I |
| C₆H₁₃— | —CO—CH₃ | | K 79 | B 85.5 I |
| C₆H₁₃— | —CO—C₅H₁₁ | | K 106 | A 105.9 I |
| C₇H₁₅— | —CO—CH₃ | | K 76.5 | B 84.5 I |
| C₇H₁₅— | —CO—C₅H₁₁ | | K 94.3 | B 95.6 A 103.8 I |
| C₈H₁₇— | —CO—CH₃ | | K 86.5 | B 84 I |
| C₈H₁₇— | —CO—C₅H₁₁ | | K 87.5 | B 92.2 A 101.3 I |
| C₉H₁₉— | —CO—CH₃ | | K 85 | B 82.5 I |
| C₉H₁₉— | —CO—C₅H₁₁ | | K 80.2 | B 88.1 A 99.7 I |
| C₁₀H₂₁— | —CO—C₅H₁₁ | | K 77.5 | B 88.8 A 98.7 I |
| C₁₀H₂₁— | —CO—C₉H₁₉ | | K 57.8 | E 101 I |
| C₅H₁₁— | —CO—CH₂—CO—CH₃ | | K 110 | X 135 I |
| C₁₀H₂₁— | —CO—CH₂—CO—CH₃ | | K 86 | E 97 B 107 A 135 I |
| C₅H₁₁— | —CO—CH₂—OOC—C₃H₇ | | K 85 | S 147 I |
| C₈H₁₇ — | —CO—CH₂—OOC—C₃H₇ | | K 70 | S 144 I |
| C₆H₁₃— | —CO—CH═CH—COO—C₂H₅ | | K 40 | S 59 I |
| C₆H₁₃— | —CO—CH═CH—COO—C₃H₇ | | K 40 | S 66 I |
| C₆H₁₃— | —CO—CH═CH—COO—C₄H₉ | | K 34 | S 68 I |
| C₆H₁₃— | —CO—CH═CH—COO—C₅H₁₁ | | K 25 | S 57 I |
| C₈H₁₇— | —CO—CH═CH—COO—C₃H₇ | | K 62 | S 72 I |
| C₈H₁₇— | —CO—CH═CH—COO—C₄H₉ | | K 56 | S 69 I |
| C₈H₁₇— | —CO—CH═CH—COO—C₅H₁₁ | | K 54 | S 70 I |
| C₈H₁₇— | —CO—CH—CH—COO—C₆H₁₃ | | K 36 | S 71 I |
| C₈H₁₇— | —CO—CH═CH—COO—C₇H₁₅ | | K 40 | S 72 I |
| C₈H₁₇— | —CO—CH═CH—COO—C₈H₁₇ | | K 35 | S 71 I |
| C₃H₇— | —COO—C₃H₇ | | K 63 | X 61 I |
| C₅H₁₁— | —COO—C₃H₇ | | K 55 | X 58 I |
| C₅H₁₁— | —COO—C₈H₁₇ | | K 29 | B 25 I |
| C₆H₁₇— | —COO—C₂H₅ | | K 64 | B 61.4 A 61.4 I |
| C₈H₁₇— | —COO—C₃H₇ | | K 60 | A 57 I |
| C₅H₁₁— | —COS—C₂H₅ | | K ? | E 103.5 L 113 A 121.4 U |
| C₅H₁₁— | —COS—C₃H₇ | | K ? | E 90 L 110.3 A 118.5 I |
| C₅H₁₁— | —COS—C₄H₉ | | K ? | E 75 L 109 A 120.5 I |
| C₅H₁₁— | —COS—C₅H₁₁ | | K ? | E 59.8 L 104.5 A 120 I |
| C₅H₁₁— | —COS—C₆H₁₃ | | K ? | E 50 L 102 A 118 I |
| C₅H₁₁— | —COS—C₇H₁₅ | | K ? | E 40.1 L 100.2 A 116.7 I |
| C₅H₁₁— | —COS—C₈H₁₇ | | K ? | E 33 L 99.8 A 116.3 I |
| C₅H₁₁— | —COS—C₉H₁₉ | | K ? | E 25 L 95.4 A 113.8 I |
| C₅H₁₁— | —COS—C₁₀H₂₁ | | K ? | E 15 L 94 A 113.2 I |
| C₅H₁₁— | —OOC—C₅H₁₁ | | K 45.7 | S 67.4 I |
| C₈H₁₇— | —OOC—C₇H₁₅ | | K 65 | E 83 B 91 I |
| C₇H₁₅— | —OOC—CHMe—CHMe—O—CH₃ | 1 | K −18 | C* 9 A 13 I |
| C₈H₁₇— | —OOC—CHMe—CHMe—O—CH₃ | 1 | K 32 | C* 10 A 15 I |
| C₅H₁₁— | —CMe═N—O—C₂H₅ | | K 73 | A 91 I |
| C₆H₁₃— | —CMe═N—OOC—C₄H₉ | | K 89 | A 88 I |
| C₆H₁₃— | —CMe═N—OOC—C₈H₁₇ | | K 70 | A 86 I |
| C₈H₁₇—O— | —C₅H₁₀—CHMe—O—C₃H₇ | 1 | K 14 | S 18 S 37 C* 41 I |
| C₁₀H₂₁—O— | —C₅H₁₀—CHMe—O—CH₃ | 1 | K 41 | S 49 C* 53 I |
| C₁₀H₂₁—O— | —C₅H₁₀—CHMe—O—C₂H₅ | 1 | K 31 | S 32 S 38 C* 48 I |
| C₁₀H₂₁—O— | —C₅H₁₀—CHMe—O—C₃H₇ | 1 | K 28 | S 23 S 35 C* 44 I |
| C₁₀H₂₁—O— | —C₅H₁₀—CHMe—O—C₄H₉ | 1 | K 33 | S 25 C* 35 A 39 I |
| C₁₀H₂₁—O— | —C₅H₁₀—CHMe—O—C₅H₁₁ | 1 | K 32 | S 27 C* 30 A 36 I |
| C₁₂H₂₅—O— | —C₆H₁₀—CHMe—O—C₃H₇ | 1 | K 40 | C* 44 U |
| C₁₀H₂₁—O— | —C₆H₁₂—CHMe—O—C₃H₇ | 1 | K 43 | S 46 S 56 I |
| C₂H₅—O— | —O—C₂H₅ | | K 178 | X 185 I |
| C₆H₁₃—O— | —O—C₆H₁₃ | | K 124 | N 130 U |
| C₈H₁₇—O— | —O—CHMe—COO—CH₃ | S | K 57 | A 49.2 I |
| C₈H₁₇—O— | —O—CHMe—COO—C₂H₅ | S | K 39 | A 42 I |
| CH₃—O— | —CO—C₂H₅ | | K 145.7 | E 146.4 I |
| CH₃—O— | —CO—C₃H₇ | | K 126.2 | E 122.2 A 125.9 I |
| CH₃—O— | —CO—C₄H₉ | | K 120.5 | A 117.7 I |
| CH₃—O— | —CO—C₅H₁₁ | | K 123 | A 119 I |
| CH₃—O— | —CO—C₆H₁₃ | | K 118 | A 117 I |
| CH₃—O— | —CO—C₇H₁₅ | | K 120 | A 117.7 I |
| CH₃—O— | —CO—C₈H₁₇ | | K 116 | A 116.2 I |
| CH₃—O— | —CO—C₉H₁₉ | | K 118 | A 116.7 I |
| C₂H₅—O— | —CO—CH₃ | | K 96 | E 156.2 I |
| C₂H₅—O— | —CO—C₂H₅ | | K 124 | E 172.4 I |
| C₂H₅—O— | —CO—C₃H₇ | | K 123 | E 156.2 I |
| C₂H₅—O— | —CO—C₄H₉ | | K 108 | E 136 A 153 I |
| C₂H₅—O— | —CO—C₅H₁₁ | | K 110 | E 129.9 A 150.6 I |
| C₂H₅—O— | —CO—C₆H₁₃ | | K 107 | E 124 A 148 I |
| C₂H₅—O— | —CO—C₇H₁₅ | | K 111.5 | E 121 A 146.4 I |
| C₂H₅—O— | —CO—C₈H₁₇ | | K 108 | E 120.2 A 144.8 I |
| C₂H₅—O— | —CO—C₉H₁₉ | | K 118 | E 121.7 A 143.1 I |
| C₃H₇—O— | —CO—CH₃ | | K 107 | E 155.6 I |
| C₃H₇—O— | —CO—C₂H₅ | | K 119 | E 177.3 I |
| C₃H₇—O— | —CO—C₃H₇ | | K 136.5 | E 153.9 A 158.2 I |
| C₃H₇—O— | —CO—C₄H₉ | | K 126 | E 135.7 A 154.6 I |
| C₃H₇—O— | —CO—C₅H₁₁ | | K 116 | E 125.9 A 150.3 I |
| C₃H₇—O— | —CO—C₆H₁₃ | | K 113 | E 120.1 A 147.3 I |
| C₃H₇—O— | —CO—C₇H₁₅ | | K 118 | E 121 A 145.2 I |
| C₃H₇—O— | —CO—C₈H₁₇ | | K 115 | E 120.3 A 143 I |
| C₃H₇—O— | —CO—C₉H₁₉ | | K 106 | E 119.5 A 141 I |
| C₄H₉—O— | —CO—CH₃ | | K 97 | E 144 I |
| C₄H₉—O— | —CO—C₂H₅ | | K 114 | E 167.3 A 171.4 I |
| C₄H₉—O— | —CO—C₃H₇ | | K 101.5 | E 145.7 A 155.9 I |
| C₄H₉—O— | —CO—C₄H₉ | | K 124 | E 136.2 A 156.8 I |
| C₄H₉—O— | —CO—C₅H₁₁ | | K 115 | E 120 A 150.8 I |
| C₄H₉—O— | —CO—C₆H₁₃ | | K 109 | E 115 A 151.5 I |
| C₄H₉—O— | —CO—C₇H₁₅ | | K 99 | E 113.7 A 148.3 I |
| C₄H₉—O— | —CO—C₈H₁₇ | | K 102.5 | E 111.8 A 146.8 I |
| C₄H₉—O— | —CO—C₉H₁₉ | | K 107 | E 111.5 A 144.7 I |
| C₅H₁₁—O— | —CO—CH₃ | | K 90 | E 139.5 I |
| C₅H₁₁—O— | —CO—C₂H₅ | | K 91 | E 155.6 A 169 I |
| C₅H₁₁—O— | —CO—C₃H₇ | | K 93 | E 129.5 A 150.8 I |
| C₅H₁₁—O— | —CO—C₄H₉ | | K 124 | E 121 A 152.1 I |
| C₅H₁₁—O— | —CO—C₅H₁₁ | | K 128.8 | E 127 A 147.8 I |
| C₅H₁₁—O— | —CO—C₆H₁₃ | | K 117 | E 113 A 146.3 I |
| C₅H₁₁—O— | —CO—C₇H₁₅ | | K 111 | E 108 A 143.8 I |
| C₅H₁₁—O— | —CO—C₈H₁₇ | | K 104 | E 101 A 144 I |
| C₅H₁₁—O— | —CO—C₉H₁₉ | | K 102.7 | E 101.5 A 141.8 I |
| C₆H₁₃—O— | —CO—CH₃ | | K 91 | E 137 I |
| C₆H₁₃—O— | —CO—C₂H₅ | | K 78 | E 149 A 165.5 I |
| C₆H₁₃—O— | —CO—C₃H₇ | | K 82 | E 121.8 A 147 I |
| C₆H₁₃—O— | —CO—C₄H₉ | | K 109 | E 116 A 149.6 I |
| C₆H₁₃—O— | —CO—C₅H₁₁ | | K 120.5 | A 145.3 I |
| C₆H₁₃—O— | —CO—C₆H₁₃ | | K 124.5 | A 145.2 I |
| C₆H₁₃—O— | —CO—C₇H₁₅ | | K 123 | A 142.5 I |
| C₆H₁₃—O— | —CO—C₈H₁₇ | | K 113. 5 | A 141.2 I |
| C₆H₁₃—O— | —CO—C₉H₁₉ | | K 110.2 | A 139.5 I |
| C₇H₁₅—O— | —CO—CH₃ | | K 99 | E 136 I |
| C₇H₁₅—O— | —CO—C₂H₅ | | K 98 | E 146.8 A 163.7 I |
| C₇H₁₅—O— | —CO—C₃H₇ | | K 87 | E 120.2 A 145.2 I |
| C₇H₁₅—O— | —CO—C₄H₉ | | K 106 | E 110 A 147 I |
| C₇H₁₅—O— | —CO—C₅H₁₁ | | K 112.5 | A 142.3 I |
| C₇H₁₅—O— | —CO—C₆H₁₃ | | K 123 | A 138 I |
| C₇H₁₅—O— | —CO—C₇H₁₅ | | K 126.5 | A 139.7 I |
| C₇H₁₅—O— | —CO—C₈H₁₇ | | K 119 | A 138.7 I |
| C₇H₁₅—O— | —CO—C₉H₁₉ | | K 114 | A 134.7 I |
| C₈H₁₇—O— | —CO—CH₃ | | K 96 | E 136.5 I |
| C₈H₁₇—O— | —CO—C₂H₅ | | K 104 | E 144.8 A 161.8 I |
| C₈H₁₇—O— | —CO—C₃H₇ | | K 96 | E 118.9 A 142.9 I |
| C₈H₁₇—O— | —CO—C₄H₉ | | K 106.5 | E 107 A 145.7 I |
| C₈H₁₇—O— | —CO—C₅H₁₁ | | K 104 | A 140 I |
| C₈H₁₇—O— | —CO—C₆H₁₃ | | K 116 | A 140.3 I |
| C₈H₁₇—O— | —CO—C₇H₁₅ | | K 125 | A 138.5 I |
| C₈H₁₇—O— | —CO—C₈H₁₇ | | K 124.5 | A 137.4 I |
| C₈H₁₇—O— | —CO—C₉H₁₉ | | K 124.5 | A 134.9 I |
| C₉H₁₉—O— | —CO—CH₃ | | K 104.2 | E 135 I |
| C₉H₁₉—O— | —CO—C₂H₅ | | K 112 | E 144.3 A 160 I |
| C₉H₁₉—O— | —CO—C₃H₇ | | K 103.5 | E 118.2 A 141 I |
| C₉H₁₉—O— | —CO—C₄H₉ | | K 101 | E 106.4 A 143.9 I |
| C₉H₁₉—O— | —CO—C₅H₁₁ | | K 106 | A 138.5 I |
| C₉H₁₉—O— | —CO—C₆H₁₃ | | K 112.8 | A 139 I |
| C₉H₁₉—O— | —CO—C₇H₁₅ | | K 124 | A 136 I |
| C₉H₁₉—O— | —CO—C₈H₁₇ | | K 124.5 | A 135.4 I |
| C₉H₁₉—O— | —CO—C₉H₁₉ | | K 128.5 | A 132.8 I |
| C₁₀H₂₁—O— | —CO—CH₃ | | K 103 | E 132 I |
| C₁₀H₂₁—O— | —CO—C₂H₅ | | K 92 | E 143.4 A 157.5 I |
| C₁₀H₂₁—O— | —CO—C₃H₇ | | K 90 | E 117.5 A 138.8 I |
| C₁₀H₂₁—O— | —CO—C₄H₉ | | K 97 | E 106 A 141.2 I |
| C₁₀H₂₁—O— | —CO—C₅H₁₁ | | K 101.9 | A 136.6 I |
| C₁₀H₂₁—O— | —CO—C₆H₁₃ | | K 108.7 | A 137 I |
| C₁₀H₂₁—O— | —CO—C₇H₁₅ | | K 110.5 | A 134 I |
| C₁₀H₂₁—O— | —CO—C₈H₁₇ | | K 118 | A 133.3 I |
| C₁₀H₂₁—O— | —CO—C₉H₁₉ | | K 123.5 | A 130.9 I |
| C₁₁H₂₃—O— | —CO—CH₃ | | K 110.5 | E 130.6 I |
| C₁₂H₂₅—O— | —CO—CH₃ | | K 109.8 | E 129.9 I |
| C₁₂H₂₅—O— | —CO—C₂H₅ | | K 95.5 | E 139.3 A 151.5 I |
| C₁₂H₂₅—O— | —CO—C₃H₇ | | K 105.5 | E 115.5 A 134.8 I |
| C₁₂H₂₅—O— | —CO—C₄H₉ | | K 102 | E 105 S 115 A 141 I |
| C₁₂H₂₅—O— | —CO—C₅H₁₁ | | K 98 | A 132.5 I |
| C₁₂H₂₅—O— | —CO—C₆H₁₃ | | K 105 | A 131 I |
| C₁₂H₂₅—O— | —CO—C₇H₁₅ | | K 108.5 | A 129.7 I |
| C₁₂H₂₅—O— | —CO—C₈H₁₇ | | K 112.5 | A 129.8 I |
| C₁₂H₂₅—O— | —CO—C₉H₁₉ | | K 115.5 | A 127.4 I |
| C₁₄H₂₉—O— | —CO—CH₃ | | K 112.1 | E 123.2 B |
| C₁₆H₃₃—O— | —CO—CH₃ | | K 116.8 | E 122.5 I |
| C₄H₉—O— | ——CO—CH₂CO—C₄H₉ | | K 126.1 | A 155.4 I |
| C₆H₁₃—O— | —CO—CH₂—CO—C₂H₅ | | K 108.6 | E 128.1 A 175.2 I |
| C₈H₁₇—O— | —CO—CH₂—CO—CH₃ | | K 108.7 | E 140.7 A 176.5 I |
| C₈H₁₇—O— | —CO—CH₂—CO—C₂H₅ | | K 101 | E 124.3 A 173.1 I |
| C₈H₁₇—O— | —CO—CH₂—CO—C₄H₉ | | K 110.2 | A 152.5 I |
| C₈H₁₇—O— | —CO—CH₂—CO—C₈H₁₇ | | K 125.3 | A 137 I |
| C₉H₁₉—O— | —CO—CH₂—CO—CH₃ | | K 104.5 | E 141 A 175.5 I |
| C₁₀H₂₁—O— | —CO—CH₂—CO—CH₃ | | K 100.5 | E 137.4 A 173.8 I |
| C₁₀H₂₁—O— | —CO—CH₂—CO—C₂H₅ | | K 98.5 | E 123.4 A 168.3 I |
| C₁₁H₂₃—O— | —CO—CH₂—CO—CH₃ | | K 108.5 | E 135.6 A 172 I |
| C₁₁H₂₃—O— | —CO—CH₂—CO—C₂H₅ | | K 105.1 | E 123.7 A 166.8 I |
| C₁₂H₂₅—O— | —CO—CH₂—CO—CH₃ | | K 105 | E 135 A 167.5 I |
| C₁₂H₂₅—O— | —CO—CH₂—CO—C₂H₅ | | K 95.8 | E 120 A 161.5 I |
| C₁₂H₂₅—O— | —CO—CH₂—CO—C₃H₇ | | K 112.5 | E 103.3 A 147 I |
| C₁₂H₂₅—O— | —CO—CH₂—CO—C₄H₉ | | K 105.2 | A 133.8 I |
| C₁₂H₂₅—O— | —CO—CH₂—CO—C₁₂H₂₅ | | K 124.4 | A 125.8 I |
| C₁₄H₂₉—O— | —CO—CH₂—CO—C₂H₅ | | K 106 | A 120.5 A 158.5 I |
| C₁₆H₃₃—O— | —CO—CH₂—CO—CH₃ | | K 118.9 | E 139.1 A 162 I |
| C₁₈H₃₇—O— | —CO—CH₂—CO—CH₃ | | K 121.7 | E 137 A 157.8 I |
| C₁₈H₃₇—O— | —CO—CH₂—CO—C₂H₅ | | K 113 | E 114.5 A 150.7 I |
| CH₃—O— | —COO—C₆H₁₃ | | K 61.7 | E 45.4 I |
| C₂H₅—O— | —COO—C₃H₇ | | K 102 | S 103 I |
| C₃H₇—O— | —COO—C₃H₇ | | K 105 | S 107 I |
| C₄H₉—O— | —COO—C₃H₇ | | K 97 | A 113.5 I |
| C₄H₉—O— | —COO—C₄H₉ | | K 93 | E 92 A 102 I |
| C₅H₁₁—O— | —COO—C₂H₅ | | K 114.5 | A 123.5 I |
| C₅H₁₁—O— | —COO—C₃H₇ | | K 80 | A 106.5 I |
| C₅H₁₁—O— | —COO—C₆H₁₃ | | K 63.7 | E 63.3 B 68.4 A 85.4 I |
| C₅H₁₁—O— | —COO—C₇H₁₅ | | K ? | E 59 B 65 A 81 I |
| C₅H₁₁—O— | —COO—C₁₂H₂₅ | | K 70.4 | E 54.4 A 70.6 I |
| C₆H₁₃—O— | —COO—CH₃ | | K 124 | E 132 B 139 A 139 I |
| C₆H₁₃—O— | —COO—C₂H₅ | | K 81 | E 92 B 97 A 119 I |
| C₆H₁₃—O— | —COO—C₃H₇ | | K 80 | E 67 B 74 A 107 I |
| C₆H₁₃—O— | —COO—C₄H₉ | | K 58 | B 64 A 92 I |
| C₆H₁₃—O— | —COO—C₅H₁₁ | | K 83 | B 58 A 90 E |
| C₆H₁₃—O— | —COO—C₆H₁₃ | | K 79 | B 57.5 A 86 E |
| C₆H₁₃—O— | —COO—C₇H₁₅ | | K 76 | B 57 A 84 E |
| C₆H₁₃—O— | —COO—C₈H₁₇ | | K 74 | B 56 A 82 I |
| C₆H₁₃—O— | —COO—C₉H₁₉ | | K 71 | B 55 A 80 I |
| C₆H₁₃—O— | —COO—C₁₀H₂₁ | | K 59 | B 54.5 A 78 I |
| C₇H₁₅—O— | —COO—CH₃ | | K 124 | E 127 B 133 A 133 I |
| C₇H₁₅—O— | —COO—C₂H₅ | | K 52 | E 88 B 94 A 111 I |
| C₇H₁₅—O— | —COO—C₃H₇ | | K 78 | E 54 B 64 A 102 I |
| C₇H₁₅—O— | —COO—C₄H₉ | | K 62 | C 59 A 89 I |
| C₇H₁₅—O— | —COO—C₅H₁₁ | | K 79 | C 50 A 87 E |
| C₇H₁₅—O— | —COO—C₆H₁₃ | | K 86 | C 60 A 84 E |
| C₇H₁₅—O— | —COO—C₇H₁₅ | | K 86 | C 55 A 82 E |
| C₇H₁₅—O— | —COO—C₈H₁₇ | | K 76 | A 80 I |
| C₇H₁₅—O— | —COO—C₉H₁₉ | | K 69 | A 78 I |
| C₇H₁₅—O— | —COO—C₁₀H₂₁ | | K 69 | A 76 I |
| C₈H₁₇—O— | —COO—CH₃ | | K 117 | E 126 B 132 A 132 I |
| C₈H₁₇—O— | —COO—C₂H₅ | | K 75 | E 88 B 96 A 112 I |
| C₈H₁₇—O— | —COO—C₃H₇ | | K 83 | B 64 A 101 I |
| C₈H₁₇—O— | —COO—C₄H₉ | | K 56 | C 56 A 86 I |
| C₈H₁₇—O— | —COO—C₅H₁₁ | | K 66 | C 55 A 88 E |
| C₈H₁₇—O— | —COO—C₆H₁₃ | | K 72 | C 56 A 82 E |
| C₈H₁₇—O— | —COO—C₇H₁₅ | | K 87 | C 46 A 83 E |
| C₈H₁₇—O— | —COO—C₈H₁₇ | | K 80 | A 80 I |
| C₈H₁₇—O— | —COO—C₉H₁₉ | | K 79 | A 80 I |
| C₈H₁₇—O— | —COO—C₁₀H₂₁ | | K 75 | A 79 I |
| C₈H₁₇—O— | —COO—C₁₁H₂₃ | | K 74 | A 79 I |
| C₈H₁₇—O— | —COO—C₁₂H₂₅ | | K 78 | A 76 I |
| C₈H₁₇—O— | —COO—C₁₃H₂₇ | | K 77 | A 76 I |
| C₈H₁₇—O— | —COO—C₁₄H₂₉ | | K 80 | A 74 I |
| C₈H₁₇—O— | —COO—C₁₅H₃₁ | | K 77 | A 74 I |
| C₈H₁₇—O— | —COO—C₁₆H₃₃ | | K 83 | A 72 I |
| C₈H₁₇—O— | —COO—C₁₇H₃₅ | | K 81 | A 72 E |
| C₈H₁₇—O— | —COO—C₁₈H₃₇ | | K 80 | A 70 E |
| C₈H₁₇—O— | —COO—C₁₉H₃₉ | | K 81 | A 69 E |
| C₉H₁₉—O— | —COO—CH₃ | | K 124 | E 123 B 129 A 129 I |
| C₉H₁₉—O— | —COO—C₂H₅ | | K 78 | E 81 B 91 A 106 I |
| C₉H₁₉—O— | —COO—C₃H₇ | | K 67 | B 63 A 99 I |
| C₉H₁₉—O— | —COO—C₄H₉ | | K 64 | C 56 A 86 I |
| C₉H₁₉—O— | —COO—C₅H₁₁ | | K 62 | C 55 A 86 E |
| C₉H₁₉—O— | —COO—C₆H₁₃ | | K 71 | C 57 A 83 E |
| C₉H₁₉—O— | —COO—C₇H₁₅ | | K 84 | C 54 A 82 E |
| C₉H₁₉—O— | —COO—C₈H₁₇ | | K 86 | C 36 A <84 E |
| C₁₀H₂₁—O— | —COO—CH₃ | | K 122 | E 117 B 124 A 124 I |
| C₁₀H₂₁—O— | —COO—C₂H₅ | | K 71 | E 80 B 90 A 104 I |
| C₁₀H₂₁—O— | —COO—C₃H₇ | | K ? | B 67.9 A 99 I |
| C₁₀H₂₁—O— | —COO—C₄H₉ | | K 54 | C 49 A 82 I |
| C₁₀H₂₁—O— | —COO—C₅H₁₁ | | K 66 | C 53 A 82 I |
| C₁₀H₂₁—O— | —COO—C₆H₁₃ | | K 60 | C 67 A 84 I |
| C₁₀H₂₁—O— | —COO—C₇H₁₅ | | K 74 | C 66 A 80 E |
| C₁₀H₂₁—O— | —COO—C₈H₁₇ | | K 83 | C 67 A 78 E |
| C₁₀H₂₁—O— | —COO—C₉H₁₉ | | K 86 | C 52 A ? E |
| C₁₀H₂₁—O— | —COO—C₁₀H₂₁ | | K 85 | C 54 A ? E |
| C₁₂H₂₅—O— | —COO—CH₃ | | K 122.5 | S 124 I |
| C₁₂H₂₅—O— | —COO—C₂H₅ | | K 80.5 | S 102.5 I |
| C₁₂H₂₅—O— | —COO—C₃H₇ | | K 71 | S 97 I |
| C₁₂H₂₅—O— | —COO—C₆H₁₃ | | K 69 | G 57.8 C 67.5 A 80 I |
| C₁₂H₂₅—O— | —COO—C₇H₁₅ | | K 77 | G 72 C 74 A 81 I |
| C₁₂H₂₅—O— | —COO—C₈H₁₇ | | K 76.3 | C 72.6 A 80 I |
| C₁₄H₂₉—O— | —COO—C₆H₁₃ | | K 68 | G 58.8 C 68.2 A 81 I |
| C₁₄H₂₉—O— | —COO—C₇H₁₅ | | K 71.2 | C 72.5 A 82.5 I |
| C₁₄H₂₉—O— | —COO—C₈H₁₇ | | K 76 | C 74.5 A 80.5 I |
| C₁₆H₃₃—O— | —COO—C₂H₅ | | K 88 | B 82 A 94 I |
| C₁₆H₃₃—O— | —COO—C₃H₇ | | K 80 | B 46 A 89 E |
| C₁₆H₃₃—O— | —COO—C₄H₉ | | K 78 | A 79 I |
| C₁₆H₃₃—O— | —COO—C₅H₁₁ | | K 79 | G 40 A 81 E |
| C₁₆H₃₃—O— | —COO—C₆H₁₃ | | K 75 | G 60 A 78 E |
| C₁₆H₃₃—O— | —COO—C₇H₁₅ | | K 77 | G 72 A 80 I |
| C₁₆H₃₃—O— | —COO—C₈H₁₇ | | K 74 | G 76 A 78 I |
| C₁₆H₃₃—O— | —COO—C₉H₁₉ | | K 83 | G 78 A 80 I |
| C₁₆H₃₃—O— | —COO—C₁₀H₂₁ | | K 83 | G 77 A 78 E |
| C₁₆H₃₃—O— | —COO—C₁₁H₂₃ | | K 86 | G 72 A 79 E |
| C₁₆H₃₃—O— | —COO—C₁₂H₂₅ | | K 89 | G 64 A 77 E |
| C₁₆H₃₃—O— | —COO—C₁₃H₂₇ | | K 91 | G 40 A 78 E |
| C₁₈H₃₇—O— | —COO—C₂H₅ | | K 72 | B 55 A 87 E |
| C₁₈H₃₇—O— | —COO—C₃H₇ | | K 83 | A 86 I |
| C₉H₁₉—O— | —OOC—CHCl—CHMe—CH₃ | 1 | K 80 | S 62.5 C* 68 A 82.5 I |
| C₁₀H₂₁—O— | —OOC—CHCl—CHMe—CH₃ | 1 | K 82 | C* 69 A 81 I |
| C₁₁H₂₃—O— | —OOC—CHCl—CHMe—CH₃ | S | K 86 | A 85 I |
| C₁₂H₂₅—O— | —OOC—CHCl—CHMe—CH₃ | 1 | K 92 | A 85 I |
| C₇H₁₅—O— | —OOC—CHCl—CHMe—CH₃ | 2 | K ? | G 70.2 C 72.4 A 82 I |
| C₅H₁₁—O— | —OOC—CHCl—CHMe—C₂H₅ | 3 | K ? | C* 55 A 64 B |
| C₆H₁₃—O— | —OOC—CHCl—CHMe—C₂H₅ | 3 | K 47 | S 48 C* 51.5 A 61 I |
| C₇H₁₅—O— | —OOC—CHCl—CHMe—C₂H₅ | 3 | K 55 | C* 55 A 62 I |
| C₈H₁₇—O— | —OOC—CHCl—CHMe—C₂H₅ | 3 | K 48 | S 36 C* 56 A 66 I |
| C₉H₁₉—O— | —OOC—CHCl—CHMe—C₂H₅ | 3 | K 52 | C* 53.5 A 65 I |
| C₁₀H₂₁—O— | —OOC—CHCl—CHMe—C₂H₅ | 3 | K 50 | C* 43 A 49 U |
| C₁₂H₂₅—O— | —OOC—CHCl—CHMe—C₂H₅ | 3 | K 62 | C* 66 A 67 I |
| C₁₄H₂₉—O— | —OOC—CHCl—CHMe—C₂H₅ | 3 | K 66 | A 68 I |
| C₈H₁₇—O— | —OOC—CHCl—CHMe—C₂H₅ | 5 | K ? | C* 59 A 60 I |
| C₆H₁₃—O— | —OOC—CHBr—CHMe—CH₃ | S | K 64 | C* 67 I |
| C₈H₁₇—O— | —OOC—CHBr—CHMe—CH₃ | S | K 35 | C* 48 A 56 I |
| C₁₀H₂₁—O— | —OOC—CHBr—CHMe—CH₃ | S | K 55 | C* 57 A 68 I |
| C₁₂H₂₅—O— | —OOC—CHBr—CHMe—CH₃ | S | K 69 | A 70 I |
| C₆H₁₃—O— | —OOC—CHBr—CHMe—C₂H₅ | 3 | K ? | C* 55 B |
| C₈H₁₇—O— | —OOC—CHBr—CHMe—C₂H₅ | 3 | K 20 | C* 42 A 53 I |
| C₁₀H₂₁—O— | —OOC—CHBr—CHMe—C₂H₅ | 3 | K ? | C* 49 A 58 B |
| C₁₂H₂₅—O— | —OOC—CHBr—CHMe—C₂H₅ | 3 | K ? | C* 47 A 59 B |
| C₈H₁₇—O— | —OOC—CHMe—CHMe—C₂H₅ | 3 | K 48 | I* 36 C* 53 A 64 I |
| C₈H₁₇—O— | —OCOO—CH₂—CHCl—CHMe—C₂H₅ | 3 | K 43 | C* 50 I |
| 2(C₂H₅—OOC)—CH—C₆H₁₂—O— | —O—CHMe—C₆H₁₃ | S | K −20 | X 19 I |
| C₅H₁₁—COO— | —CO—CHMe—C₂H₅ | S | K ? | S 15 S 32 A 57 I |
| C₈H₁₇—COO— | —CO—CHMe—C₂H₅ | S | K 47.8 | A 65.1 I |
| C₁₃H₂₇—COO— | —CO—CHMe—C₂H₅ | S | K 69.4 | A 66.7 I |
| C₇H₁₅—COO— | —COO—CHMe—C₂H₅ | R | K 46.7 | C* 22.4 A 44.6 I |
| C₈H₁₇—COO— | —COO—CHMe—C₂H₅ | R | K 56.2 | C* 26.4 A 45.6 I |
| C₁₈H₃₇—O— | —COO—C₄H₉ | | K 83 | A 78 I |
| C₁₈H₃₇—O— | —COO—C₅H₁₁ | | K 83 | A 79 I |
| C₁₈H₃₇—O— | —COO—C₆H₁₃ | | K 84 | G 50 A 76 E |
| C₁₈H₃₇—O— | —COO—C₇H₁₅ | | K 82 | G 67 A 78 E |
| C₁₈H₃₇—O— | —COO—C₈H₁₇ | | K 84 | G 75 A 76 E |
| C₁₈H₃₇—O— | —COO—C₉H₁₉ | | K 80 | G 77 A 78 I |
| C₁₈H₃₇—O— | —COO—C₁₀H₂₁ | | K 84 | G 75 A 78 E |
| C₁₈H₃₇—O— | —COO—C₁₁H₂₃ | | K 81 | G 56 A 78 E |
| C₁₈H₃₇—O— | —COO—C₁₂H₂₅ | | K 88 | A 78 E |
| C₅H₁₁—O— | —COS—C₆H₁₃ | | K 91 | L 121 A 149.5 I |
| C₅H₁₁—O— | —OOC—C₅H₁₁ | | K ? | E 97.7 B 106 I |
| C₈H₁₇—O— | —OOC—C₉H₁₉ | | K 87 | G 107 F 108.5 I |
| C₈H₁₇—O— | —OOC—C₁₁H₂₃ | | K 78 | G 105 F 108.5 I |
| C₈H₁₇—O— | —OOC—C₁₃H₂₇ | | K 82 | G 104 F 108 I |
| C₇H₁₅—NH— | —NH—C₇H₁₅ | | K 96.8 | C 93 N 103.8 I |
| C₈H₁₇—NH— | —NH—C₈H₁₇ | | K 99 | I 98.1 C 110 N 110.4 I |
| C₉H₁₉—NH— | —NH—C₉H₁₉ | | K 93.8 | I 102 C 112.8 I |
| C₁₀H₂₁—NH— | —NH—C₁₀H₂₁ | | K 97.1 | I 108.8 C 116.8 I |
| C₁₁H₂₃—NH— | —NH—C₁₁H₂₃ | | K 95.4 | F 92.8 I 109.9 C 117 I |
| C₁₂H₂₅—NH— | —NH—C₁₂H₂₅ | | K 96.4 | I 113.5 C 117.8 I |
| C₁₆H₃₃—NH— | —NH—C₁₆H₃₃ | | K 103 | I 115.8 I |
| C₁₈H₃₇—NH— | —NH—C₁₈H₃₇ | | K 105.2 | I 114.6 I |
| CH₃—O—C₂H₄—O— | —O—C₂H₄—O—CH₃ | | K 127 | K 139 I |
| C₂H₅—O—C₂H₄—O— | —O—C₂H₄—O—C₂H₅ | | K 75 | K 118 I |
| C₆H₁₃—OCOO—C₂H₄—O— | —O—C₂H₄—OCOO—C₆H₁₃ | | K 83 | S 109 I |
| C₇H₁₅—OCOO—C₂H₄—O— | —O—C₂H₄—OCOO—C₇H₁₅ | | K 77 | S 85 I |
| C₈H₁₇—OCOO—C₂H₄—O— | —O—C₂H₄—OCOO—C₈H₁₇ | | K 83 | S 88 I |
| CH₃—OCOO—C₆H₁₂—O— | —O—C₆H₁₂—OCOO—CH₃ | | K 107 | S 159 I |
| C₂H₅—OCOO—C₆H₁₂—O— | —O—C₆H₁₂—OCOO—C₂H₅ | | K 98 | S 166 I |
| C₃H₇—OCOO—C₆H₁₂—O— | —O—C₆H₁₂—OCOO—C₃H₇ | | K 95 | S 157 I |
| C₄H₉—OCOO—C₆H₁₂—O— | —O—C₆H₁₂—OCOO—C₄H₉ | | K 90 | S 170 I |
| C₅H₁₁—OCOO—C₆H₁₂—O— | —O—C₆H₁₂—OCOO—C₅H₁₁ | | K 89 | S 150 I |
| C₆H₁₃—OCOO—C₆H₁₂—O— | —O—C₆H₁₂—OCOO—C₆H₁₃ | | K 89 | S 168 I |
| C₇H₁₅—OCOO—C₆H₁₂—O— | —O—C₆H₁₂—OCOO—C₇H₁₅ | | K 85 | S 150 I |
| C₈H₁₇—OCOO—C₆H₁₂—O— | —O—C₆H₁₂—OCOO—C₈H₁₇ | | K 88 | S 172 I |
| C₉H₁₉—CO— | —CO—C₉H₁₉ | | K 149.3 | C 147.6 I |
| C₁₀H₂₁—CO— | —CO—C₁₀H₂₁ | | K 141 | S 142 I |
| C₅H₁₁—CO— | —OOC—C₅H₁₁ | | K 87.5 | E 91 B 111.5 A 140 I |
| C₂H₅—CO— | —NHOC—C₃H₇ | | K 233 | S 225 I |
| C₂H₅—OOC— | —COO—C₂H₅ | | K 114 | X <? U |
| CH₃—OOC— | —OOC—C₄H₉ | | K 86.5 | S 112 L 116 I |
| C₂H₅—OOC— | —OOC—C₄H₉ | | K 96 | L 100 I |
| C₃H₇—OOC— | —OOC—C₄H₉ | | K 59.8 | B 63.3 A 81 I |
| C₄H₉—OOC— | —OOC—C₄H₉ | | K 80.3 | S 63.4 L 69.4 A 74.4 I |
| C₅H₁₁—OOC— | —OOC—C₄H₉ | | K 49.7 | S 52.8 L 55.4 A 70.2 I |
| C₆H₁₃—OOC— | —OOC—C₄H₉ | | K 49.1 | L 58.7 A 68.4 I |
| C₇H₁₅—OOC— | —OOC—C₄H₉ | | K 47.3 | L 52.8 A 66.8 I |
| C₇H₁₅—OOC— | —OOC—C₅H₁₁ | | K 50 | B 80.5 A 83 I |
| C₇H₁₅—OOC— | —OOC—C₇H₁₅ | | K 57 | B 76.5 A 79 I |
| C₈H₁₇—OOC— | —OOC—C₄H₉ | | K 61.4 | L 52.3 A 68.6 I |
| C₈H₁₇—OOC— | —OOC—C₇H₁₅ | | K 52 | B 70.5 A 76 I |
| C₈H₁₇—OOC— | —OOC—C₉H₁₉ | | K 49 | B 82 A 85 I |
| C₉H₁₉—OOC— | —OOC—C₄H₉ | | K 49.5 | B 48.4 A 51.8 I |
| C₁₀H₂₁—OOC— | —OOC—C₄H₉ | | K 68.4 | A 60.2 I |
| C₁₀H₂₁—OOC— | —OOC—C₅H₁₁ | | K 55 | B 65 A 58 I |
| C₁₀H₂₁—OOC— | —OOC—C₉H₁₉ | | K 82.5 | B 77.5 A 81 I |
| C₁₁H₂₃—OOC— | —OOC—C₄H₉ | | K 59.5 | A 82.8 I |
| C₈H₁₇—COO— | —COO—CH₂—CHMe—O—CH₃ | 1 | K 49.6 | A 48.3 I |
| C₈H₁₇—COO— | —COO—CH₂—CHMe—O—C₃H₇ | 1 | K 28 | I* 21.1 A 44.2 I |
| C₈H₁₇—COO— | —COO—CH₂—CHMe—O—C₆H₁₃ | 1 | K 7 | A 39.7 I |
| C₉H₁₉—COO— | —COO—CH₂CHMe—O—CH₃ | 1 | K 35.8 | A 52.8 I |
| C₉H₁₉—COO— | —COO—CH₂—CHMe—O—C₃H₇ | 1 | K 33.1 | I* 28 A 50 I |
| C₉H₁₉—COO— | —COO—CH₂—CHMe—O—C₆H₁₃ | 1 | K 35.7 | A 44.4 I |
| C₁₀H₂₁—COO— | —COO—CH₂—CHMe—O—CH₃ | 1 | K 53 | A 54.4 I |
| C₁₀H₂₁—COO— | —COO—CH₂—CHMe—O—C₃H₇ | 1 | K 39.8 | I* 32.1 A 49.6 I |
| C₁₀H₂₁—COO— | —COO—CH₂—CHMe—O—C₆H₁₃ | 1 | K 38.9 | A 46.3 I |
| C₁₁H₂₃—COO— | —COO—CH₂—CHMe—O—CH₃ | 1 | K 47 | A 58 I |
| C₁₁H₂₃—COO— | —COO—CH₂CHMe—O—C₃H₇ | 1 | K 47 | A 58 I |
| C₁₁H₂₃—COO— | —COO—CH₂—CHMe—O—C₆H₁₃ | 1 | K 47.1 | A 48.4 I |
| C₁₃H₂₇—COO— | —COO—CH₂—CHMe—O—C₃H₇ | 1 | K 58.2 | A 60.4 I |
| CH₃—COO— | —OOC—CH₃ | | K 163 | X <? I |
| C₅H₁₁—COO— | —OOC—C₅H₁₁ | | K 117 | S 118 I |
| C₆H₁₃—COO— | —OOC—C₆H₁₃ | | K 105 | S 118 I |
| C₇H₁₅—COO— | —OOC—C₇H₁₅ | | K 95 | S 122 I |
| C₈H₁₇—COO— | —OOC—C₈H₁₇ | | K 95 | S 121 I |
| C₉H₁₉—COO— | —OOC—C₉H₁₉ | | K 98 | S 122 I |
| C₅H₁₁—COO— | —OOC—CHMe—CHMe—O—CH₃ | 1 | K 47 | C* 55 I |
| C₆H₁₃—COO— | —OOC—CHMe—CHMe—O—CH₃ | 1 | K 23 | S 31 C* 39 I |
| C₇H₁₅—COO— | —OOC—CHMe—CHMe—O—CH₃ | 1 | K 37 | C* 46 I |
| C₈H₁₇—COO— | —OOC—CHMe—CHMe—O—CH₃ | 1 | K 38 | C* 47 I |
| C₈H₁₇—COO— | —OOC—CHMe—CHMe—O—C₄H₉ | 1 | K 47 | S 49 C* 56 I |
| CH₃—OCOO— | —OCOO—CH₃ | | K 148 | X <? I |
| C₂H₅—OCOO— | —OCOO—C₂H₅ | | K 96 | X <? I |
| C₄H₉—COO—N═CMe— | —CMe═N—OOC—C₄H₉ | | K 111 | A 121 I |
| C₈H₁₇—COO—N═CMe— | —CMe═N—OOC—C₈H₁₇ | | K 104 | A 132 I |
| C₈H₁₇— | —O—CHMe—C₆H₁₃ | 1 | K ? | I |
| C₇H₁₅— | —OOC—CHMe—C₂H₅ | 1 | K 28.5 | S 57.3 I |
| C₉H₁₉—O— | —C₂H₄—COO—CHMe—C₆H₁₃ | 1 | K 72.4 | N* 145.9 U |
| C₁₂H₂₅—O— | —CO—CHMe—C₃H₇ | 2 | K 47 | A 49 I |
| C₆H₁₃—O— | —COO—CHMe—C₂H₅ | 1 | K 43 | A 38 U |
| C₈H₁₇—O— | —COO—CHMe—C₂H₅ | S | K 64.5 | C* 30 A 53 I |
| C₉H₁₉—O— | —COO—CHMe—C₆H₁₃ | 1 | K ? | C* ? N* ? U |
| C₈H₁₇—O— | —COO—CHMe—CH₃ | | K 75 | C 41 A 69 I |
| C₈H₁₇—O— | —COO—CHMe—C₂H₅ | 2 | K 67 | C 31 A 50 I |
| C₈H₁₇—O— | —COO—CHMe—C₃H₇ | 2 | K 43 | C 26 A 36 I |
| C₈H₁₇—O— | —COO—CHMe—C₄H₉ | 2 | K 49 | A 34 E |
| C₈H₁₇—O— | —COO—CHMe—C₅H₁₁ | 2 | K 61 | A 30 E |
| C₈H₁₇—O— | —COO—CHMe—C₆H₁₃ | 2 | K 57 | A 37 E |
| C₈H₁₇—O— | —COO—CHMe—C₇H₁₅ | 2 | K 61 | A 37 E |
| C₆H₁₃—O— | —COO—CH₂—CHCl—CHMe—CH₃ | 1 | K 46 | C* 15 A 15 U |
| C₈H₁₇—O— | —COO—CH₂—CHCl—CHMe—CH₃ | 1 | K 34 | C* 34 A 54 I |
| C₉H₁₉—O— | —COO—CH₂—CHCl—CHMe—CH₃ | 1 | K 39 | C* 44 A 58 I |
| C₁₀H₂₁—O— | —COO—CH₂—CHCl—CHMe—CH₃ | 1 | K 36 | C* 45 A 58 I |
| C₁₁H₂₃—O— | —COO—CH₂—CHCl—CHMe—CH₃ | 1 | K 55 | C* 49 A 60 I |
| C₁₂H₂₅—O— | —COO—CH₂—CHCl—CHMe—CH₃ | 1 | K 52 | C* 47 A 61 I |
| C₁₃H₂₇—O— | —COO—CH₂—CHCl—CHMe—CH₃ | 1 | K 57 | A 61 I |
| C₆H₁₃—O— | —COO—CH₂—CHCl—CHMe—C₂H₅ | 3 | K 31 | C* 10 A 40 I |
| C₇H₁₅—O— | —COO—CH₂—CHCl—CHMe—C₂H₅ | 3 | K 75 | C* 39 A 56 I |
| C₈H₁₇—O— | —COO—CH₂—CHCl—CHMe—C₂H₅ | 3 | K 15 | S 16 C* 32 A 50 I |
| C₉H₁₉—O— | —COO—CH₂—CHCl—CHMe—C₂H₅ | 3 | K 27 | C* 40 A 53 I |
| C₁₀H₂₁—O— | —COO—CH₂—CHCl—CHMe—C₂H₅ | 3 | K 39 | C* 41 A 54 I |
| C₁₁H₂₃—O— | —COO—CH₂—CHCl—CHMe—C₂H₅ | 3 | K 35 | C* 42 A 55 I |
| C₁₂H₂₅—O— | —COO—CH₂—CHCl—CHMe—C₂H₅ | 3 | K 40 | C* 43 A 57 I |
| C₁₃H₂₇—O— | —COO—CH₂—CHCl—CHMe—C₂H₅ | 3 | K 45 | C* 47 A 60 I |
| C₈H₁₇—O— | —COO—CHMe—COO—CHMe—C₆H₁₃ | 3 | K 42 | A 21 I |
| C₈H₁₇—O— | —OOC—CHMe—C₂H₅ | 1 | K 69.4 | C* 84.4 I |
| C₁₀H₂₁—O— | —OOC—CHMe—C₂H₅ | S | K 74.8 | H 75.8 C* 79.4 A 83.2 I |
| C₁₁H₂₃—O— | —OOC—CHMe—C₂H₅ | 1 | K 70 | C* 72 I |
| C₁₂H₂₅—O— | —OOC—CHMe—C₂H₅ | 1 | K 68 | C* 69 I |
| C₁₄H₂₉—O— | —OOC—CHMe—C₂H₅ | 1 | K 84 | A 81.4 I |
| C₇H₁₅—O— | —OOC—CHF—CHMe—CH₃ | S | K 89 | S 105 A 107 I |
| C₈H₁₇—O— | —OOC—CHF—CHMe—CH₃ | S | K 95 | S 103 N* 109 I |
| C₈H₁₇—O— | —OOC—CHF—CHMe—C₂H₅ | 3 | K ? | C* ? I |
| C₁₀H₂₁—O— | —OOC—CHF—CHMe—C₂H₅ | 3 | K ? | I |
| C₁₂H₂₅—O— | —OOC—CHF—CHMe—C₂H₅ | 3 | K 61 | A 72 I |
| C₈H₁₇—O— | —OOC—CHF—CHMe—C₂H₅ | 5 | K 84 | C* 86 A 94 I |
| C₁₂H₂₅—O— | —OOC—CHF—CHMe—C₂H₅ | 5 | K 71 | C* 81 A 93 I |
| C₆H₁₃—O— | —OOC—CHCl—CHMe—CH₃ | 1 | K ? | G* 77.6 A 83.3 I |
| C₇H₁₅—O— | —OOC—CHCl—CHMe—CH₃ | 1 | K 72 | H 64 G* 71 C* 73 A 81.5 I |
| C₈H₁₇—O— | —OOC—CHCl—CHMe—CH₃ | 1 | K 76 | S 66 C* 71 A 83 I |
| C₈H₁₇—COO— | —COO—CHMe—C₃H₇ | 1 | K 46.2 | A 38.4 I |
| C₈H₁₇—COO— | —COO—CHMe—C₄H₉ | 1 | K 29.6 | A 32.6 I |
| C₈H₁₇—COO— | —COO—CHMe—C₅H₁₁ | 1 | K 37 | A 31.9 I |
| C₈H₁₇—COO— | —COO—CHMe—C₆H₁₃ | 1 | K 34.3 | A 26.3 I |
| C₈H₁₇—COO— | —COO—CHMe—C₇H₁₅ | 1 | K 34 | A 26 I |
| C₉H₁₉—COO— | —COO—CHMe—C₂H₅ | R | K 31.3 | J* 21.1 C* 35.2 A 48.9 I |
| C₁₀H₂₁—COO— | —COO—CHMe—C₂H₅ | R | K 44.6 | J* 31.1 C* 36.9 A 48.5 I |
| C₁₁H₂₃—COO— | —COO—CHMe—C₂H₅ | R | K 41.2 | J* 38.6 C* 41.2 A 50.5 I |
| C₁₂H₂₅—COO— | —COO—CHMe—C₂H₅ | R | K 43.5 | J* 41.3 A 50 I |
| C₁₃H₂₇—COO— | —COO—CHMe—C₂H₅ | R | K 49.8 | J* 46.7 A 52.7 I |
| C₆H₁₃—COO— | —COO—CH₂—CHCl—CHMe—CH₃ | 1 | K 46 | C* 15 A 45 I |
| C₈H₁₇—COO— | —COO—CH₂—CHCl—CHMe—CH₃ | 1 | K 37 | I* 10 C* 40 A 54 I |
| C₉H₁₉—COO— | —COO—CH₂—CHCl—CHMe—CH₃ | 1 | K ? | C* ? I |
| C₁₀H₂₁—COO— | —COO—CH₂—CHCl—CHMe—CH₃ | 1 | K 36 | C* 45 A 58 I |
| C₆H₁₃—COO— | —COO—CH₂—CHCl—CHMe—C₂H₅ | 3 | K 31 | C* 10 A 40 I |
| C₈H₁₇—COO— | —COO—CH₂—CHCl—CHMe—C₂H₅ | 3 | K 36 | S 13 C* 36 A 49 I |
| C₁₀H₂₁—COO— | —COO—CH₂—CHCl—CHMe—C₂H₅ | 3 | K 36 | C* 41 A 52 I |
| C₈H₁₇—COO— | —COO—CH₂—CHCl—CHMe—C₂H₅ | 5 | K 6 | C* 37 A 47 I |
| C₈H₁₇—COO— | —COO—CH₂—CH(OMe)—CHMe—CH₃ | R | K 25 | S 10 C* 19 A 39 I |
| C₈H₁₇—COO— | —COO—CH₂—CH(OMe)—CHMe—C₂H₅ | 3 | K 38 | C* 18 A 37 I |
| C₈H₁₇—COO— | —OOC—CHCl—CHMe—CH₃ | 1 | K 66 | S 85 C* 95 I |
| C₉H₁₉—COO— | —OOC—CHCl—CHMe—CH₃ | 1 | K 68 | S 82 C* 91 A 92 I |
| C₆H₁₃—COO— | —OOC—CHCl—CHMe—C₂H₅ | 3 | K 36 | S 51 C* 67 I |
| C₇H₁₅—COO— | —OOC—CHCl—CHMe—C₂H₅ | 3 | K ? | C* ? I |
| C₈H₁₇—COO— | —OOC—CHCl—CHMe—C₂H₅ | 3 | K 41 | S 49 C* 71 I |
| C₁₀H₂₁—COO— | —OOC—CHCl—CHMe—C₂H₅ | 3 | K 48 | S 53 C* 80 I |
| C₆H₁₃—COO— | —OCOO—CH₂—CHCl—CHMe—C₂H₅ | 3 | K 53 | S 49 I |
| C₈H₁₇—COO— | —OCOO—CH₂—CHCl—CHMe—C₂H₅ | 3 | K 48 | S 46 C* 53 I |
| C₉H₁₈—COO— | —OCOO—CH₂—CHCl—CHMe—C₂H₅ | 3 | K 54 | S 54 C* 56 I |
| C₈H₁₇—OCOO— | —CO—CHMe—C₂H₅ | S | K 47.3 | A 41.6 I |
| CH₃—OCOO— | —COO—CHMe—C₆H₁₃ | 1 | K <20 | I |
| C₉H₁₉—OCOO— | —COO—CH₂—CHCl—CHMe—CH₃ | 1 | K 66 | C* 36 I |
| C₉H₁₉—OCOO— | —OOC—CHCl—CHMe—CH₃ | 1 | K 50 | I* 55 C* 58 I |
| C₈H₁₇—OCOO— | —OOC—CHCl—CHMe—C₂H₅ | 3 | K 29 | C* 29 A 41 I |
| C₉H₁₉—OCOO— | —OOC—CHCl—CHMe—C₂H₅ | 3 | K 25 | I* 27 C* 43 I |
| C₈H₁₇—OCOO— | —OOC—CHCl—CHMe—C₂H₅ | 5 | K 22 | I* 25 C* 37 I |
| C₉H₁₉—OCOO— | —OOC—CHCl—CHMe—C₂H₅ | 5 | K 15 | I* 25 C* 39 I |
| C₈H₁₇— | —CO—CH═CH—COO—CH₂—CHMe—CH₃ | | K 68.5 | N 43 I |
| C₇H₁₅— | —OOC—CH₂—CHMe—C₂H₅ | S | K 40.4 | S 68.7 I |
| C₈H₁₇—O— | —O—CH₂—CHMe—C₂H₅ | S | K 70.2 | S 83.7 H 86 I |
| C₁₀H₂₁—O— | —O—CH₂—CHMe—C₂H₅ | S | K 78 | H 78.3 C* 80.3 I |
| C₁₂H₂₅—O— | —O—CH₂—CHMe—C₂H₅ | S | K 75.3 | S 73.9 H 77.4 C* 78.9 A 79.8 I |
| C₈H₁₇—O— | —CO—CH₂—CHMe—C₂H₅ | S | K 70.4 | C* 68.3 A 98.3 I |
| C₁₂H₂₅—O— | —CO—CH₂—CHMe—C₂H₅ | 2 | K 74 | A 86 I |
| C₄H₉—O— | —COO—CH₂—CHMe—C₂H₅ | S | K 55.5 | S 73.8 I |
| C₅H₁₁—O— | —COO—CH₂—CHMe—C₂H₅ | S | K 57.5 | A 85.3 I |
| C₆H₁₃—O— | —COO—CH₂—CHMe—C₂H₅ | S | K 48 | A 66 I |
| C₇H₁₅—O— | —COO—CH₂—CHMe—C₂H₅ | S | K 41.5 | C* 43 A 64.2 I |
| C₈H₁₇—O— | —COO—CH₂—CHMe—C₂H₅ | S | K 49.2 | C* 44 A 65.9 I |
| C₉H₁₉—O— | —COO—CH₂—CHMe—C₂H₅ | S | K 60 | C* 38 A 64.4 I |
| C₁₀H₂₁—O— | —COO—CH₂—CHMe—C₂H₅ | S | K 48.2 | C* 41.2 A 66.2 I |
| C₁₁H₂₃—O— | —COO—CH₂—CHMe—C₂H₅ | S | K 40 | C* 50 A 63 U |
| C₁₂H₂₅—O— | —COO—CH₂—CHMe—C₂H₅ | S | K 53.2 | C* 39 A 63.8 I |
| C₁₃H₂₇—O— | —COO—CH₂—CHMe—C₂H₅ | S | K 50 | C* 51 A 64 U |
| C₁₄H₂₉—O— | —COO—CH₂—CHMe—C₂H₅ | S | K 61.1 | A 61.7 I |
| C₆H₁₃—O— | —COO—CH₂—CHCl—CH₂—CHMe—CH₃ | 1 | K 36 | C* 4 A 30 I |
| C₈H₁₇—O— | —COO—CH₂—CHCl—CH₂—CHMe—CH₃ | 1 | K 35 | S 0 C* 30 A 40 I |
| C₉H₁₉—O— | —COO—CH₂—CHCl—CH₂—CHMe—CH₃ | 1 | K 50 | C* 36 A 45 I |
| C₁₀H₂₁—O— | —COO—CH₂—CHCl—CH₂—CHMe—CH₃ | 1 | K 28 | C* 40 A 47 I |
| C₁₁H₂₃—O— | —COO—CH₂—CHCl—CH₂—CHMe—CH₃ | 1 | K 35 | A 47 I |
| C₁₂H₂₅—O— | —COO—CH₂—CHCl—CH₂—CHMe—CH₃ | 1 | K 48 | C* 42 A 48 I |
| C₈H₁₇—O— | —OOC—CH₂—CHMe—C₂H₅ | S | K 56.2 | S 91.8 C* 94.8 I |
| C₁₀H₂₁—O— | —OOC—CH₂—CHMe—C₂H₅ | S | K 65.7 | H 63.4 C* 83.9 A 99.8 I |
| C₁₄H₂₉—O— | —OOC—CH₂—CHMe—C₂H₅ | S | K 77.5 | C* 83.4 A 89.5 I |
| C₅H₁₁—O— | —OOC—CHCl—CH₂—CHMe—CH₃ | 1 | K ? | E 62.9 L 71.3 A 74.5 I |
| C₆H₁₃—O— | —OOC—CHCl—CH₂—CHMe—CH₃ | 1 | K 71 | C* 65 A 74 I |
| C₇H₁₅—O— | —OOC—CHCl—CH₂—CHMe—CH₃ | 1 | K 54 | C* 57 A 67.5 I |
| C₈H₁₇—O— | —OOC—CHCl—CH₂—CHMe—CH₃ | 1 | K 64 | C* 56.5 A 67 I |
| C₉H₁₉—O— | —OOC—CHCl—CH₂—CHMe—CH₃ | 1 | K 67 | C* 54 A 66.5 I |
| C₂H₅—OOC— | —OOC—CHMe—O—CH₂—CHMe—C₂H₅ | 3 | K ? | I |
| C₇H₁₅—COO— | —CH₂—CHMe—C₂H₅ | S | K 30 | B 66 I |
| C₄H₉—COO— | —O—CH₂—CHMe—C₂H₅ | S | K 86 | B 85 I |
| C₉H₁₉—COO— | —O—CH₂—CHMe—C₂H₅ | 1 | K ? | B 117 I |
| C₆H₁₃—COO— | —COO—CH₂—CHMe—C₂H₅ | S | K 22.4 | C* 18.4 A 51.9 I |
| C₇H₁₅—COO— | —COO—CH₂—CHMe—C₂H₅ | S | K 33.7 | C* 33.1 A 57.1 I |
| C₈H₁₇—COO— | —COO—CH₂—CHMe—C₂H₅ | S | K 35.9 | C* 41.8 A 59.7 I |
| C₉H₁₉—COO— | —COO—CH₂—CHMe—C₂H₅ | S | K 34.2 | C* 47.4 A 61.6 I |
| C₁₀H₂₁—COO— | —COO—CH₂—CHMe—C₂H₅ | S | K 43.9 | C* 49.6 A 62.3 I |
| C₁₁H₂₃—COO— | —COO—CH₂—CHMe—C₂H₅ | S | K 45 | C* 50.4 A 63.8 I |
| C₁₂H₂₅—COO— | —COO—CH₂—CHMe—C₂H₅ | S | K 41.2 | C* 50.5 A 63.6 I |
| C₁₃H₂₇—COO— | —COO—CH₂—CHMe—C₂H₅ | S | K 52.9 | C* 51.1 A 64.8 I |
| C₁₅H₃₁—COO— | —COO—CH₂—CHMe—C₂H₅ | S | K 60.9 | A 64.2 I |
| C₆H₁₃—COO— | —COO—CH₂—CHCl—CH₂—CHMe—CH₃ | 1 | K 34 | C* 4 A 30 I |
| C₈H₁₇—COO— | —COO—CH₂—CHCl—CH₂—CHMe—CH₃ | 1 | K 35 | S 0 C* 30 A 40 I |
| C₁₀H₂₁—COO— | —COO—CH₂—CHCl—CH₂—CHMe—CH₃ | 1 | K 28 | C* 40 A 46 I |
| C₈H₁₇—COO— | —COO—CH₂—CH(OMe)—CH₂—CHMe—CH₃ | 1 | K 31.7 | A 31.7 I |
| C₉H₁₉—COO— | —COO—CH₂—CH(OMe)—CH₂—CHMe—CH₃ | 1 | K 38.2 | A 37.2 I |
| C₁₀H₂₁—COO— | —COO—CH₂—CH(OMe)—CH₂—CHMe—CH₃ | 1 | K 41.5 | A 43.4 I |
| C₁₂H₂₅—COO— | —COO—CH₂—CH(OMe)—CH₂—CHMe—CH₃ | 1 | K 51.7 | A 39.8 E |
| C₈H₁₇—COO— | —OOC—CHCl—CH₂—CHMe—CH₃ | 1 | K 55 | S 55 C* 68 A 70 I |
| C₉H₁₉—COO— | —OOC—CHCl—CH₂—CHMe—CH₃ | 1 | K 54 | S 55 C* 68 A 71 I |
| C₈H₁₇—OCOO— | —CH₂—CHMe—C₂H₅ | S | K 36.8 | C* 24.5 N* 27 I |
| C₆H₁₃—OCOO— | —O—CH₂—CHMe—C₂H₅ | S | K 49 | C* 48 I |
| C₈H₁₇—OCOO— | —O—CH₂—CHMe—C₂H₅ | S | K 55 | C* 47 N* 49.5 I |
| C₉H₁₉—OCOO— | —O—CH₂—CHMe—C₂H₅ | S | K 59 | C* 46 N* 49 I |
| C₈H₁₇—OCOO— | —OOC—CHCl—CH₂—CHMe—CH₃ | 1 | K 20 | I* 22 C* 34 I |
| C₉H₁₉—OCOO— | —OOC—CHCl—CH₂—CHMe—CH₃ | 1 | K 0 | I* 21 C* 35 I |
| C₇H₁₅—O— | —C₂H₄—CHMe—C₂H₅ | S | K 14.1 | S 54 S 64.9 I |
| C₈H₁₇—O— | —C₂H₄—CHMe—C₂H₅ | S | K 43 | S 57.9 H 62.5 C* 65.1 I |
| C₉H₁₉—O— | —C₂H₄—CHMe—C₂H₅ | S | K 58.4 | S 49.9 H 59 C* 62.7 A 63.5 I |
| C₁₀H₂₁—O— | —C₂H₄—CHMe—C₂H₅ | S | K 47.3 | S 51 H 53.6 C* 58.9 A 82.9 I |
| C₁₂H₂₅—O— | —CO—C₂H₄—CHMe—CH₃ | | K 98 | A 113 I |
| C₈H₁₇—O— | —COO—C₂H₄—CHMe—C₂H₅ | S | K 59 | C* 58 A 72 I |
| C₉H₁₉—O— | —COO—C₂H₄—CHMe—C₂H₅ | 1 | K 41 | S 45 C* 53 A 67 U |
| C₁₀H₂₁—O— | —COO—C₂H₄—CHMe—C₂H₅ | 1 | K 45 | S 53 C* 67 A 74 I |
| C₈H₁₇—O— | —OOC—C₂H₄—CHMe—C₂H₅ | 1 | K ? | G* 92.5 A 93 I |
| C₈H₁₇—CO— | —OOC—C₂H₄—CHMe—C₂H₅ | 1 | K 74.2 | A 112 U |
| C₉H₁₉—CO— | —OOC—C₂—H₄CHMe—C₂H₅ | 1 | K ? | S 68 C* 99.8 A 114.2 U |
| C₈H₁₇—O— | —COO—C₂H₅—CHMe—C₂H₅ | 1 | K 38 | G* 62.2 A 68 I |
| C₈H₁₇—O— | —COO—C₂H₄—CHMe—C₂H₄—CHMe—CH₃ | 1 | K 45 | C* 48 A 58 I |
| C₉H₁₈—O— | —COO—C₂H₄—CHMe—C₃H₆—CHMe—CH₃ | 1 | K 53 | A 54 I |
| C₁₂H₂₅—O— | —COO—C₂H₄—CHMe—C₃H₆—CHMe—CH₃ | S | K 50 | C* 47 A 53 I |
| C₇H₁₅—COO— | —COO—C₂H₄—CHMe—C₃H₆—CHMe—CH₃ | S | K 24.2 | B 41.3 A 65.7 I |
| C₈H₁₇—COO— | —COO—C₂H₄—CHMe—C₃H₆—CHMe—CH₃ | S | K 36.6 | J* 38.5 C* 43.9 A 55 I |
| C₉H₁₉—COO— | —COO—C₂H₄—CHMe—C₃H₆—CHMe—CH₃ | S | K 40.9 | J* 39.8 C* 51.5 A 56.4 I |
| C₁₀H₂₁—COO— | —COO—C₂H₄—CHMe—C₃H₆—CHMe—CH₃ | S | K 45.3 | J* 42.9 C* 53.5 A 56.9 I |
| C₁₁H₂₃—COO— | —COO—C₂H₄—CHMe—C₃H₆—CHMe—CH₃ | S | K 51.2 | J* 46.6 C* 55.9 A 56.5 I |
| C₁₂H₂₅—COO— | —COO—C₂H₄—CHMe—C₃H₆—CHMe—CH₃ | S | K 57.8 | A 55.5 I |
| C₁₀H₂₁— | —O—C₄H₈—CHMe—C₃H₇ | 2 | K 22 | C 60.5 I |
| C₁₀H₂₁— | —O—C₅H₁₀—CHMe—C₂H₄ | 2 | K 26.5 | C 69.5 I |
| C₈H₁₇—O— | —OOC—CHF—C₆H₁₃ | 1 | K ? | C* ? I |
| C₅H₁₁—O— | —OOC—CHCl—C₂H₅ | 1 | K 103.5 | G* 107 I |
| C₆H₁₃—O— | —OOC—CHCl—C₂H₅ | 1 | K 96 | H 87 G* 103 A 107 I |
| C₇H₁₅—O— | —OOC—CHCl—C₂H₅ | 1 | K 91.5 | H 80 G* 92 F* 96 A 104 I |
| C₈H₁₇—O— | —OOC—CHCl—C₂H₅ | 1 | K 98 | H 71 G* 91 F* 95 A 104 I |
| C₉H₁₉—O— | —OOC—CHCl—CH₃ | S | K ? | G* <? I |
| C₉H₁₉—O— | —OOC—CHCl—C₂H₅ | 1 | K 100 | G* 85 F* 96 A 102.5 I |
| C₁₀H₂₁—O— | —OOC—CHCl—C₂H₅ | 1 | K 100 | G* 82 F* 95 A 101 I |
| C₁₂H₂₅—O— | —OOC—CHCl—C₂H₅ | 1 | K 96 | G* 74 F* 95 A 100 I |
| C₉H₁₉—COO— | —OOC—CHCl—C₂H₅ | 1 | K 123 | S 132 I |
| C₈H₁₇—OCOO— | —OOC—CHCl—C₂H₅ | 1 | K 62 | I* 70 C* 80 I |
| C₈H₁₇— | —COO—CH₂—CHCl—CH₃ | 1 | K 38.5 | A 34 I |
| C₅H₁₁—O— | —COO—CH₂—CHCl—CH₃ | R | K 80 | A 92.5 I |
| C₆H₁₃—O— | —COO—CH₂—CHCl—CH₃ | R | K 73 | A 86.4 I |
| C₇H₁₅—O— | —COO—CH₂—CHCl—CH₃ | R | K 79 | A 86.7 I |
| C₈H₁₇—O— | —COO—CH₂—CHCl—CH₃ | R | K 77.5 | A 86.2 I |
| C₉H₁₉—O— | —COO—CH₂—CHCl—CH₃ | R | K 84 | A 86.7 I |
| C₁₀H₂₁—O— | —COO—CH₂—CHCl—CH₃ | R | K 82.8 | A 87 I |
| C₁₂H₂₅—O— | —COO—CH₂—CHCl—CH₃ | R | K 85.5 | A 86.1 I |
| C₁₀H₂₁—O— | —OOC—CH₂—CHCl—CH₃ | 1 | K 96 | S 95 S 108 I |
| C₈H₁₇——O— | —COO—CH₂—CHCl—CH₃ | 1 | K 61.3 | E 30.5 B 69.7 A 90.2 I |
| C₈H₁₇—COO— | —COO—CH₂—CHCl—C₂H₅ | S | K 25 | C* 22 A 56 I |
| C₉H₁₉—COO— | —COO—CH₂—CHCl—CH₃ | 1 | K 48.4 | A 80 I |
| C₈H₁₇—COO— | —COO—C₂H₄—CHCl—CH₃ | S | K 50.4 | J* 53.2 I* 53.2 A 65 I |
| C₉H₁₉—COO— | —COO—C₂H₄—CHCl—CH₃ | S | K 53.8 | J* 57.4 A 67.5 I |
| C₁₀H₂₁—COO— | —COO—C₂H₄—CHCl—CH₃ | S | K 58.4 | J* 60.3 A 68.2 I |
| C₁₁H₂₃—COO— | —COO—C₂H₄—CHCl—CH₃ | S | K 66.2 | J* 63.7 A 69.3 I |
| C₁₃H₂₇—COO— | —COO—C₂H₄—CHCl—CH₃ | S | K 70.6 | A 69.6 I |
| C₄H₉—O— | —CO—CHBr—CH₃ | 2 | K 97 | A 103 I |
| C₅H₁₁—O— | —CO—CHBr—CH₃ | 2 | K 91 | A 99 I |
| C₆H₁₃—O— | —CO—CHBr—CH₃ | 2 | K 85 | A 99 I |
| C₇H₁₅—O— | —CO—CHBr—CH₃ | 2 | K 78 | A 103 I |
| C₈H₁₇—O— | —CO—CHBr—CH₃ | 2 | K 84 | A 103 I |
| C₉H₁₉—O— | —CO—CHBr—CH₃ | 2 | K 80 | A 103 I |
| C₁₀H₂₁—O— | —CO—CHBr—CH₃ | 2 | K 71 | A 103 I |
| C₁₂H₂₅—O— | —CO—CHBr—C₃H₇ | 2 | K 95 | A 78 I |
| C₃H₇— | —CF₃ | | K 97 | N −80 E |
| C₃H₇— | —O—CF₃ | | K 92 | N −60 E |
| C₅H₁₁— | —S—CF₃ | | K 31 | N −80 E |
| C₅H₁₁— | —O—CH₂—CF₃ | | K 107 | N −30 E |
| C₅H₁₁— | —CO—CF₃ | | K 13 | N −40 E |
| C₄H₉—O— | —C₆F₁₃ | | K 86 | S 104 I |
| C₇H₁₅—O— | —CF₃ | | K 69 | B 114.5 I |
| C₈H₁₇—O— | —CF₃ | | K 115 | N −20 E |
| C₄H₉—O— | —S—CF₃ | | K 82 | N −40 E |
| C₈H₁₇—O— | —COO—CH₂—C₆F₁₃ | | K 85 | C 109 A 119 I |
| C₈H₁₇—O— | —COO—C₂H₄—C₄F₉ | | K 108 | C 112 I |
| C₈H₁₇—O— | —COO—C₂H₄—C₆F₁₃ | | K 114 | C125 A 127 I |
| C₈H₁₇—O— | —COO—C₂H₄—C₈F₁₇ | | K 122 | C 132 A 141 I |
| C₈H₁₇—O— | —COO—C₂H₄—C₁₀F₂₁ | | K 141 | A 152 I |
| CH₃—NH— | —C₆F₁₃ | | K 142 | S 168 I |
| C₂H₅—NH— | —C₆F₁₃ | | K 122 | S 174 I |
| C₃H₇—NH— | —C₆F₁₃ | | K 110 | S 134 I |
| C₄H₉—NH— | —C₃F₇ | | K 117 | S 123 I |
| C₄H₉—NH— | —C₈F₁₃ | | K 107 | S 145 I |
| C₅H₁₁—NH— | —C₃F₇ | | K 108 | S 111 I |
| C₅H₁₁—NH— | —C₆F₁₃ | | K 108 | S 133 I |
| C₈H₁₇—NH— | —C₆F₁₃ | | K 115 | S 113 I |
| C₈H₁₇—OOC— | —O—C₂H₄—C₆F₁₃ | | K ? | C ? A ? I |
| C₉H₁₉—COO— | —CF₃ | | K 63.3 | E 74 B 108.3 I |
| CH₃—CHMe—CH₂—CHCl—COO— | —O—CH₂—C₇F₁₅ | 1 | K 88 | A 98 I |
| C₂H₅—CHMe—CH₂—O— | —O—C₁₁H₂₃—OOC—CH═CH₂ | S | K 62 | A 69 I |
| C₂H₅—CHMe—CH₂—OOC— | —O—C₈H₁₆—O—CH═CH₂ | S | K 37.6 | C* 30.2 A 53.3 I |
| C₂H₅—CHMe—CH₂—OOC— | —O—C₂H₄—OOC—CH═CH₂ | S | K 53 | A 49 I |
| C₂H₅—CHMe—CH₂—OOC— | —O—C₆H₁₂—OOC—CH═CH₂ | S | K 28 | C* 13 A 36 I |
| C₂H₅—CHMe—CH₂—OOC— | —O—C₁₀H₂₀—OOC—CH═CH₂ | S | K 48 | C* 42 A 54 I |
| C₂H₅—CHMe—CH₂—OOC— | —O—C₁₂H₂₄—OOC—CH═CH₂ | S | K 54.8 | A 43.7 I |
| C₂H₅—CHMe—CH₂—OOC— | —O—C₆H₁₂—CH═CH₂ | S | K 20 | C* 29 A 53 I |
| C₂H₅—CHMe—CH₂—OOC— | —OOC—C₅H₁₀—CH═CH₂ | S | K 44.5 | C* 41.7 A ? I |
| C₂H₅—CHF—COO— | —OOC—CHF—C₂H₅ | 3 | K ? | S 162.1 S 167 I |
| C₃H₇—CHF—COO— | —OOC—CHF—C₃H₇ | 3 | K 102.4 | S 131.5 I |
| C₆H₁₃—CHF—CH₂—O— | —O—C₄H₈—C₄F₉ | 1 | K ? | S 47 S 87 S 91 S 97 C* 112 A 130 I |
| CH₃—CHCl—COO— | —OOC—CHCl—CH₃ | 3 | K 132.7 | S 182.4 S 163.3 I |
| C₂H₅—CHCl—COO— | —OOC—CHCl—C₂H₅ | 3 | K 82.8 | S 83 S 102.2 I |
| CH₃—CHCl—COO— | —O—C₄H₉—CH═CH₂ | 1 | K 99 | E 112.5 B 118 I |
| CH₃—CHCl—COO— | —O—C₉H₁₈—CH═CH₂ | 1 | K 112 | A 108 I |
| C₈F₁₇—C₁₁H₂₂—O— | —COO—CH₂—CF₃ | | K 95 | S 82 A 113 I |
| C₈F₁₇—C₁₁H₂₂—O— | —COO—CH₂—C₇F₁₅ | | K 103 | C 115 I |
| H₂C═CH—CH₂—OOC—C₅H₁₀—O— | —COO—C₅H₁₀—O—CH₂—CH═CH₂ | | K 78 | I |
| H₂C═CH—C₄H₉—O— | —O—C₄H₈—CH═CH₂ | | K 51.2 | S 119.5 I |
| C₅H₁₁—C:::C— | —C:::C—C₅H₁₁ | | K 67.5 | S 86 I |
| C₇H₁₅—C:::C— | —C:::C—C₇H₁₅ | | K ? | S 73 I |
| CH₃—OOC— | —O—C₉H₁₈—CH═CH₂ | | K 95 | E 118 I |
| CH₃—OOC— | —OOC—C₈H₁₈—CH═CH₂ | | K 82 | I |
| C₂H₅—OOC—CHMe—OOC— | —O—C₈H₁₆—CH═CH₂ | 1 | K 48 | A 39 U |
| C₆H₁₃—O— | —O—C₉H₁₈—CH═CH₂ | | K 102 | S 102 S 105 I |
| C₅H₁₁— | —C:::C—H | | K 56.4 | S 82.7 I |
| C₅H₁₁— | —C:::C—CH₃ | | K 60.5 | S 83.4 I |
| CH₃—O— | —OOC—C:::C—C:::C—C₁₀H₂₁ | | K 54 | N 86 I |
| CH₃—O— | —O—C₆H₁₂—OOC—CH(—CH₂—C:::C—H)₂ | | K 75 | S 106 I |
| CH₃—O— | —OOC—C₂H₅—C:::C—H | | K 92 | N 68.1 I |
| CH₃—O— | —OOC—C₈H₁₆—C:::C—H | | K 76.7 | N 85.6 I |
| C₂H₅—CHMe—CHF—CH₂—OOC— | —O—C₁₁H₂₂—O—CH═CH₂ | 3 | K 48.5 | S 32 C* 34.7 A 54.3 I |
| C₂H₅—CHMe—CHCl—CH₂—OOC— | —O—C₂H₄—O—CH═CH₂ | 3 | K 58.2 | I |
| C₂H₅—CHMe—CHCl—CH₂—OOC— | —O—C₆H₁₂—O—CH═CH₂ | 3 | K 40 | C* 26.5 A 55 I |
| C₂H₅—CHMe—CHCl—CH₂—OOC— | —O—C₈H₁₆—O—CH═CH₂ | 3 | K 39 | C* ? A 51.3 I |
| C₂H₅—CHMe—CHCl—CH₂—OOC— | —O—C₁₁H₂₂—O—CH═CH₂ | 3 | K 41.9 | C* 21 A 38.3 I |
| C₆H₁₃—CHMe—O— | —O—CH₂—CH═CH₂ | 1 | K 77 | S 56 I |
| C₂H₅—CHMe—CHCl—COO— | —O—CH₂—CH═CH₂ | 3 | K 91 | I |
| C₂H₅—CHMe—CHCl—COO— | —O—C₆H₁₂—CH═CH₂ | 3 | K 41 | C* 35 A 51 I |
| C₂H₅—CHMe—CHCl—COO— | —O—C₉H₁₈—CH═CH₂ | 3 | K 49 | C* 33 A 52 I |
| C₂H₅—CHMe—CHCl—COO— | —O—C₉H₁₈—CH═CH₂ | 3 | K 36 | C* 48 A 58 I |
| C₂H₅—CHMe—CH₂— | —COO—CH₂—CHMe—C₂H₄ | 6 | K −4 | N* −70 E |
| C₂H₅—CHMe—CH₂— | —COO—CH₂—C₇F₁₅ | 1 | K 72 | A 101 I |
| C₂H₅—CHMe—CH₂—O— | —COO—CH₂—C₇F₁₅ | 1 | K ? | H 96 A 115 I |
| C₃H₇— | —O—CF₂—H | | K 84 | N −30 E |
| C₃H₇— | —S—CF₂—H | | K 58 | N −70 E |
| C₇H₁₅— | —SO—CF₂—H | 2 | K 72 | N −70 E |
| C₇H₁₅— | —SO₂—CF₂—H | | K 50 | N −110 E |
| C₈H₁₇—O— | —O—CF₂—H | | K 104 | N 20 E |
| C₈H₁₇—O— | —COO—CHCF₃—C₆H₁₃ | 1 | K 45.5 | E 69 A 74 I |
| C₈H₁₇—OCOO— | —OOC—CH₂—CHCF₃—C₄H₉ | 1 | K ? | S 5 S 25 I |
| C₈H₁₇—O— | —COO—C₂H₄—CHCF₃—C₄H₉ | 1 | K 42 | A 35 I |
| C₅H₁₁— | —CH═CH₂ | | K 122 | N 51.5 U |
| C₈H₁₇— | —OOC—CH═CH—C₅H₁₁ | | K 36 | E 59 B 66 N 75 I |
| CH₃—O— | —O—C₁₁H₂₂—O—CH═CH₂ | | K 95 | I |
| C₄H₉—O— | —COO—C₄H₈—OOC—CH═CH₂ | | K ? | S 55 I |
| C₈H₁₇—O— | —OOC—C₄H₈—OOC—CH═CH₂ | | K 84.1 | S 91.7 I |
| C₈H₁₇—O— | —OOC—C₂H₄—CHMe—CH₂—OOC—CH═CH₂ | 1 | K 48.7 | S 73.9 I |
| C₈H₁₇— | —O—CH₂—CH═CH—C₅H₁₁ | | K 75 | E 93 I |
| CH₃—O— | —O—C₆H₁₂—O—CH₂—CH═CH₂ | | K 101 | N 98 I |
| C₆H₁₃—O— | —O—C₆H₁₂—O—CH₂—CH═CH₂ | | K 100 | S 99 I |
| CH₃—O— | —O—C₂H₄—O—C₂H₄—O—C₂H₂—O—CH₂—CH═CH₂ | | K 73 | X 83 I |
| C₄H₉—OOC—CHMe—OOC— | —O—C₈H₁₈—O—CH₂—CH═CH₂ | 1 | K 10 | A 20 I |
| CH₃—O— | —OOC—C₃H₆—CH═CH₂ | | K 70 | N 76 I |
| C₂H₅— | —C₄H₈—CH═CH₂ | | K ? | B 26.3 I |
| C₄H₉— | —C₄H₈—CH═CH₂ | | K 24.4 | B 38.5 I |
| C₂H₅— | —C₆H₁₂—CH═CH₂ | | K 9.4 | B 28.2 I |
| C₄H₉— | —C₆H₁₂—CH═CH₂ | | K −24.6 | B 42.4 I |
| CH₃—O— | —O—C₆H₁₂—CH═CH₂ | | K 96 | E 108 I |
| C₆H₁₃—O— | —O—C₆H₁₂—CH═CH₂ | | K 113 | S 112 I |
| CH₃—OOC— | —O—C₆H₁₂—CH═CH₂ | | K 103 | E 123 S 127 I |
| CH₃—O— | —O—C₈H₁₆—CH═CH₂ | | K 81 | E 108 I |
| CH₃—O— | —OOC—C₈H₁₆-CH═CH₂ | | K 75 | N 79 I |

The liquid crystalline charge transfer materials of the present invention are useful for a variety of applications such as optical sensors, electro-luminescent elements, photoconductors, spacial optical modulators and thin-film transistors.

The liquid crystalline charge transfer materials of the present invention can attain high mobility of electric charges, and prevent the formation of structural traps. Therefore, optical sensors having high-speed responsibility can be mentioned as a primary application of these materials. Secondarily, the materials of the present invention are excellent in charge transferability, and they themselves are fluorescent, so that they can be used for charge transfer layers in electro-luminescent elements which can be produced with the mobility maintaining high. Moreover, the materials of the invention are such that orientation in an electric field and photoconductivity can be switched at the same time. Therefore, they can be used for image-displaying elements.

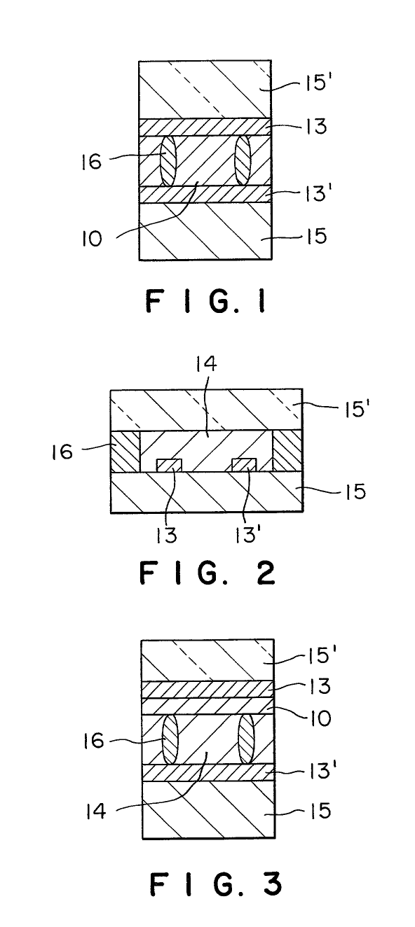

FIGS. 1 to 4 are views for illustrating typical examples of the application of the charge transfer materials of the present invention to electro-luminescent elements. The simplest structure of the elements is shown in FIG. 1, in which a luminescent layer (charge transfer layer) 10, 14 is formed as a single layer, and sandwiched between a cathode (transparent electrode) 13 provided on a transparent substrate 15′ and an anode 13′ provided on a substrate 15. Reference numeral 16 indicates a spacer. Only when the charge transfer material has both charge transferability and fluorescence like the liquid crystalline charge transfer materials of the present invention, it is possible to produce an electro-luminescent element having the above structure. In this case, in order to obtain strong luminescence, it is preferable that a material having a low work function be selected as a material for forming the cathode which acts as an electron injector and that a material having a work function which is equal to or greater than the work function of the cathode be selected for forming the anode.

Examples of materials for forming the anode generally include ITO, indium oxide, tin oxide (doped with antimony, arsenic, or fluorine), Cd₂SnO₄, zinc oxide, copper iodide, alkaline or alkaline earth metals such as sodium, potassium, magnesium and lithium, sodium-potassium alloys, magnesium-indium alloys, magnesium-silver alloys, aluminum, gold, silver, gallium, indium and copper, and those materials which are used for forming the cathode.

A material for forming the luminescent layer or charge transfer layer is composed of a charge transfer material and a luminescent material. The charge transfer material is preferably an electron-hole transfer material, a mixture of electron-hole transfer materials, or a mixture of an electron transfer material and a hole transfer material. However, in the case where luminescence at the surface of the electrode is utilized, a material which transfers only electrons or holes may also be used. Since the charge transfer materials of the present invention themselves are fluorescent, it is not necessary to use any luminescent material in the present invention; however, such a material may also be used along with the materials of the invention.

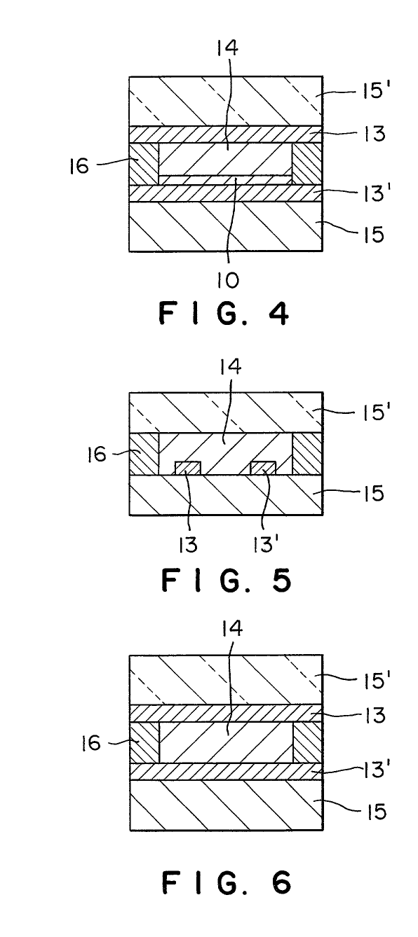

Further, in the case of an electro-luminescent element having a structure as shown in FIGS. 3 or 4, the thickness of a luminescent layer (luminescent material) 10 is so made that the transfer of electrons or holes will not be impeded. The thickness of the luminescent layer is preferably from 0.2 to 15 μm; and it can be adjusted by scattering spacer particles in the luminescent material, or by a sealer to be provided around the periphery of the cell.

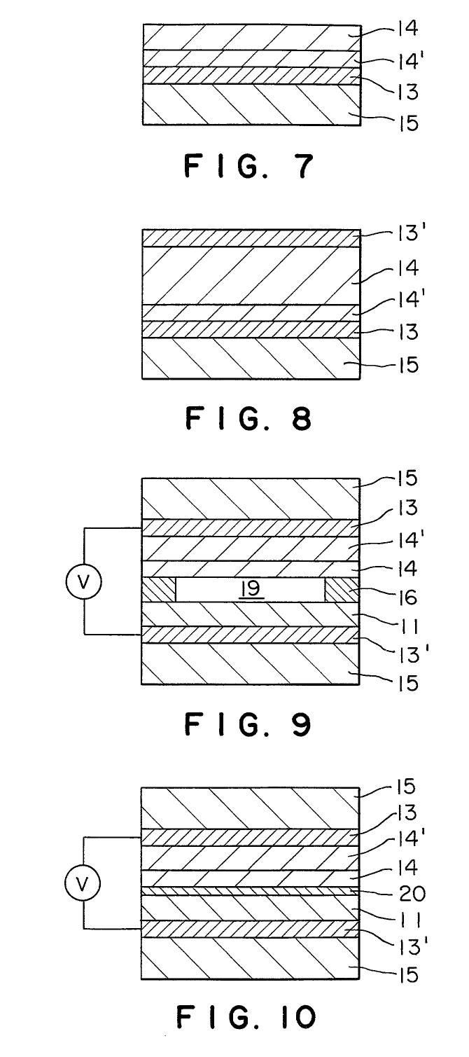

FIGS. 5 to 7 are views for illustrating typical examples of the application of the charge transfer materials of the present invention to optical sensors. An optical sensor is composed of electrodes 13, 13′, and a liquid crystalline charge transfer material 14 of the present invention. For optical sensors, such a property that the value of electric current changes when light is applied to the charge transfer materials can be utilized.

FIG. 8 is a view for illustrating a typical example of the application of the charge transfer materials of the present invention to image-displaying elements. An image-displaying element is composed of a transparent substrate 15 such as a glass plate, a transparent electrode 13 made from ITO (indium titanium oxide) or the like, a charge-generating layer 14′ which generates carriers correspondingly to light applied to this layer, a liquid crystalline charge transfer material 14 of the present invention and a counter electrode (gold electrode) 13′, which are successively laminated in the mentioned order. When light is applied image-wise (input image) to the lower part (transparent substrate) of the element, molecules in the liquid crystalline charge transfer material are oriented correspondingly to the light applied, and carriers flow toward the counter electrode (gold electrode) 13′. By optically reading this orientation of molecules in the liquid crystal, the input image can be reproduced. If the above liquid crystal is highly smectic, the orientation of molecules in the liquid crystal is maintained for a long time, and the input information can thus be maintained for a long time.

FIG. 9 is a view for illustrating an example of the application of the liquid crystalline charge transfer materials of the present invention to a charge transfer layer 14 in an image-recording device. While applying voltage to upper and lower electrodes 13 and 13′ as shown in FIG. 9, light is applied pattern-wise to the upper part of the device. In a charge-generating layer 14′, carriers are generated pattern-wise; and charges transferred by the charge transfer layer 14 are discharged in the space 19, and reach the surface of an information-recording layer 11.

The information-recording layer is a liquid crystal-polymer composite layer consisting of a smectic liquid crystal and a polymer. Molecules in the liquid crystal are oriented pattern-wise by an electric field produced by accumulated charges, and accumulated. Optical reading can thus be conducted.

FIG. 10 also shows an information-recording device. Application of voltage and that of light are conducted in the same manner as in the case of the information-recording device shown in FIG. 9. Charges generated (image) are accumulated on the upper surface of a dielectric layer 20, and optical reading can thus be conducted.

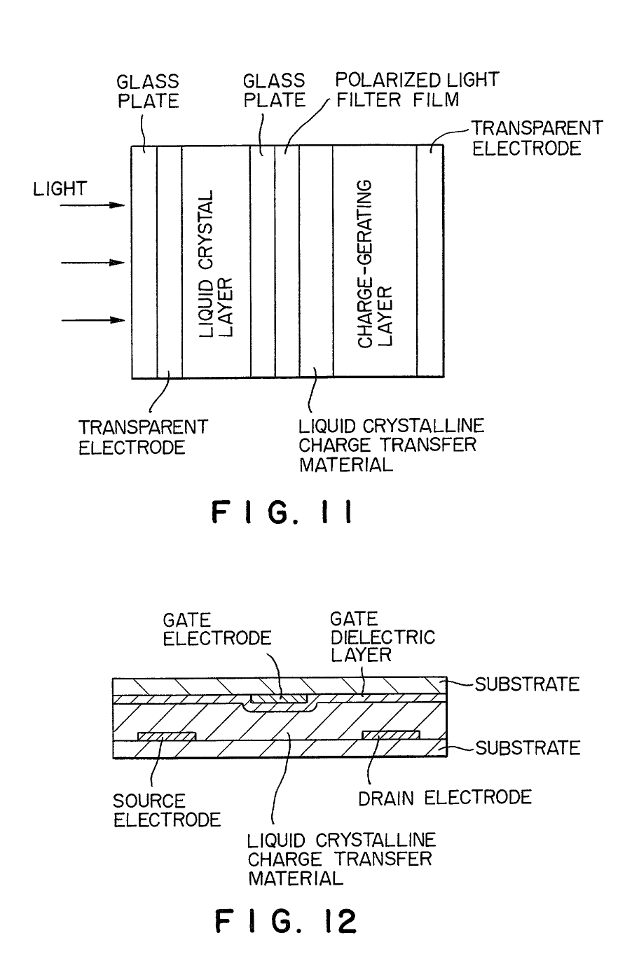

Further, the liquid crystalline charge transfer materials of the present invention can also be used for a spacial optical modulator as schematically shown in FIG. 11. Moreover, they can also be used as an active layer in a thin-film transistor. For example, as shown in FIG. 12, the above-described liquid crystalline material can be used by providing it on a substrate on which a source electrode, a drain electrode and a gate electrode have been arranged.

The present invention will now be explained more specifically by referring to the following Examples. However, the present invention is not limited by these examples.

### EXAMPLE A1

4-Heptyloxybiphenylcarbonic acid (manufactured by Teikoku Chemical Industries Co., Ltd., Japan) and 7-hydroxy-4-methylcumarin (synthesized in accordance with the description in J. Chem. Soc. Chem. Commun., (2) 225-226, 1995) were dissolved in 4-pyridinyl phenol, and dehydration condensation was then carried out at 90° C. by using 1,3-dicyclohexylcarbodiimide to synthesize 7-hydroxy-6-(4-heptyloxybiphenylcarboxy)-4-methylcumarin.

### EXAMPLE A2

Two glass substrates, each having thereon an ITO electrode (surface resistance: 100 to 200 Ω/□) formed by means of vacuum deposition were bonded with the ITO electrodes facing each other, a gap being provided between the substrates by using spacer particles, thereby obtaining a cell. Into this cell, the 7-hydroxy-6-(4-heptyloxybiphenylcarboxy)-4-methylcumarin obtained in Example A1 was injected under the condition of 110° C. When a direct current electric field of 250 V was applied to this cell, luminescence originating from the above compound was observed.

### EXAMPLE A3

A glass substrate on which an ITO electrode (surface resistance: 100 to 200 Ω/□) had been provided by means of vacuum deposition, and a glass substrate on which an Ag electrode (specific resistance: 1 Ω/cm or less, film thickness: 3,000 Å) had been provided were bonded with the electrodes facing each other, a gap being provided between the substrates by using spacer particles, thereby obtaining a cell. Into this cell, a liquid crystalline material which was the compound obtained in Example A1 was injected under the condition of 110° C. When a direct current electric field of 250 V was applied to this cell in a dark room, luminescence originating from the above liquid crystalline material was observed.

### EXAMPLE A4

A cell having the structure shown in FIG. 2 was made by using a liquid crystalline material which was the compound obtained in Example A1, where the liquid crystalline material was injected into the cell under the condition of 110° C. When a direct current electric field of 250 V was applied to this cell in a dark room, luminescence originating from the above liquid crystalline material was observed.

### EXAMPLE A5

A cell having the structure shown in FIG. 3 was made by using a liquid crystalline material which was the compound obtained in Example A1, where the liquid crystalline material was injected into the cell under the condition of 110° C. When a direct current electric field of 250 V was applied to this cell in a dark room, luminescence originating from the above liquid crystalline material was observed.

### EXAMPLE A6

A cell having the structure shown in FIG. 4 was made by using a liquid crystalline material which was the compound obtained in Example A1, where the liquid crystalline material was injected into the cell under the condition of 110° C. When a direct current electric field of 250 V was applied to this cell in a dark room, luminescence originating from the above liquid crystalline material was observed.

### EXAMPLE B1

Two glass substrates, each having thereon an ITO electrode (surface resistance: 100 to 200 Ω/□) formed by means of vacuum deposition were bonded with the ITO electrodes facing each other, a gap being provided between the substrates by using spacer particles, thereby obtaining a cell. Into this cell, benzthiazole liquid crystal (2-(4′-heptyloxyphenyl)-6-dodecylbenzothiazole, Crystal-90° C.-SmA-100° C.-Iso.) was injected under the condition of 110° C. When a direct current electric field of 250 V was applied to this cell, luminescence originating from the above compound was observed.

### EXAMPLE B2

A glass substrate on which an ITO electrode (surface resistance: 100 to 200 Ω/□) had been provided by means of vacuum deposition, and a glass substrate on which an Ag electrode (specific resistance: 1 □/cm or less, film thickness: 3,000 Å) had been provided were bonded with the electrodes facing each other, a gap being provided between the substrates by using spacer particles, thereby obtaining a cell. Into this cell, a liquid crystalline material which was the compound obtained in Example B1 was injected under the condition of 110° C. When a direct current electric field of 250 V was applied to this cell in a dark room, luminescence originating from the above liquid crystalline material was observed.

### EXAMPLE B3

A cell having the structure shown in FIG. 2 was made by using a liquid crystalline material which was the compound obtained in Example B1, where the liquid crystalline material was injected into the cell under the condition of 110° C. When a direct current electric field of 250 V was applied to this cell in a dark room, luminescence originating from the above liquid crystalline material was observed.

### EXAMPLE B4

A cell having the structure shown in FIG. 3 was made by using a liquid crystalline material which was the compound obtained in Example B1, where the liquid crystalline material was injected into the cell under the condition of 110° C. When a direct current electric field of 250 V was applied to this cell in a dark room, luminescence originating from the above liquid crystalline material was observed.

### EXAMPLE B5

A cell having the structure shown in FIG. 4 was made by using a liquid crystalline material which was the compound obtained in Example B1, where the liquid crystalline material was injected into the cell under the condition of 110° C. When a direct current electric field of 250 V was applied to this cell in a dark room, luminescence originating from the above liquid crystalline material was observed.

1. A liquid crystalline charge transfer material having the following structure (A) containing a fluorescent skeletal structure Y, and the core Z of a liquid crystal: 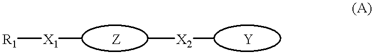
in which R₁, which may directly be combined with Z without interposing X₁, represents a saturated or unsaturated, and linear, branched or cyclic hydrocarbon group having 1 to 22 carbon atoms; and X₁ and X₂ represent oxygen atom, sulfur atom, or —CO—, —OCO—, —COO—, —N═CH—, —CONH—, —NH—, —NHCO— or —CH₂— group.

2. The liquid crystalline charge transfer material according to claim 1, wherein Z has a structure represented by Z₁ or Z₁-Z₂-Z₃, in which Z₁ and Z₃ are (6π electron system aromatic ring)₁, (10π electron system aromatic ring)ₘ or (14π electron system aromatic ring)ₙ (where 1, m and n are an integer of 0 to 4, provided that 1+m+ n=1 to 4), and Z2 is —CH═CH—, —C≡C—, —N═N—, —CH═N— or —COO— group, or Z₁ and Z₃ are directly combined with each other.

3. The liquid crystalline charge transfer material according to claim 1, wherein Y is selected from radicals of metal chelate compounds, polycyclically condensed or conjugated aromatic hydrocarbons, diphenylethylene derivatives, triphenylamine derivatives, diaminocarbazole derivatives, bisstyryl derivatives, benzothiazole derivatives, benzoxazole derivatives, aromatic diamine derivatives, quinacridone compounds, perylene compounds, oxadiazole derivatives, cumarin compounds and anthracene derivatives.

4. An electro-luminescent element containing in its driving path at least one material set forth in claim 1.

5. An electro-luminescent element whose charge transfer part and luminescent part are made from at least one material set forth in claim 1.

6. An electro-luminescent element which contains in its driving path at least one material set forth in claim 1 and whose charge transfer part and luminescent part are composed of a single layer.

7. An optical sensor containing in its driving path at least one material set forth in claim 1.

8. A photoconductor containing in its driving path at least one material set forth in claim 1.

9. An image-displaying element containing in its driving path at least one material set forth in claim 1.

10. A spacial optical modulator containing in its driving path at least one material set forth in claim 1.

11. A thin-film transistor containing in its driving path at least one material set forth in claim 1.

12. A liquid crystalline charge transfer material having the following skeletal structure (B) containing the fluorescent core Y of a liquid crystal: 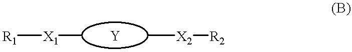
in which R₁ and R₂, which may directly be combined with Y without interposing X₁ and X₂, represents a saturated or unsaturated, and linear, branched or cyclic hydrocarbon group having 1 to 22 carbon atoms; and X₁ and X₂ represent oxygen atom, sulfur atom, or —CO—, —OCO—, —COO—, —N═CH—, —CONH—, —NH—, —NHCO— or — CH₂— group.

13. The liquid crystalline charge transfer material according to claim 12, wherein Y is (6π electron system aromatic ring)₁, (10π electron system aromatic ring)ₘ or (14π electron system aromatic ring)ₙ (where 1, m and n are an integer of 0 to 4, provided that 1+m+n=1 to 4), and the aromatic rings may be combined through —CH═CH—, —C≡C—, —N═N—, —CH═N— or —COO— group.

14. The liquid crystalline charge transfer material according to claim 12, wherein Y is selected from radicals of metal chelate compounds, polycyclically condensed or conjugated aromatic hydrocarbons, diphenylethylene derivatives, triphenylamine derivatives, diaminocarbazole derivatives, bisstyryl derivatives, benzothiazole derivatives, benzoxazole derivatives, aromatic diamine derivatives, quinacridone compounds, perylene compounds, oxadiazole derivatives, cumarin compounds and anthracene derivatives.

15. An electro-luminescent element containing in its driving path at least one material set forth in claim 12.

16. An electro-luminescent element whose charge transfer part and luminescent part are made from at least one material set forth in claim 12.

17. An electro-luminescent element which contains in its driving path at least one material set forth in claim 12 and whose charge transfer part and luminescent part are composed of a single layer.

18. An optical sensor containing in its driving path at least one material set forth in claim 12.

19. A photoconductor containing in its driving path at least one material set forth in claim 12.

20. An image-displaying element containing in its driving path at least one material set forth in claim 12.

21. A spacial optical modulator containing in its driving path at least one material set forth in claim 12.

22. A thin-film transistor containing in its driving path at least one material set forth in claim 12.
